(19) United States
(12) Patent Application Publication
(10) Pub. No.: US 2014/0316906 A1
(43) Pub. Date: Oct. 23, 2014

(54) Systems and Methods for Identifying Talent

(71) Applicants: Mark Edward Passalacqua, New York, NY (US); Bonnie Elaine Kraus, (US); Dennis John D'Amico, (US); Joseph George Connelly, (US); Dominic Gerard Cioffi, (US); Robert Joseph Loverro, (US)

(72) Inventors: Dominic Gerard Cioffi, Sparta, NJ (US); Joseph George Connelly, Sparta, NJ (US); Dennis John D'Amico, Andover, NJ (US); Bonnie Elaine Kraus, Sparta, NJ (US); Robert Joseph Loverro, Sparta, NJ (US); Mark Edward Passalacqua, New York, NY (US)

(73) Assignee: YOU ROCK MEDIA GROUP, INC., Sparta, NJ (US)

(21) Appl. No.: 14/156,451

(22) Filed: Jan. 16, 2014

Related U.S. Application Data
(63) Continuation-in-part of application No. 11/326,173, filed on Jan. 4, 2006.

(51) Int. Cl. G06Q 50/00; G06Q 30/02

(52) U.S. Cl. CPC G06Q 50/01; G06Q 30/0277
USPC 705/14.73; 705/319; 705/39

(57) ABSTRACT

Systems and methods for identifying talent that eliminate or minimize the costs and/or risks of identifying such talent, involve public feedback, and generate significant charitable donations. In one aspect of the present invention, talent's or bands' songs are made available to critics such as members of the public via mediums such as the Internet, radio, and television. Such individuals provide feedback during successive phases of the talent identification process, and talents and/or bands with the greatest public appeal advance to the final stages of the process. Ultimately, the talent or band receiving the most favorable feedback is promoted or awarded with, for example, a record deal. Throughout the process, revenue is generated via a variety of methods including voting/critiquing fees, advertising, sale of promotional items, and the like. In some aspects of the present invention, at least a portion of such revenue is donated to charity.

### CROSS-REFERENCE TO RELATED APPLICATIONS

This application claims the benefit of and is a continuation-in-part of the co-pending U.S. non-provisional patent application entitled “System and Methods for Identifying Talent”, having Ser. No. 11/326,173, filed Jan. 4, 2006, which is incorporated by reference in its entirety as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

Embodiments of the present invention generally relate to systems and methods for identifying talent. More specifically, the present invention relates to systems and methods for identifying talent via global talent competitions, which eliminate or minimize the costs and/or risks of identifying such talent and include mechanisms for generating significant charitable donations.

The music industry is dominated by four major record labels, which control approximately 70% of the worldwide music market and approximately 85% of the United States music market. These record labels include Universal Music Group with approximately 25.5% of the worldwide music market, Sony BMG Music Entertainment with approximately 21.5% of the worldwide music market, EMI Group with approximately 13.4% of the worldwide music market, and Warner Music Group with approximately 11.3% of the worldwide music market. Consequently, these four record labels are responsible for the discovery and promotion of the majority of aspiring new artists.

Currently, these record labels incorporate a variety of techniques to evaluate thousands of new artists daily in search of those artists whose promotion will create a substantial return on investment for the record label. Such techniques include the employment of highly paid talent scouts, who are tasked with evaluating and discovering the next great talent. Many talent scouts seek artists who possess a significant preexisting fan base or other indicators of success, thereby increasing the likelihood that promotion of such artist will result in a solid return on investment for the record label. Since every selected artist incurs substantial upfront promotion costs prior to generation of revenue for the record label, the record label faces financial loss whenever a promoted artist does not provide the anticipated return on investment.

Entities other than record labels have also implemented systems and methods for identifying talent. One such method includes regional talent competitions (e.g., battle of the band competitions), in which bands compete against each other in live performances at designated venues. In such competitions, the bands are typically screened and selected prior to the competition by personnel associated with the competition such as a judge, panel of judges, talent scout, or the like. These competitions are typically organized and/or conducted by private entities to generate revenue from ticket sales, concessions, merchandising, and the like.

Similarly, worldwide Internet talent competitions exist. In one such system, artists may upload their songs to a talent competition Web site for a fee, and industry experts employed by the Internet talent competition evaluate the uploaded songs. In such competitions, the industry experts screen potential contestants for the Internet talent competition prior to the competition. Such experts typically select the artists that will be allowed to compete in the talent competition. Thereafter, the public is exposed to the selected artists via the Internet medium and may provide feedback for the selected artists via the talent competition Web site. Such competitions are typically organized and/or conducted by private entities to generate revenue from the fees paid by the initial contestants.

Moreover, televised talent competitions such as American Idol and the like exist. American Idol personnel hold auditions in cities across the United States for thousands of artists during which the pool of artists is judged and narrowed to a predetermined quantity. The selected artists then perform in weekly competitions before a live studio audience on broadcast television. A panel of industry expert judges evaluates each artist during every level of competition, however, the final winner of the competition is decided by public vote. The American Idol competition is organized and/or conducted by private entities to generate revenue from sources such as television advertising, merchandising, and the like.

### BRIEF SUMMARY OF THE INVENTION

Briefly stated, in one aspect of the present invention, a method for identifying talent is provided. This method includes: creating a community; allowing, using a microprocessor, any member of a public to join the community via a network connection capable of accessing a server associated with the community; receiving, using a microprocessor, talent into the community; receiving, using a microprocessor, at least one of the group consisting of talent media and talent promotional items from the talent; making at least one of the group consisting of the talent, the talent media, the talent promotional items, and combinations thereof available to the community via the network; receiving, using a microprocessor, feedback from the fans via a plurality of electronic devices in communication with the server; automatically selecting, using a microprocessor, a subset of the talent based upon predetermined selection criteria; and promoting the subset.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 depicts the phases of one method of identifying talent in accordance with one embodiment of the present invention;

FIG. 2 depicts the phases of an alternate method of identifying talent in accordance with an embodiment of the present invention;

FIG. 3 depicts the phases of yet another method of identifying talent in accordance with an embodiment of the present invention;

FIGS. 4A-4C depict a flowchart of one method for identifying talent in accordance with one embodiment of the present invention;

FIG. 5 depicts a diagram of an exemplary computer environment for use with the systems and methods of identifying talent in accordance with an embodiment of the present invention;

FIG. 6A is a block diagram of an exemplary computer environment for use with the systems and methods of discovering talent as depicted in FIGS. 6A through 19 in accordance with one alternate embodiment of the present invention;

FIG. 6B is an exemplary set of databases/database tables for use with the exemplary computer environment depicted in FIG. 6A in accordance with the alternate embodiment of the present invention set forth in FIGS. 6A through 19;

FIGS. 7A and 7B depict a flowchart of one method of allowing a user of the systems and methods of the present invention to discover talent in accordance with the alternate embodiment of the present invention set forth in FIGS. 6A through 19;

FIG. 8 depicts a flowchart of one method for allowing a user to purchase talent products in accordance with the alternate embodiment of the present invention set forth in FIGS. 6A through 19;

FIG. 9 depicts a flowchart of one method for rewarding a user for discovering talent in accordance with the alternate embodiment of the present invention set forth in FIGS. 6A through 19;

FIGS. 10A through 10E depict a flowchart of one method for assisting a venue user with finding and hiring talent in accordance with the alternate embodiment of the present invention set forth in FIGS. 6A through 19;

FIGS. 11A and 11B depict a flowchart of one method for allowing a venue to accept a talent's application to perform for a specific event in accordance with the alternate embodiment of the present invention set forth in FIGS. 6A through 19;

FIG. 12 depicts an exemplary Open Event Dashboard for use by a venue in accordance with the alternate embodiment of the present invention set forth in FIGS. 6A through 19;

FIGS. 13A and 13B depict a flowchart of one method for allowing a user to check in and vote for talent via accessing a live event code in accordance with the alternate embodiment of the present invention set forth in FIGS. 6A through 19;

FIG. 14 depicts a flowchart of a method for allowing a user to check in and vote for talent via logging in to the systems and methods of the present invention in accordance with the alternate embodiment of the present invention set forth in FIGS. 6A through 19;

FIG. 15 depicts a flowchart of one method for identifying talent in accordance with the alternate embodiment of the present invention set forth in FIGS. 6A through 19;

FIG. 16 depicts a flowchart of one method for uploading material in accordance with the alternate embodiment of the present invention set forth in FIGS. 6A through 19;

FIG. 17 depicts a flowchart of one method for downloading material in accordance with the alternate embodiment of the present invention set forth in FIGS. 6A through 19;

FIGS. 18A and 18B depict a flowchart of one method for rating talent and/or material in accordance with the alternate embodiment of the present invention set forth in FIGS. 6A through 19; and

FIG. 19 depicts an exemplary fan user dashboard in accordance with the alternate embodiment of the present invention set forth in FIGS. 6A through 19.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a voter” may include a plurality of voters. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

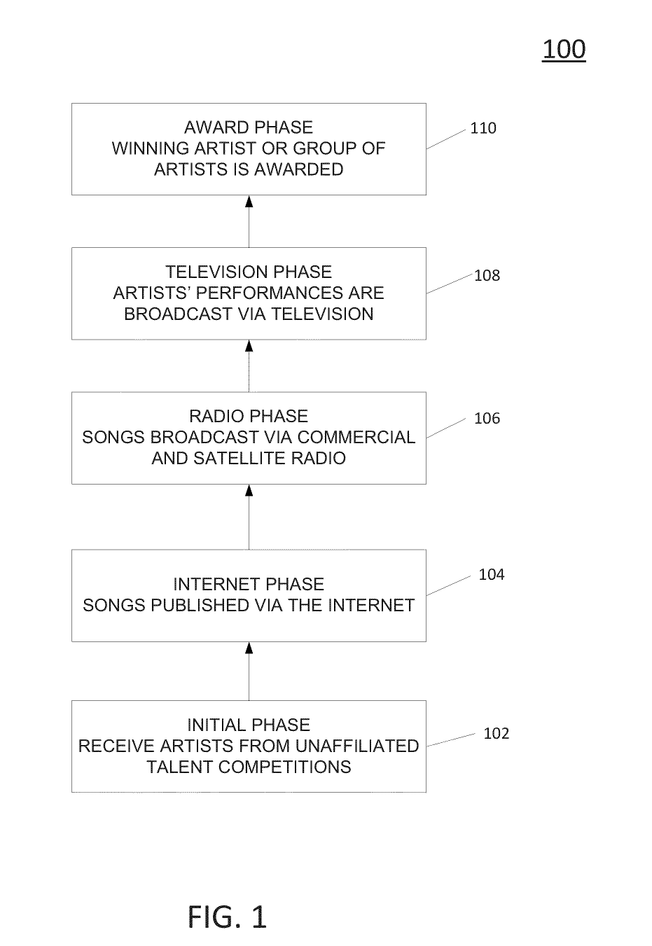

Referring first to FIG. 1, illustrated are five phases of an exemplary embodiment of a system and method for identifying talent. In the depicted embodiment, artists or a group of artists (e.g., a band) selected from a plurality of existing talent competitions are exposed to critics such as members of the public via mediums such as the Internet, radio, and television. Critique, feedback, and the like are gathered at each phase of the system and method to determine which artists and/or bands shall be exposed to the scrutiny of the critics via each of the distinct mediums. Furthermore, such critique, feedback, scrutiny, and the like shall ultimately determine which of the competing artists and/or bands shall be rewarded at the conclusion of the contest with, for example, a recording contract.

Talent identification method 100 begins at initial phase 102. In one aspect of the present invention, initial phase 102 includes receiving artists and/or bands from one or more existing local talent competitions. Such talent competitions may include existing battle of the band competitions and/or various other talent competitions conducted worldwide. Such competitions may be conducted live or via mediums such as the Internet, radio, television, and the like. Furthermore, the contestants of such competitions may include individual artists, groups of artists, bands, or the like.

In one aspect of the present invention, a set of existing local talent competitions from which talent shall be advanced to Internet phase 104 is selected. Preferably, such set of competitions is selected to ensure worldwide participation in the systems and/or methods of the present invention to increase the likelihood of identifying a “Super Group” or “Super Artist” having worldwide appeal. For example, such set of existing local talent competitions may include one competition per participating country. Or such set may include one competition for each smaller participating country and one competition per state, or other geographical subdivision, for each larger participating country. Virtually any combination of local talent competitions may be implemented via the systems and methods of the present invention. However, the systems and methods of the present invention are not limited to worldwide competition. Such systems and methods may be incorporated for identification of talent from a talent pool selected from a smaller geographic area (e.g., the United States, the State of New York, etc.) without departing from the scope hereof.

After a set of existing local talent competitions from which performers, artists and/or bands shall be advanced to Internet phase 106A is selected, selection criteria shall be defined to determine which artists and/or bands from each local talent competition shall be advanced. For example, in one embodiment of the present invention, only one winner from each of the predetermined list of local talent competitions shall be advanced to Internet phase 104. However, in other embodiments of the present invention, all finalists and/or all semi-finalists from each individual talent competition may be advanced to Internet phase 104. However, the present invention is not so limited. Virtually any selection criteria for determining which artists and/or bands from each local talent competition will be advanced to Internet phase 104 may be implemented without departing from the scope hereof.

Receiving artists and/or bands from initial phase 102 and advancement of such artist and/or band through talent identification method 100 via the systems and methods of the present invention provides a variety of benefits and advantages. In one aspect of the present invention, initial phase 102 eliminates or reduces the overhead of the entity seeking to identify talent by allowing the initial talent pool to be selected purely via a plurality of existing local talent competitions. Once a group of local talent competitions has been selected (e.g., one talent competition per state, one talent competition per country, etc.) and the selection criteria for selecting talent from each of the local talent competitions has been determined (e.g., each winner of each competition will be advanced to Internet phase 104), advancement of such participants in the systems and methods of the present invention is purely administrative. That is, the need for highly paid talent assessment personnel is completely eliminated since the local talent competitions determine the winners for each competition independent of the entity implementing the systems and methods of the present invention.

Also, receiving artists and/or bands selected by the systems and methods of the local talent competitions increases the likelihood that the artist and/or band selected by the systems and methods of the present invention (e.g., public preferences, music listener preferences, etc.) will become “The Next Great Super Group” or “The Next Great Super Artist”. In many instances, such artists and/or bands are selected in the local talent competitions purely based upon the public's vote, or the votes of those in attendance at the local talent competition. Since such voters and/or attendees tend to comprise a large portion of music consumers, their opinions regarding the quality of up and coming artists and/or bands are more likely to reflect those of the music consumer. Allowing a plurality of actual music consumers, rather than an individual, highly paid recording industry talent scout, to select the initial talent pool increases the possibility that the artist and/or band selected using the systems and methods of the present invention will be more palatable to music consumers as a whole, thereby increasing the likelihood that the identified talent will become the “The Next Great Super Group” or “The Next Great Super Artist”.

Furthermore, the aforementioned increase in the likelihood of finding the “The Next Great Super Group” or “The Next Great Super Artist” minimizes the risk and maximizes the return on investment of the entity implementing the systems and methods of the present invention (e.g., a record label). As the successful artists and/or bands advance through each phase of talent identification process 100, global fan support for and marketability of each artist and/or band is proven. Similarly, at the conclusion of talent identification process 100, the successful artist and/or band has proven his, her, or their marketability, which minimizes the risk associated with investing financial capital into further promotion of such successful artist and/or band. Furthermore, since marketability and fan support have already been proven, it is more likely that the entity implementing the systems and methods of the present invention will maximize its return (e.g., profits from song sales, concert sales, and the like) on funds invested in the further promotion of such artist and/or band.

In addition, the systems and methods of the present invention (including the step of receiving artists and/or bands from initial phase 102) provide all artists and/or bands with equal opportunity and equal access to the entity implementing the systems and methods of the present invention by eliminating the bias, favoritism, bad judgment, and the like of such entity, which can result in the promotion of mediocre or untalented artists and/or bands. Via the present invention, absolutely every artist and/or band from around the world has the opportunity to enter an existing local talent competition. Thereafter, if successful, such artists and/or band may advance through talent identification process 100 unimpeded by any employee of the entity implementing the present invention. That is, such artist and/or band advances purely on his, her, or their skill, talent, and acceptance by the general participating listening public.

Also, some implementations of the systems and methods of the present invention result in a truly unbiased worldwide identification of talent since cultural biases are minimized and/or eliminated. The advancement of artists and/or bands from initial phase 102 to Internet phase 104 is determined solely by the local talent competition audiences and/or judges. Typically, such audiences and/or judges are from the same culture as the competing artists and/or bands. Consequently, the methods of advancing artists and/or bands of the present invention minimize the possibility that artists and/or bands will be eliminated due to cultural biases or differences. For example, a New York City record label executive may be unintentionally, or intentionally, biased toward selection of United States artists and/or bands due to such executive's familiarity with the United States culture. Such bias may result in non-recognition of “The Next Great Super Group” or “The Next Great Super Artist” solely due to such cultural bias. When implemented in a worldwide embodiment, the systems and methods of the present invention minimize or eliminate the possibility of such non-recognition. Furthermore, the voting public's exposure to culturally diverse musical talent and styles will likely create new markets for such music in areas that may not have been previously exposed to them due to the cultural and/or artificial music industry walls or boundaries.

Moreover, some embodiments of the systems and methods of the present invention facilitate identification of a truly global talent pool by geographically segmenting one or more of initial phase 102, Internet phase 104, and radio phase 106. Such segmentation narrows the talent pool to be critiqued by each critic. If such segmentation were not implemented, each critic would be tasked with critiquing each and every one of the artists and/or bands participating in the first phase of the global talent identification process 100. Such a cumbersome and time-consuming critiquing process is likely to minimize the quantity of individuals willing to partake in such critiquing, thereby minimizing the effectiveness of the entire talent identification process 100. Consequently, the systems and methods of the present invention act to segment, and thereby limit the number of, artists and/or bands to be critiqued by each pool of critics to facilitate such process, thereby maximizing the effectiveness of the entire talent identification process 100.

Segmentation of one or more phases of talent identification process 100 facilitates worldwide participation in the final phases (e.g., television phase 108) of talent identification process 100. Since critics provide critique, feedback, and the like during the early stages of talent identification process 100, many such individuals will develop an interest or desire to continue such critiquing throughout the entire process. In some instances, such individuals may develop artist and/or band loyalty and may wish to help their favorite artists and/or bands achieve the ultimate prize. Such desire to participate and artist and/or band loyalty will encourage individuals from around the globe to continue participating in talent identification process 100 through the completion of the process, even if such completion involves a single television broadcast or a single series of television broadcasts. Inclusion of such critics at the onset of talent identification process 100 maximizes the possibility that such individuals will tune in for the final stage(s), thereby increasing the overall effectiveness of talent identification process 100.

The popularity and widespread, or worldwide, participation in talent identification process 100 further operates to encourage and/or attract new artists and/or bands, and potentially highly talented artists and/or bands, to participate in each subsequent implementation of the talent identification process 100. Such encouragement and/or attraction are likely to provide a continuous flow of talented artists and/or bands for every subsequent implementation of the present invention, thereby increasing the quality of the process and, presumably, the quality of the rewarded artist and/or band. Such increase in quality further increases the likelihood of finding the “The Next Great Super Group” or “The Next Great Super Artist”.

For all of the aforementioned reasons, talent identification process 100 begins with an initial phase such as that described for initial phase 102. After completion of initial phase 102, talent identification process 100 proceeds to Internet phase 104.

At Internet phase 104, songs and/or music videos are received from the artists and/or band who have met the required selection criteria for advancement from initial phase 102 to Internet phase 104 (i.e., the “advancing artists and/or bands”). In one aspect of the present invention, such received songs are original works that have been created and performed by the respective artist(s) and/or band(s). However, alternate embodiments of the present invention are envisioned in which such received songs have been created by entities other than the advancing artist(s) and/or band(s). Or, such received songs may be songs originally performed by artist(s) and/or band(s) other than the advancing artist and/or band.

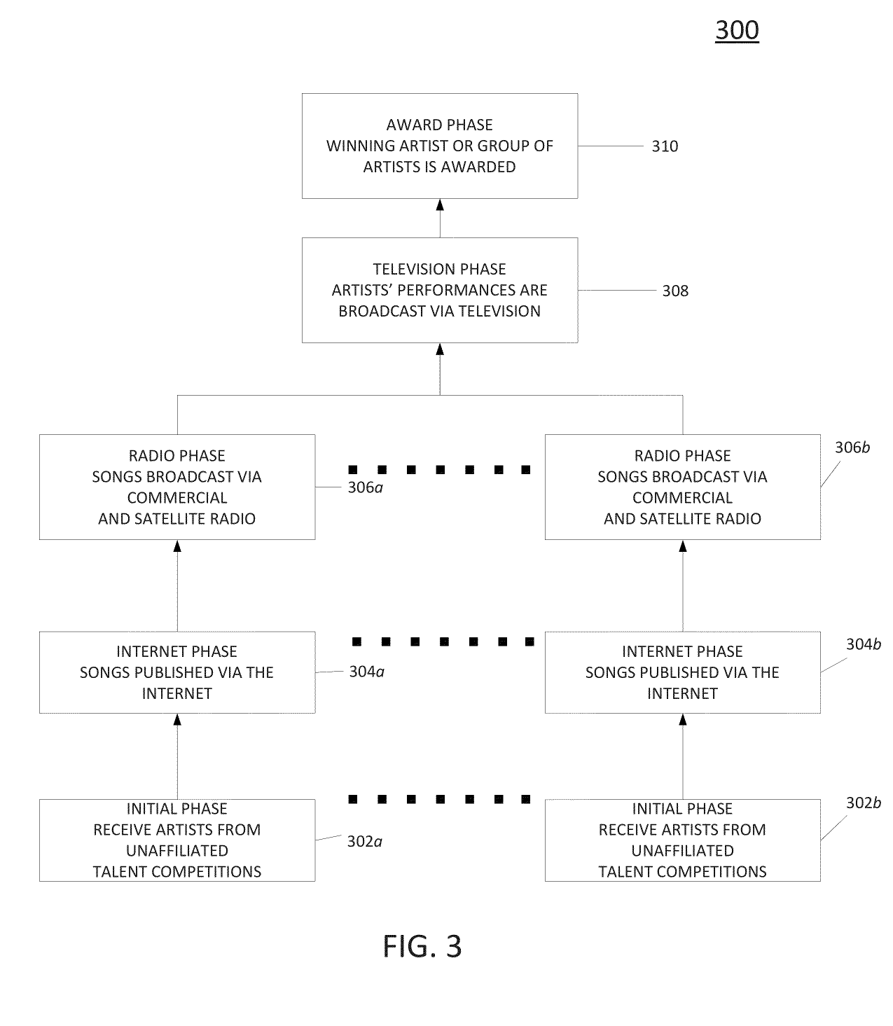

After receipt of songs and/or music videos from the advancing artists and/or bands, such songs and/or music videos are then published via a computer network such as the Internet or the like via creation of user interfaces such as Web pages. Such publication allows critics to provide critique, feedback, and the like for each of the published songs and/or music videos. In one embodiment of the present invention, critics vote for each song and/or music video. In another embodiment of the present invention, a system such as that described with respect to FIG. 3 below, tallies the number of times each song and/or music video is accessed by a critic. Or, alternatively, such a system may tally the number of times each song is downloaded. Virtually any method of quantifying the acceptance or popularity of a particular song and/or music video by critics, such as members of the public, may be substituted without departing from the scope of the present invention.

In some aspects of the present invention, critics are charged fees for providing such critique, feedback, or the like. Such fees may include fees for casting a vote, fees for downloading a song, fees for listening to a song, fees for viewing a music video, fees for purchasing an artist or band's product, and the like.

Furthermore, embodiments of the present invention are envisioned in which revenue is also derived from advertising and sponsorship of Web sites, Web pages, and the like associated with talent identification process 100. In addition, revenue may be generated from sale of products associated with talent identification process 100 such as clothing, hats, mugs, bumper stickers, and the like. The interaction between the critics and the talent identification process 100 creates opportunities for future direct marketing of goods and services to the critic. Moreover, demographic information may be collected prior to allowing a critic to provide feedback, and such information may be utilized to increase advertising sales for future implementations of talent identification process 100.

In some embodiments of the present invention, at least a portion of charged fees or other collected revenue is donated to a charity such as those charities that support the interests of starving artists and/or bands. However, such portions of charged fees or other collected revenue may also be donated to unrelated charities without departing from the scope hereof.

Collection of critique, feedback, and the like will occur during Internet phase 104 for a predetermined period of time. Upon the expiration of such time period, the artists and/or bands whose songs have received the most favorable feedback (e.g., the highest number of votes, the highest number of downloaded or accessed songs, etc.) will advance to the next phase of talent identification process 100 (e.g., radio phase 106).

In radio phase 106, songs received from the artists and/or bands who advanced from Internet phase 104 to radio phase 106 will be broadcast via radio such as commercial radio, satellite radio, and the like. In some embodiments of the present invention, such songs shall be the same songs evaluated during earlier phases of talent identification process 100 (e.g., Internet phase 104). However, alternate embodiments of the present invention are envisioned in which each advancing artist and/or band must submit new songs for evaluation in one or more of the phases (e.g., radio phase 106) following Internet phase 104.

In one embodiment of the present invention, the songs broadcast during radio phase 106 will be broadcast locally and/or internationally via one or more newly created radio stations (e.g., a newly created “Undiscovered Talent Station”), which may be dedicated to discovery of new talent and/or talent identification process 100. In some such embodiments of the present invention, songs from the existing “Super Groups” and “Super Artists” (e.g., the Beatles, Led Zeppelin, etc.) are played in combination with the songs received from the advancing artists and/or bands to provide perspective to the listeners and/or critics and to attract a larger audience of listeners. However, combination of the advancing artists' and/or bands' songs with existing songs, whether such songs are performed by “Super Groups”, “Super Artists”, or other lesser known musicians, may also be implemented in embodiments of the present invention in which the advancing artists' and/or bands' songs are played via non-dedicated radio stations without departing from the scope hereof.

Broadcast of the songs of the advancing artists and/or bands via one or more radio stations encompassing the geographic area of talent identification process 100 (e.g., worldwide) allows critics within such geographic area to listen to, and evaluate, such broadcast songs. Additionally, radio phase 106 attracts new participants to talent identification process 100, such as those individuals who are not computer-savvy. Either during, or at the conclusion of, radio phase 106, such critics shall be provided with the ability to provide critique, feedback, or the like for one or more broadcast songs, artists, and/or bands. Such critique, feedback, or the like may be provided via any system and method known in the art or any systems and methods yet to be invented without departing from the scope of the present invention. Such systems and methods include, but are not limited to, electronic mail, text messaging, telephones, cell phones, Apple IPods™, personal computers, and Blackberrys®.

In some aspects of the present invention, critics are charged fees for providing such critique, feedback, or the like during radio phase 106. Such fees may include fees for casting a vote. Additional revenue may also be generated for advertising and sponsorship of the radio stations associated with talent identification process 100, as well as the sale of products associated with talent identification process 100. As discussed above with respect to Internet phase 104, in some embodiments of the present invention, at least a portion of charged fees or other collected revenue is donated to charity.

Collection of critique, feedback, and the like will occur during radio phase 106 for a predetermined period of time. Upon the expiration of such time period, the artists and/or bands whose songs have received the most favorable feedback (e.g., the highest number of votes) will advance to the next phase of talent identification process 100 (e.g., television phase 108).

In television phase 108, the artists and/or bands whose songs received the most favorable feedback in radio phase 106 will compete in a local, national, or international television competition. In some embodiments of the present invention, such artists and/or bands shall perform the same song or songs evaluated during earlier phases of talent identification process 100 (e.g., Internet phase 104, radio phase 106, etc.). However, alternate embodiments of the present invention are envisioned in which each advancing artist and/or band must perform a new song for evaluation in television phase 108.

Competition of the advancing artists and/or bands via one or more television shows broadcast to the entire geographic area of talent identification process 100 (e.g., worldwide) allows critics within such geographic area to see, hear, and evaluate such artists and/or bands and the associated performances. Either during, or at the conclusion of, television phase 108, such critics shall be provided with the ability to provide critique, feedback, or the like for one or more of the competing artists and/or bands. Such critique, feedback, or the like may be provided via any system and method known in the art or any systems and methods yet to be invented without departing from the scope of the present invention. Such systems and methods include, but are not limited to, electronic mail, text messaging, telephones, cell phones, Apple IPods™, personal computers, and Blackberrys®.

Similar to that discussed above with respect to the other phases of talent identification process 100, in some aspects of the present invention, critics are charged fees for providing such critique, feedback, or the like during television phase 108. Such fees may include fees for casting a vote. Additional revenue may also be generated for advertising and sponsorship of the television shows associated with talent identification process 100, as well as the sale of products associated with talent identification process 100. As discussed above with respect to Internet phase 104 and radio phase 106, in some embodiments of the present invention, at least a portion of charged fees or other collected revenue is donated to charity.

Collection of critique, feedback, and the like will occur during television phase 108 for a predetermined period of time. Upon the expiration of such time period, the artist and/or band, who receive the most favorable feedback (e.g., the highest number of votes) will advance to award phase 110.

In one aspect of the present invention, during award phase 110, the artist and/or band receiving the most favorable feedback during the prior phase may be named “The Next Great Super Group” or “The Next Great Super Artist”. In another aspect of the present invention, such artist and/or band advancing to award phase 110 is awarded a record deal. Although only one, or some other minimal quantity of, artists and/or bands will typically be selected as the winner of talent identification process 100, all of the artists and/or bands participating therein will be awarded with worldwide exposure and publicity, which may potentially lead to a record deal or other benefits separate and distinct from talent identification process 100.

In another embodiment of the present invention, talent identification process 100 additionally includes a critic award process. In its most simplistic form, the critic(s) that correctly identify the winner of talent identification process 100 in every phase of such process receives an award. Alternatively, the critic award process may occur during each individual phase of identification process 100. That is, winning critic(s) may be selected at the end of each phase. In one such embodiment, a different critic is selected as a winner of each phase.

In another such embodiment, several critics are selected as critic semi-finalists at the conclusion of initial phase 102. In this embodiment, the critic semi-finalists selected at the conclusion of initial phase 102 proceed to Internet phase 104, at which one or more of the critic semi-finalists are eliminated. This process is repeated at the conclusion of radio phase 106 and television phase 108 until one or more of the critic semi-finalists are determined to be the critic winner. Such winner may then receive an award during award phase 110. Additionally, the critic semi-finalists may receive differing awards based upon the extent to which each semi-finalist critic advances through the critic award portion of talent identification process 100.

In the embodiments of the present invention in which critics are ranked, a method of ranking is required. In one embodiment of the present invention, the method of ranking is based upon how accurately each critic guesses the semi-finalists of each phase of talent identification process 100. Alternatively, the method of ranking may be based upon how well the critic assesses the artist and/or band. This assessment may include, but is not limited to, written critiques of the artist and/or band, verbal critiques of the artist and/or band, knowledge of industry standards relating to the artist and/or bands' performances, and combinations thereof. In addition, such critics may be ranked by professional talent scouts, judges, or the like, or, alternatively, such individuals may be ranked by each other (i.e., the critics tasked with critiquing the artists and/or bands). However, the present invention is not so limited. Virtually any criteria and/or method for ranking critics or selecting a winning critic may be implemented without departing from the scope hereof.

Although the critic winner may receive any award without departing from the scope of the invention, the award may be selected to add to the entertainment value of talent identification process 100. For example, the critic winner may be awarded a position as a talent scout or agent. Or, the critic winner may host a phase of a subsequent implementation of talent identification process 100 (e.g., television phase 108).

Although FIG. 1 depicts the steps of talent identification process 100 in a specific, predetermined manner (i.e., Internet phase 104, radio phase 106, and television phase 108), varying sequences of such steps may be substituted without departing from the scope of the present invention. For example, television phase 108 may precede radio phase 106, radio phase 106 may preceded Internet phase 104, etc. Furthermore, some phases may include combinations of the phases discussed herein. For example, television phase 108 may include an Internet counterpart in which critics may view the television show via the Internet.

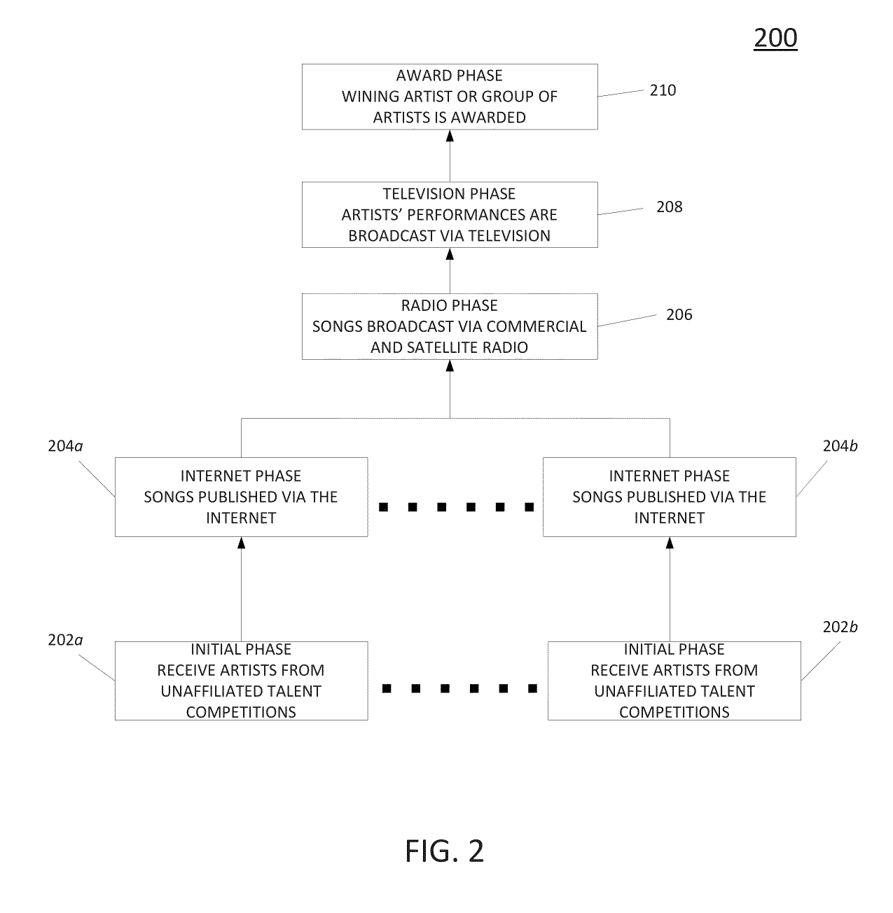

Turning next to FIG. 2, illustrated is another exemplary embodiment of a system and method for identifying talent. In talent identification process 200, radio, television, and award phases 206, 208, and 210, respectively, are similar to radio, television, and award phases 106, 108, and 110, respectively, of talent identification process 100 as described above with respect to FIG. 1. However, talent identification process 200 differs from talent identification process 100 with respect to its initial and Internet phases 202 and 204, respectively.

In the embodiment of the present invention depicted in FIG. 2, a plurality of initial phases 202 and Internet phases 204 exist. In one aspect of the present invention, each grouped initial phase 202 and Internet phase 204 (e.g., initial phase 202a and Internet phase 204a) is associated with a subset of the totality of the existing talent competitions selected as a part of the implementation of the present invention. Virtually any criteria may be used for separation of the existing talent competitions into subsets. In one embodiment of the present invention, the existing talent competitions are separated based upon geographic areas. For example, each country participating in talent identification process 200 may have a dedicated initial phase 202 and Internet phase 204. Or, alternatively, the existing talent competitions may be divided based on different genres of music. For example, classic rock, rap, dance, and the like may each comprise a separate and distinct subset. Other possible subsets include, but are not limited to, regions of the world, regions of a country, number of artists in the band, age of the artist and/or band, alphabetic separation of the artist's and/or band's name, alphabetic separation of the artist's and/or band's song name, date of the existing talent competition, time of year of the competition, and combinations thereof. However, any method of separation of the existing talent competitions may be substituted without departing from the scope of the present invention. Additionally, any quantity of initial and Internet phases 202 and 204 may be included without departing from the scope hereof.

As part of each individual Internet phase 204, songs and/or music videos are received from the artists and/or band who have met the required criteria for advancement from the associated initial phase 202 to the respective Internet phase, as described above with respect to FIG. 1. After receipt of songs and/or music videos from the advancing artists and/or bands, such songs and/or music videos are then published via a computer network such as the Internet or the like via creation of user interfaces such as Web pages. In one aspect of the present invention, each Internet phase 204 has a dedicated user interface (e.g., each Internet phase 204 may be associated with a dedicated Web page, a dedicated hypertext link on a single Web Page, a dedicated Web Site, etc.).

Such publication allows critics to provide critique, feedback, and the like for each of the published songs and/or music videos, as described above with respect to FIG. 1. However, in this embodiment of the present invention, the critics may choose to critique the artists and/or bands in any one or more of the multiple subsets (i.e., the multiple Internet phases 204). This allows critics with limited time to participate in talent identification process 200 by reducing the quantity of songs and/or videos that the critic must review prior to providing feedback. Additionally, segmenting initial phase 202 and/or Internet phase 204 minimizes the possibility that the critics will provide feedback without reviewing all published songs and/or videos. For example, a critic who becomes bored or tired of reviewing the published songs and/or videos may provide incorrect or inaccurate feedback due to his or her failure to review all published songs and/or music videos. This may prevent the critic from providing favorable feedback for the best artists and/or bands if such critic failed to review to such artist(s)' and/or bands' published songs or videos. However, a critic may choose to review all songs and/or videos in all Internet phases 204 if so desired by simply accessing each of the user interfaces associated with each of the Internet phases 204. Alternatively, a critic could choose to review all songs and/or videos in all Internet phases 204 while opting to provide feedback for a single Internet phase 204 only. Additionally, incorporation of a plurality of Internet phases 204 allows the critics to review music and/or videos in select subsets only (e.g., a critic may desire to review classic rock songs and/or videos while avoiding review of rap songs and/or videos).

Such embodiments of the present invention also allow a more varied range of semi-finalists to reach the final phases of talent identification process 200. For example, in embodiments of the present invention including a single Internet phase 204, an artist and/or band of one genre or other type of subset may be eliminated if a majority of the critics prefer one specific subset. However, in embodiments of the present invention incorporating multiple Internet phases 204 separated by categories such as music genre, the semi-finalists are guaranteed to represent each of the categories of each of the Internet phases 204.

In yet another embodiment of the present invention, only one initial phase 202 is implemented, however, it leads to several Internet phases 204. That is, the advancing artists and/or bands determined in initial phase 202 may be split between a plurality of Internet phases 204. For example, such advancing artists and/or bands may be sorted into Internet phases 204 based upon predefined criteria such as that discussed above.

Collection of critique, feedback, and the like will occur during each Internet phase 204 for a predetermined period of time. In one embodiment of the present invention, upon the expiration of the respective time period, the artists and/or bands whose songs have received the most favorable feedback in each Internet phase 204 will advance to a single radio phase 206. Alternatively, in another embodiment of the present invention, criteria shall be defined to determine which artists and/or bands from each Internet phase 204 shall be advanced. For example, in one embodiment of the present invention, only one winner from each Internet phase 204 shall be advanced to radio phase 206. However, in other embodiments of the present invention, all finalists and/or all semi-finalists from each Internet phase 204 may be advanced to radio phase 206. However, the present invention is not so limited. Virtually any criteria for determining which artists and/or bands from each Internet phase 204 will be advanced to radio phase 206 may be implemented without departing from the scope hereof.

Referring now to FIG. 3, illustrated is another exemplary embodiment of a system and method for identifying talent. In talent identification process 300, television and award phases 308 and 310, respectively, are similar to television and award phases 108 and 110, respectively, of talent identification process 100 as described above with respect to FIG. 1. Also, initial and Internet phases 302 and 304, respectively, are similar to initial and Internet phases 202 and 204, respectively, of talent identification process 200 as described above with respect to FIG. 2. However, talent identification process 300 differs from talent identification processes 100 and 200 with respect to its radio phase 306.

In the embodiment of the present invention depicted in FIG. 3, a plurality of radio phases 306 exist. In one aspect of the present invention, each radio phase 306 is grouped with an initial phase 302 and Internet phase 304 (e.g., initial phase 302a and Internet phase 304a), and each three phase grouping is associated with a subset of the totality of the existing talent competitions selected as a part of the implementation of the present invention. Virtually any criteria may be used for separation of the existing talent competitions into subsets as described above with respect to FIG. 2.

As part of each individual radio phase 306, songs are received from the artists and/or bands who have met the required criteria for advancement from the associated Internet phase 304 to the respective radio phase 306, as described above with respect to FIG. 1. Such songs will be broadcast via radio such as commercial radio, satellite radio, and the like, as described above with respect to FIG. 1. In one aspect of the present invention, each radio phase 306 has a dedicated radio station.

Such broadcast allows critics to provide critique, feedback, and the like for each of the broadcast songs, as described above with respect to FIG. 1. However, in this embodiment of the present invention, the critics may choose to critique the artists and/or bands in any one or more of the multiple subsets (i.e., the multiple radio phases 306). This allows critics with limited time to participate in talent identification process 300 by reducing the quantity of songs that the critic must listen to prior to providing feedback. Additionally, segmenting radio phase 306 minimizes the possibility that the critics will provide feedback without listening to all broadcast songs. For example, a critic who becomes bored or tired of listening to the broadcast songs may provide incorrect or inaccurate feedback due to his or her failure to listen to all broadcast songs. This may prevent the critic from providing favorable feedback for the best artists and/or bands if such critic failed to listen to such artist(s)' and/or bands' broadcast songs. However, a critic may choose to listen to all songs in all radio phases 306 if so desired by simply accessing each of the radio phases (e.g., accessing each of the radio stations). Alternatively, a critic could choose to listen to all songs in all radio phases 306 while opting to provide feedback for a single radio phase 306 only. Additionally, incorporation of a plurality of radio phases 306 allows the critics to listen to all songs in select subsets only (e.g., a critic may desire to listen to classic rock songs while avoiding listening to rap songs).

Such embodiments of the present invention also allow a more varied range of semi-finalists to reach the final phases of talent identification process 300. For example, in embodiments of the present invention including a single radio phase 306, an artist and/or band of one genre or other type of subset may be eliminated if a majority of the critics prefer one specific subset. However, in embodiments of the present invention incorporating multiple radio phases 306 separated by categories such as music genre, the semi-finalists are guaranteed to represent each of the categories of each of the radio phases 306.

In yet another embodiment of the present invention, only one initial phase 302 and/or Internet phase 304 is implemented, however, it leads to several radio phases 306. That is, the advancing artists and/or bands determined in initial phase 302 and/or Internet phase 304 may be split between a plurality of radio phases 306. For example, such advancing artists and/or bands may be sorted into radio phases 306 based upon predefined criteria such as that discussed above.

Collection of critique, feedback, and the like will occur during each radio phase 306 for a predetermined period of time. In one embodiment of the present invention, upon the expiration of the respective time period, the artists and/or bands whose songs have received the most favorable feedback in each radio phase 306 will advance to a single television phase 308. Alternatively, in another embodiment of the present invention, criteria shall be defined to determine which artists and/or bands from each radio phase 306 shall be advanced. For example, in one embodiment of the present invention, only one winner from each radio phase 306 shall be advanced to television phase 308. However, in other embodiments of the present invention, all finalists and/or all semi-finalists from each radio phase 306 may be advanced to television phase 308. However, the present invention is not so limited. Virtually any criteria for determining which artists and/or bands from each radio phase 306 will be advanced to television phase 308 may be implemented without departing from the scope hereof.

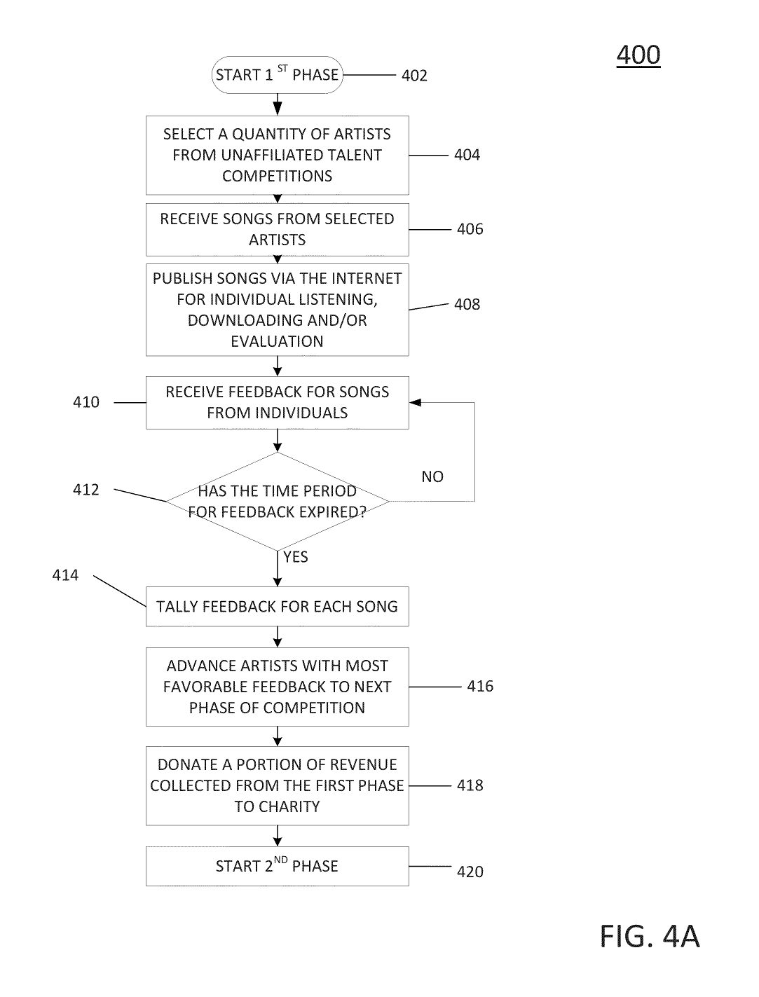

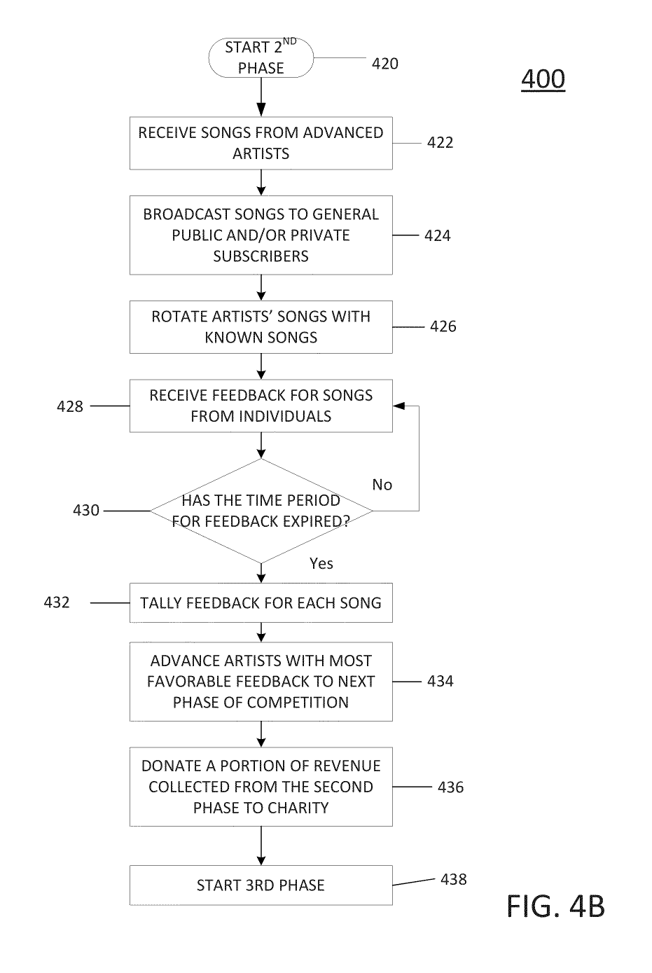

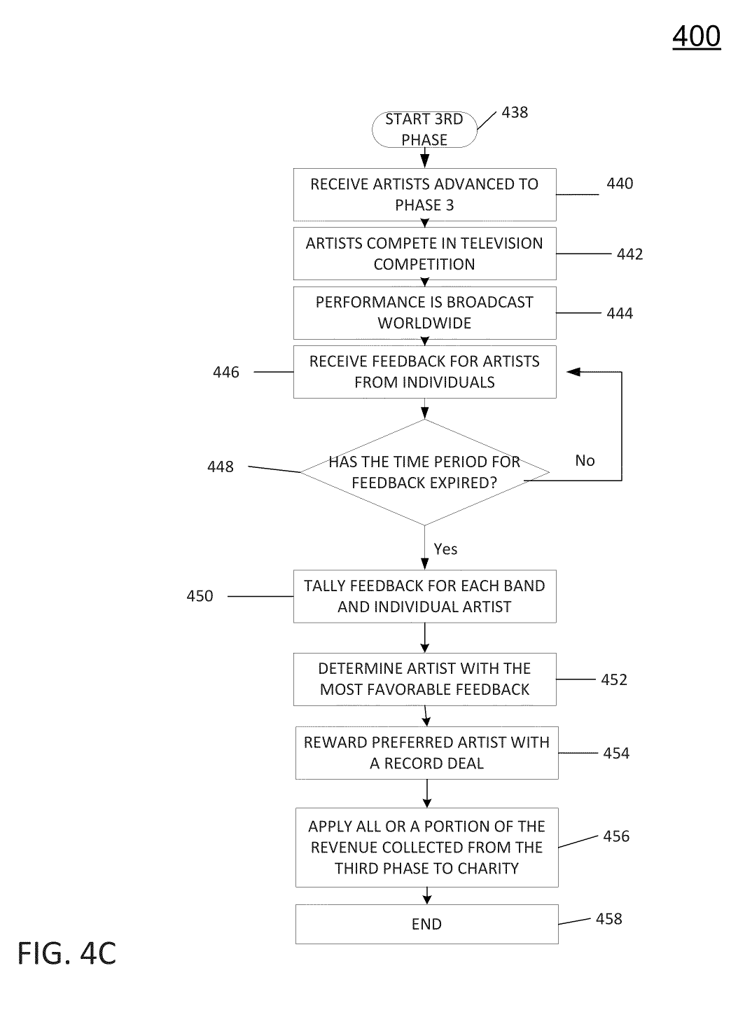

Referring next to FIGS. 4A-4C, illustrated is a flow diagram of an exemplary embodiment of a talent identification process, namely talent identification process 400, in accordance with one embodiment of the present invention. As depicted in FIG. 4A, talent identification process 400 begins at step 402 with the start of the first phase of talent identification process 400, after which talent identification process 400 proceeds to step 404.

At step 404, a plurality of artists and/or bands is selected from existing unaffiliated talent competitions such as battle of the band competitions and various other talent competitions conducted worldwide or in one or more specific, predetermined geographic areas. In one aspect of the present invention, eligible artists and/or bands will consist of artists and/or bands who have reached the finals, semi-finals, or the like in one or more existing local, national, and/or international talent competitions. In some embodiments of the present invention, such artists and/or bands will be required to have an existing portfolio including one or more of artist and/or band biographies, original music, original music videos, professionally recorded songs, and the like. However, such a requirement is not necessary to implement the systems and methods of the present invention. Talent identification process 400 then proceeds to step 406.

At step 406, songs are received from the artists and/or bands selected in step 404. In one aspect of the present invention, such received songs are original works that have been created and performed by the respective artist(s) and/or band(s). However, alternate embodiments of the present invention are envisioned in which such received songs have been created by entities other than the advancing artist(s) and/or band(s). Or, such received songs may be songs originally performed by artist(s) and/or band(s) other than the advancing artist and/or band.

Next, at step 408, the songs received in step 406 are published to an Internet Web site. In one embodiment of the present invention, publishing includes uploading the information to a server or the like, which would typically be hosted by the entity implementing talent identification process 400. Thereafter, critics may access the published songs via a portal such as a Web page of the Internet Web site. Furthermore, the Web site may include a search engine configured to identify published songs via one or more criteria including, but not limited to, artist, band, one or more keywords, and title. In such an embodiment, published songs may be retrieved by entering relevant search criteria in the search engine. Upon executing the search, the song, as well as other information relating to the song and its associated artist and/or band, is made available to the critic for listening, downloading, and/or evaluation. Talent identification process 400 then proceeds to step 410.

At step 410, published songs have been made available to the critic for listening, downloading, and/or evaluation via an Internet Web page. At this point, such individual may listen to or download one or more songs. In some embodiments of the present invention, the user simply clicks a link corresponding to the song and the desired task (e.g., downloading, listening, etc.). In one aspect of the present invention, clicking such links may also redirect the individual to the respective artist's and/or band's Web site to allow the individual to gain additional information regarding the respective artist and/or band.

During step 410, feedback is received for each published song. In one embodiment of the present invention, critics vote for each song. In another embodiment of the present invention, a server or the like through which the songs have been published tallies the number of times each song is accessed by a critic. For example, such server may record the number of times each song is downloaded, listened to, or otherwise accessed. Such critique, feedback, or the like may be gathered or collected via any system and method known in the art or any systems and methods yet to be invented without departing from the scope of the present invention. Such systems and methods include, but are not limited to, Internet tracking, electronic mail, text messaging, servers, telephones, cell phones, Apple IPods™, personal computers, and/or Blackberrys®.

Talent identification process 400 then proceeds to step 412. The first phase of talent identification process 400 will run for a predetermined period. If the time period for such phase has not expired, talent identification process 400 returns to step 410. However, if such time period has expired, talent identification process 400 proceeds to step 414.

At step 414, the feedback received for each song is tallied. In one aspect of the present invention, the songs receiving the highest number of votes from the critics will be selected to advance to the second phase of talent identification process 400. However, alternative methods of tallying feedback may be substituted without departing from the scope of the invention. For example, such tallying may include tallying the number of times each song is downloaded, listened to, or the like. Talent identification process 400 then proceeds to step 416.

At step 416, a plurality of artists and/or bands associated with the songs receiving the most favorable feedback are advanced to the second stage of talent identification process 400. Thereafter, or simultaneous with step 416, such process proceeds to step 418, at which a portion of the revenue collected via talent identification process 400 is donated to charity. Such revenue may include, but is not limited to, fees charged to the critics, advertising or other promotional revenue, sales of goods associated with talent identification process 400, and the like as discussed in greater detail above with respect to FIG. 1.

Next, at step 420, the second phase of talent identification process 400 begins and the process proceeds to step 422. At 422, songs are received from the artists and/or bands advanced from the first phase to the second phase in step 416. Next, at step 424, the received songs are broadcast via radio such as commercial radio, satellite radio, and the like. In some embodiments of the present invention, such songs shall be the same songs evaluated during other phases of talent identification process 400. However, alternate embodiments of the present invention are envisioned in which each advancing artist and/or band must submit new songs for evaluation in one or more of the phases following the first phase. Depending upon the specific embodiment of the present invention, the broadcast songs may be heard by the general public, private subscribers (e.g., satellite radio subscribers), or a combination thereof.

Talent identification process 400 may optionally proceed to step 426, or, alternatively, such step may be omitted. At step 426, songs from the existing “Super Groups”, existing “Super Artists”, or other lesser-known musicians are played in combination with the songs received from the advancing artists and/or bands to provide perspective to the listeners and/or critics and to attract a larger audience of listeners. Talent identification process then proceeds to step 428.

During step 428, feedback is received for each broadcast song. In one embodiment of the present invention, critics vote for each song. Such critique, feedback, or the like may be provided via any system and method known in the art or any systems and methods yet to be invented without departing from the scope of the present invention. Such systems and methods include, but are not limited to, Internet tracking, electronic mail, text messaging, servers, telephones, cell phones, Apple Ipods™, personal computers, and/or Blackberrys®.

Talent identification process 400 then proceeds to step 430. The second phase of talent identification process 400 will run for a predetermined period. If the time period for such phase has not expired, talent identification process 400 returns to step 428. However, if such time period has expired, talent identification process 400 proceeds to step 432.

At step 432, the feedback received for each broadcast song is tallied. In one aspect of the present invention, the songs receiving the highest number of votes from the critics will be selected to advance to the third phase of talent identification process 400. However, alternative methods of tallying feedback may be substituted without departing from the scope of the invention. Talent identification process 400 then proceeds to step 434.

At step 434, a plurality of artists and/or bands associated with the songs receiving the most favorable feedback are advanced to the third stage of talent identification process 400. Thereafter, such process proceeds to step 436, at which a portion of the revenue collected via talent identification process 400 is donated to charity. Such revenue may include, but is not limited to, fees charged to the critics, advertising or other promotional revenue, sales of goods associated with talent identification process 400, and the like as discussed in greater detail above with respect to FIG. 1.

Next, at step 438, the third phase of talent identification process 400 begins and the process proceeds to step 440. At step 440, artists and/or bands advanced from the second phase to the third phase are received. Next, at step 442, the received artists and/or bands will compete in a local, national, or international television competition. In some embodiments of the present invention, such artists and/or bands shall perform the same song or songs evaluated during earlier phases of talent identification process 400. However, alternate embodiments of the present invention are envisioned in which each advancing artist and/or band must perform a new song for evaluation in the third phase of talent identification process 400.

Next, at step 444, the television competition is broadcast to the entire participating geographic area of talent identification process 400 (e.g., worldwide) allows critics within such geographic area to see, hear, and evaluate such artists and/or bands and the associated performances. Such television competition may also be simulcast on the Internet, radio, or the like. Step 444 may occur simultaneously with step 442 (i.e., a live television competition) or subsequent to step 442 (i.e., broadcast of a taped television performance). Talent identification process then proceeds to step 446.

During step 446, feedback is received for each artist and/or band performing in the television competition. In one embodiment of the present invention, critics vote for each song. Such critique, feedback, or the like may be provided via any system and method known in the art or any systems and methods yet to be invented without departing from the scope of the present invention. Such systems and methods include, but are not limited to, Internet tracking, electronic mail, text messaging, servers, telephones, cell phones, Apple Ipods™, personal computers, and/or Blackberrys®.

Talent identification process 400 then proceeds to step 448. The third phase of talent identification process 400 will run for a predetermined period. If the time period for such phase has not expired, talent identification process 400 returns to step 446. However, if such time period has expired, talent identification process 400 proceeds to step 450.

At step 450, the feedback received for each performing artist and/or band is tallied. In one aspect of the present invention, the artist and/or band receiving the highest number of votes from the critics will be selected as the winner of talent identification process 400. However, alternative methods of tallying feedback may be substituted without departing from the scope of the invention. Talent identification process 400 then proceeds to step 452.

At step 452, a determination is made regarding which artist and/or band received the most favorable feedback. Thereafter, talent identification process 400 proceeds to step 454, at which the winning artist and/or band is rewarded. In the embodiment of the present invention depicted in FIGS. 4A-4C, the winning artist and/or band is awarded with a record deal. However, other awards may be substituted without departing from the scope of the present invention.

Next, at step 456, a portion of the revenue collected via talent identification process 400 is donated to charity. Such revenue may include, but is not limited to, fees charged to the critics, advertising or other promotional revenue, sales of goods associated with talent identification process 400, and the like as discussed in greater detail above with respect to FIG. 1. Thereafter, talent identification process 400 ends at step 458.

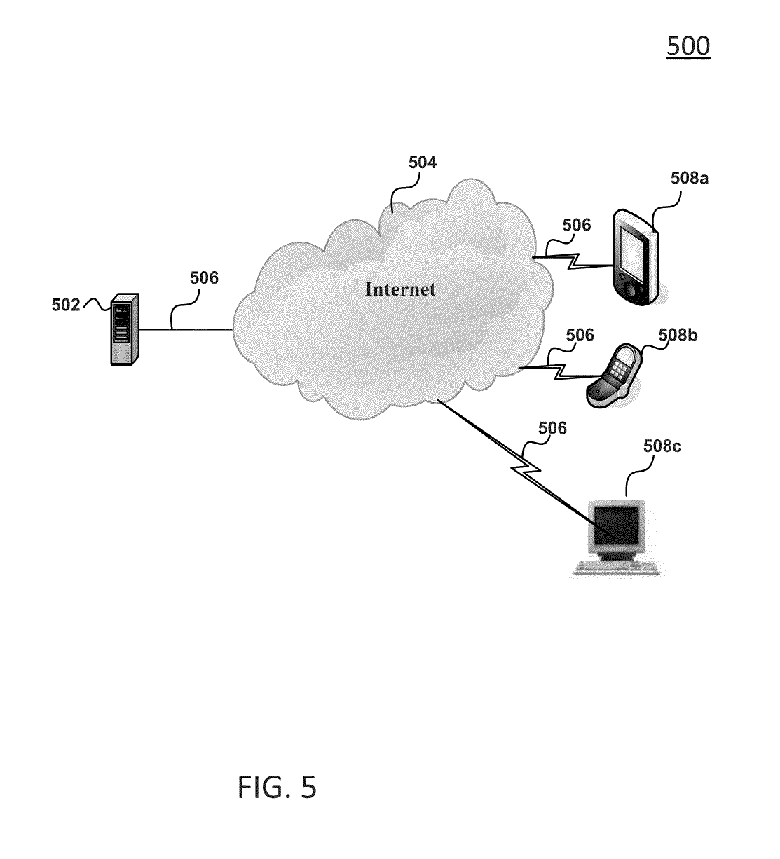

Turning now to FIG. 5, illustrated is a schematic diagram of an exemplary computer environment 500 for receiving critique, feedback, and the like in accordance with an embodiment of the present invention. In the depicted embodiment, computer environment 500 includes, inter alia, data system 502, Internet 504, connections 506, and computing devices 508a, 508b, and 508c.

Computing devices 508a, 508b, and 508c are connected to Internet 504 via connections 506, which may be any form of Internet connection known in the art or yet to be invented. Connections 506 may include, but are not limited to, telephone lines (xDSL, Ti, leased lines, etc.), cable lines, power lines, wireless transmissions, and the like. Computing devices 508a, 508b, and 508c include any equipment necessary (e.g., modems, routers, etc.), as is known in the art, to facilitate such communication with the Internet. Data system 502 is also connected to Internet 504 using one of the aforementioned methods or other such methods known in the art.

Using a system such as that depicted in FIG. 3, a critic may vote for an artist and/or band via a computing device connected to Internet 504 such as computing device 508a, 508b, and 508c. Such a computing device may be the individual's personal computer, an Internet café computer, an Apple IPod™, a computerized portable electronic device (e.g., a personal data assistant, cell phone, etc.), or the like. Using the system exemplified in FIG. 5, such voting may include upload of an electronic form of the information from a computing device 508a, 508b, and 508c via Internet 504 to data system 502 (e.g., server, mainframe, computer, etc.), wherein data system 502 is typically provided and/or managed by the entity implementing the talent identification process or its affiliate, subcontractor, or the like. However, alternate embodiments of collecting votes may be substituted without departing from the scope hereof. For example, in one aspect of the present invention, the voter transmits the vote directly to the entity implementing the talent identification process in electronic format without upload (e.g., via electronic mail). Such transmission may also be performed at a computing device 508a, 508b, or 508c via Internet 504, however, in this scenario, manipulation by the entity's staff or systems may be required prior to transferring the voting information to data system 502.

Although the systems and methods disclosed herein have focused on embodiments in which musical talent is discovered, one of skill in the art may easily appreciate that such systems and methods may be equally applied for identification of other types of non-musical talent such as models, athletes, actors/actresses, and the like.

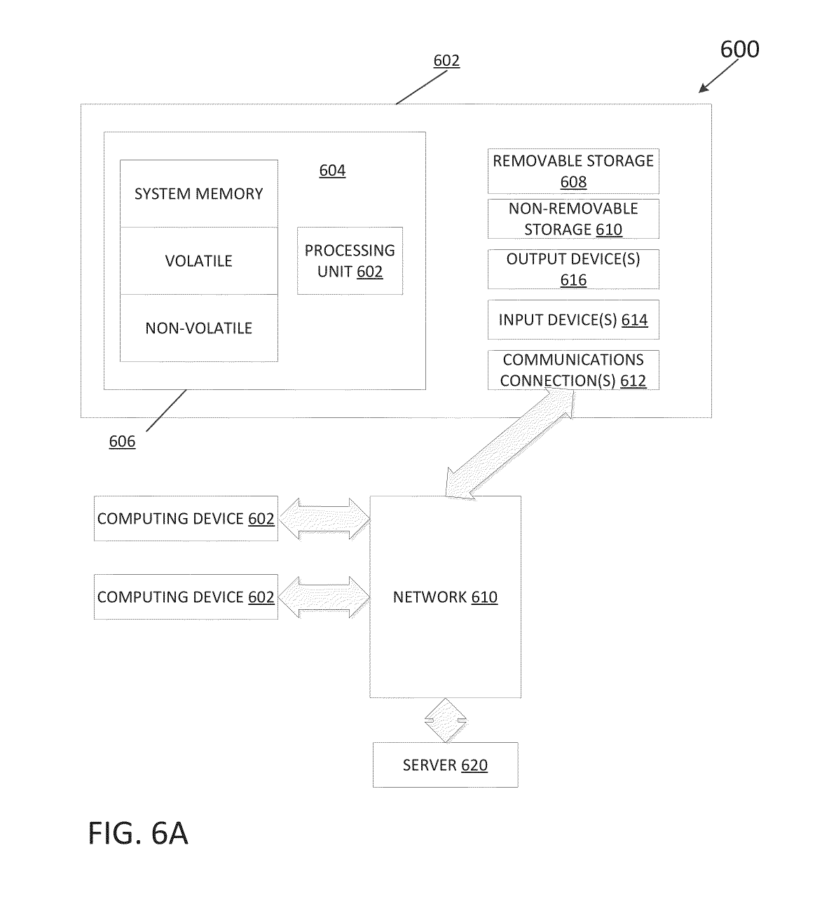

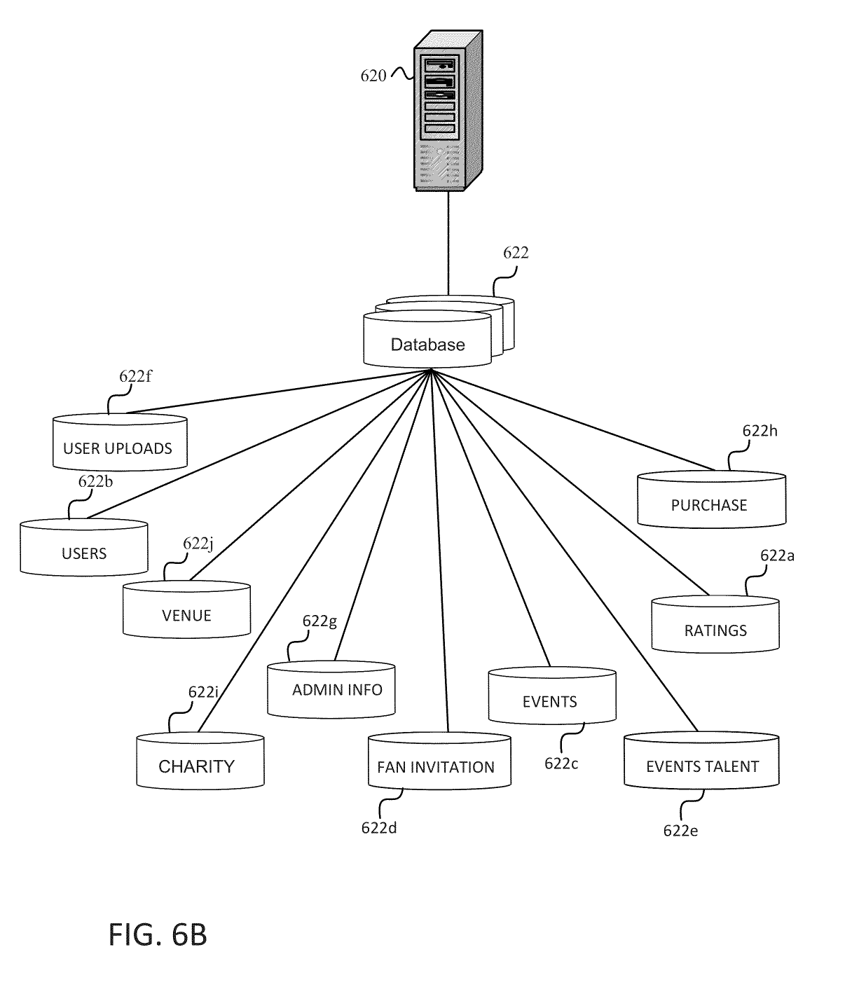

Referring now to FIGS. 6A through 19, depicted are systems and methods for discovering talent in accordance with one embodiment of the present invention. That is, the systems and methods of FIGS. 6A through 19 provide music fans and the like the ability to discover talent on their own and to suggest talent for inclusion in one or more competitions and/or in the community of fans, talent, musicians, and the like created by the systems and methods of the present invention. The systems and methods of FIGS. 6A through 19 also track statistics for the talent that may be utilized by in-house or third party recruiters for career advancement opportunities.

FIGS. 6A and 6B set forth herein represent an exemplary computing system environment for allowing a user of system 600 to perform the methods described with respect to FIGS. 6A through 19. The depicted computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

Referring now to FIG. 6A, depicted is an exemplary system 600 for implementing embodiments of the present invention. This exemplary system includes, inter alia, one or more computing devices 602 and server 620, which interface to each other via network 610. In its most basic configuration, computing device 602 includes at least one processing unit 602 and at least one memory 604. Depending on the exact configuration and type of the computing device, memory 604 may be volatile (such as random access memory (“RAM”)), non-volatile (such as read-only memory (“ROM”), flash memory, etc.), or some combination of the two. This most basic configuration is illustrated in FIG. 6A by dashed lines 606. In addition to that described herein, computing devices 602 can be any web-enabled handheld device (e.g., cell phone, smart phone, or the like) or personal computer including those operating via Android, Apple, and/or Windows mobile or non-mobile operating systems.

Computing device 602 may have additional features/functionality. For example, computing device 602 may include additional storage (removable and/or non-removable) including, but not limited to, magnetic or optical disks or tape, thumb drives, and external hard drives as applicable. Such additional storage is illustrated in FIG. 6A by removable storage 608 and non-removable storage 610.

Computing device 602 typically includes or is provided with a variety of computer-readable media. Computer-readable media can be any available media that can be accessed by computing device 602 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 604, removable storage 608, and non-removable storage 610 are all examples of computer storage media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can accessed by computing device 602. Any such computer storage media may be part of computing device 602 as applicable.

Computing device 602 may also contain communications connection 612 that allows the device to communicate with other devices. Such communications connection 612 is an example of communication media. Communication media typically embodies computer-readable instructions, data structures, program modules and/or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 602 may also have input device(s) 614 such as keyboard, mouse, pen, voice input device, touch input device, etc. Output device(s) 616 such as a display, speakers, printer, etc. may also be included. All these devices are generally known to the relevant public and therefore need not be discussed in any detail herein except as provided.

Notably, computing device 602 is one of a plurality of computing devices 602 inter-connected by a network 110. As may be appreciated, network 110 may be any appropriate network and each computing device 602 may be connected thereto by way of connection 612 in any appropriate manner, and each computing device 602 may communicate with one or more of the other computing devices 602 in network 110 in any appropriate manner. For example, network 110 may be a wired network, wireless network, or a combination thereof within an organization or home or the like, and may include a direct or indirect coupling to an external network such as the Internet or the like. Likewise, the network 110 may be such an external network.

Computing device 602 may connect to a server 620 via such an internal or external network. Although FIG. 6 depicts computing device 602 located in close proximity to server 620, this depiction is not intended to define any geographic boundaries. For example, when network 110 is the Internet, computing device can have any physical location. For example, computing device may be a tablet, cell phone, personal computer, or the like located at any user's office, home, a performance venue for the talent, etc. Or computing device could be located proximate to server 620 without departing from the scope hereof. Also, although FIG. 1 depicts computing devices 602 coupled to server 620 via network 110, computing devices may be coupled to server 620 via any other compatible networks including, without limitation, an intranet, local area network, or the like.

The system uses a standard client server technology architecture, which allows users of the system to access information stored in the relational databases via custom user interfaces. The application is hosted on a server such as server 620 which is accessible via the Internet using a publically addressable Uniform Resource Locator (“URL”). For example, users can access the system using any web-enabled device equipped with a web browser. Communication between software component and sub-systems are achieved by a combination of direct function calls, publish and subscribe mechanisms, stored procedures, and direct SQL queries.

In some embodiments, server 620 is an Edge R200 server as manufactured by Dell, Inc., however, alternate servers may be substituted without departing from the scope hereof. System 600 and/or server 620 utilize a PHP scripting language to implement the processes described in detail herein. However, alternate scripting languages may be utilized without departing from the scope hereof.

The exemplary embodiment of the present invention utilizes a Linux variant messaging subsystem. However, alternate messaging subsystems may be substituted including, without limitation, a Windows Communication Foundation (“WCF”) messaging subsystem of a Microsoft Windows operating system utilizing a .NET Framework 3.0 programming interface.

Also, in the depicted embodiment, computing device 602 interacts with server 620 via a Transmission Control Protocol/Internet Protocol (“TCP/IP”) communications protocol; however, other communication protocols may be substituted.

Computing devices 602 are equipped with one or more Web browsers to allow them to interact with server 620 via a HyperText Transfer Protocol (“HTTP”). HTTP functions as a request-response protocol in client-server computing. For example, a web browser operating on computing device 602 may execute a client application that allows it to interact with applications executed by server 620. The client application submits HTTP request messages to the server. Server 620, which provides resources such as HTML files and other content, or performs other functions on behalf of the client application, returns a response message to the client application upon request. The response typically contains completion status information about the request as well as the requested content. However, alternate methods of computing device/server communications may be substituted without departing from the scope hereof.

In the exemplary system 600, server 620 includes one or more databases 622 as depicted in FIG. 6B, which may include a plurality of database tables including, without limitation, Ratings, Users, Events, Fan Invitation, Events Talent, User Uploads, Admin Info, Purchase, Charity, and Venue database tables 622a through 622j. As may be appreciated, database(s) 622 may be any appropriate database capable of storing data and it may be included within or connected to server 620 or any plurality of servers similar to 620 in any appropriate manner.

In the exemplary embodiment of the present invention depicted in FIGS. 6A and 6B, database(s) 622 are structured query language (“SQL”) database(s) with a relational database management system, namely, MySQL as is commonly known and used in the art. Database(s) 622 are resident within server 620. However, other databases may be substituted without departing from the scope of the present invention including, but not limited to, PostgreSQL, Microsoft® SQL Server 2008 MySQL, Microsoft® Access®, and Oracle databases, and such databases may be internal or external to server 620.

It should be understood that the various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application-program interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as system 100 or a distributed computing environment. Still further, aspects of the presently disclosed subject matter may be implemented in or across a plurality of processing chips or devices, and storage may similarly be effected across a plurality of devices in system 100. Such devices might include personal computers, network servers, and handheld devices (e.g., cell phones, tablets, smartphones, etc.), for example.

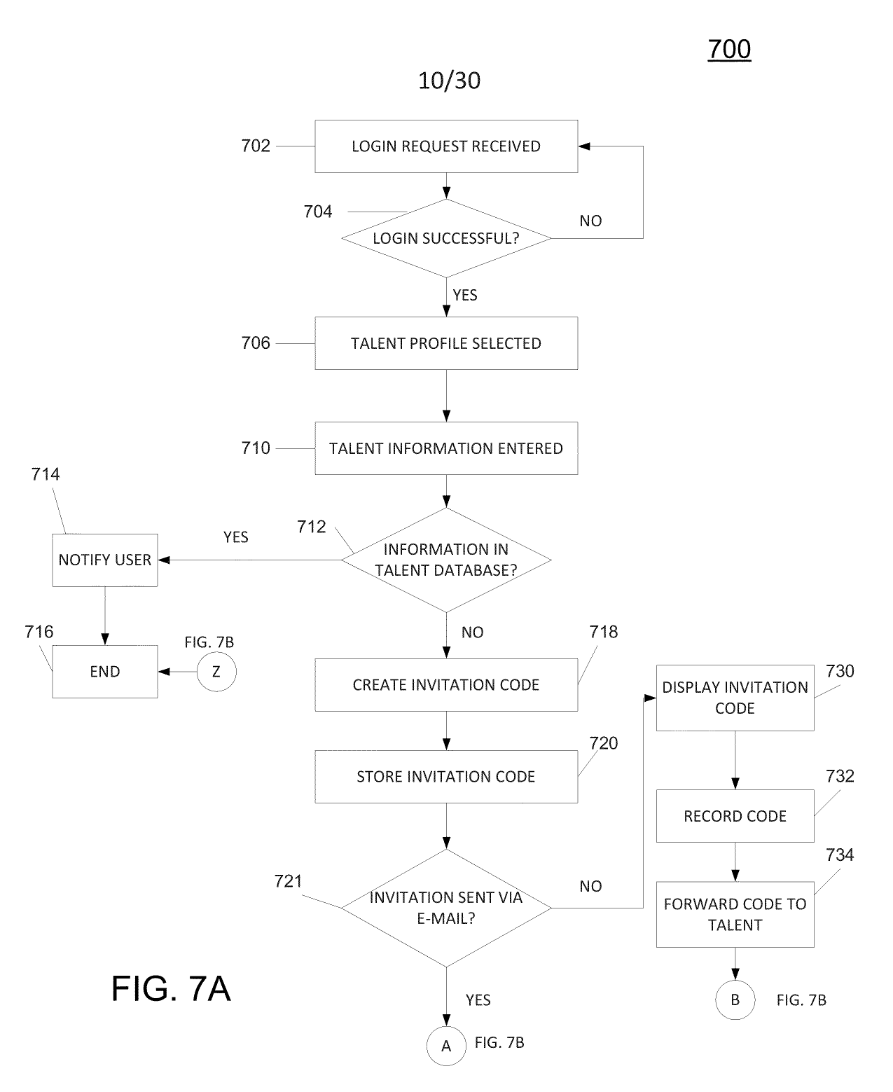

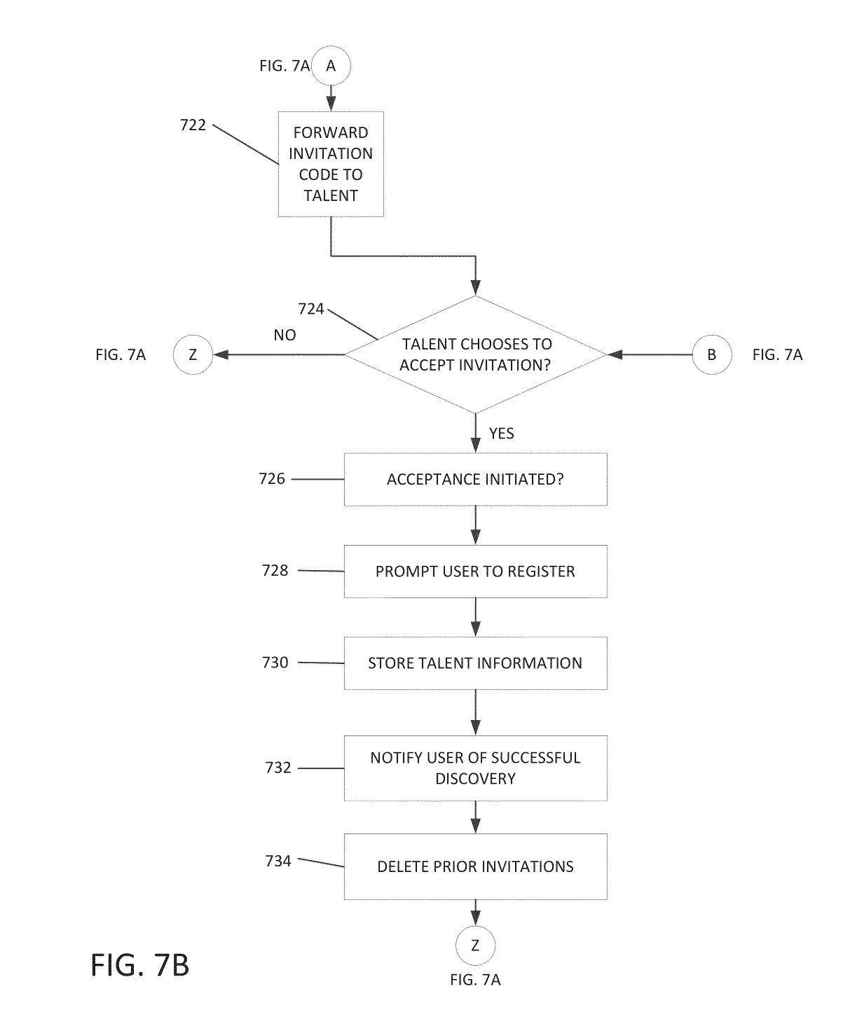

In the exemplary embodiment, server 620 and its associated databases are programmed to execute a plurality of processes including those shown in FIGS. 7A through 11B and 13A through 18B as discussed in greater detail below. Turning now to FIGS. 7A and 7B, depicted is process 700 for allowing a user of the systems and methods of the present invention to discover talent in accordance with one embodiment of the present invention. In the depicted embodiment, such discovery involves the sending of an invitation for the talent to join the community created by the systems and methods of the present invention.

Process 700 starts at 702, at which system 600 receives a login request from a user. The users referenced herein may be any member of the public. Each user becomes a member of the community created by the systems and methods of the present invention by accessing a Web page or the like associated with system 600 and selecting a registration option. Such access is similar to that discussed below for logging in to system 600. Thereafter, the user enters various information and selects login data (e.g., a user name and password) that will be used to access the user's account at a future date as is known in the art.

The login request typically involves entry of a user identification (“ID”) and password via the user's computing device 602 as is known in the art. For example, a user may open an Internet browser such as Internet Explorer, Google Chrome, Firefox, Safari or the like, and may enter the desired Uniform Resource Locator (“URL”) to access one or more predefined Web pages provided by server 620. The Web page displayed to the user includes one or more hyperlinks, text entry boxes, and/or the like to facilitate entry of a user ID and password as is known in the art. Alternate methods of accessing the systems and methods of the present invention may also be added or substituted without departing from the scope hereof including mobile applications that provide access to same via any one or more mobile devices such as smartphones, tablets, Web-enabled appliances, and the like.

At step 704, if the user ID and password matches the information included in, for example, Users table 622b, the user is logged into system 600 and process 700 proceeds to 706. If a match does not occur, process 700 proceeds to 702, at which the user is prompted to re-enter the correct user ID and password.

At 706, process 700 prompts the user to select or otherwise enter a talent profile type for the talent the user wishes to “discover.” In the depicted embodiment, the profiles that may be selected by a user are dependent upon the type of user discovering the talent. The user's type is assigned when the user first registers with system 600 as discussed above. That is, during the registration process, the user is assigned a user type of fan, intern, or school discoverer. Any user wishing to register with the systems and methods of the present invention may register with the type of “fan.” Intern type users are selected by administrators of the systems and methods of the present invention, for example, via selection for a school (e.g., college) internship program or the like. “School discoverer” types are assigned to any users that are discovered by “interns” as discussed in greater detail below. However, alternate user types and alternate methods of assigning user types may be substituted without departing from the scope of the present invention.

In the depicted embodiment, a “fan” can be any user of the system including, without limitation, people or talent following established talent and/or wishing to discover established talent. The system is designed that a fan may only discover established talent; however, alternate embodiments of the present invention are envisioned in which a fan can discover other types of talent instead of, or in addition to, established talent.

In the depicted embodiment, “established talent” is talent with original art (e.g., music), a cover artist (i.e., a musical artist who records a version of a song that was originally recorded by another artist), or a disc jockey (“DJ”).

An “intern” is part of an internship program (e.g., a college internship program) associated with the systems and methods of the present invention. An “intern” has the same abilities as a “fan” but they also have the additional ability to discover “developing talent” and/or “school discoverers.” A “developing talent” is talent that is just starting his or her career and has not yet created original art, for example, music. In addition, developing talent may not yet have determined how to classify their music and/or artistic ability. Once developing talent has been discovered by an intern, he or she can upload original art (e.g., an original song) and test its popularity in various ways.

Any discovered developing talent becomes a part of the discovering intern's network. This allows the discovered developing talent to test his/her/their popularity by uploading raw versions of original music and videos for access by other people in the network. Additionally, the developing talent receives instant feedback from the network. For example, developing talent may view information including, but not limited to: the number of people in the network who have added the talent's art (e.g., song(s), videos, etc.) to his or her playlist or favorites playlist as described in greater detail below; how many times the talent's art has been viewed or played; quantity of fans requesting the talent to participate in a live event; and other feedback gathered by system 600 as discussed in greater detail below. In the depicted embodiment, all talent media added to a user's favorite list is tallied as a count of “favorite” songs, “favorite” videos, or the like associated with the talent.

Developing talent cannot sell songs or other art or items via the systems and methods of the present invention unless they are reclassified as “established talent.” As long as the developing talent has uploaded an original song, this reclassification can be done with a simple change in his/her/their profile setting. This allows developing talent to remain in the “developing” mode until the talent decides which direction to take as a musician.

Talent profile settings are setup by the talent during registration as discussed in greater detail below with respect to 728. Talent profiles may include information such as, but not limited to: username; password; e-mail address; address; talent category (e.g., original, developing, or DJ); age; gender; talent type (e.g., solo, band, etc.); live performer (i.e., whether the talent is willing to perform live events); one or more genres of music played by the talent (e.g., Indie, Rock, Alternative, Jazz, etc.); talent profile picture; the distance the talent is willing to travel to perform at an event; one or more charities to whom the talent wishes to donate funds; whether the talent wishes to be notified of potential performance events that match the talent's profile settings; and agreement to terms and conditions of participation in the systems and methods of the present invention. However, information may be substituted, deleted, or added to the profile without departing from the scope hereof.

In the depicted embodiment of the systems and methods of the present invention, the developing talent can change his or her profile to: “Original Artist” (i.e., the artist has uploaded original material); “Cover Artist” (i.e., the talent has decided not to write or upload his or her own original material but has uploaded the talent's performance of another person's music); or “DJ” (i.e., the talent has uploaded a sample mix created by the talent or a video of the talent working at a party or a club).

A “school discoverer” is a college, high school, or middle school student who is not an intern. A “school discover” is discovered by an intern and becomes a part of the intern's network. The school discoverer can discover established talent and/or developing talent. If talent discovered by a school discoverer makes sales via the systems and methods of the present invention, the school discoverer and the intern that discovered the school discoverer share in any commissions, rewards, promotions, and the like related to the discovered talent. For example, in the depicted embodiment, both the intern and the school discoverer receive a commission in the amount of 2.5% of all sales made by the discovered talent (i.e., they share the commission awarded to a fan in equal proportions). However, other methods or rewarding or compensating fans, interns, and/or school discoverers for their discovered talent may be substituted without departing from the scope hereof.

Once the school discoverer earns the ability to become an intern, he or she will be awarded 100% of all rewards, promotions, or the like associated with the talent he or she discovers after becoming an intern. That is, for future discoveries only, the school discoverer turned intern will no longer have to share the commissions with the intern that discovered him or her. In the depicted embodiment, the new intern will continue to share the commissions with the intern that discovered him or her for all talent discovered before the date upon which the school discoverer becomes an intern. However, alternate methods of awarding commissions may be substituted without departing from the scope hereof.

In sum, in the depicted embodiment, if a user is a fan, he or she is only permitted to discover talent that has a talent profile of established. If a user is an intern or school discoverer, he or she is permitted to discover talent having a talent profile of developing or established. However, alternate configurations and/or options may be substituted.

Process 700 then proceeds to 710, at which the user enters the e-mail information for the discovered talent. In the depicted embodiment of the present invention, the user also selects a profile for the talent (e.g., original artist, cover artist, DJ, etc.). If the talent receiving the invitation does not agree with the profile selected by the inviting user, the talent must decline the invitation (i.e., the talent does not have the ability to change his or her profile). However, alternate embodiments are envisioned in which the talent may alter his or her profile. Also, in the depicted embodiment, although the entered information includes the talent's name, e-mail address, and profile, alternate information may be substituted.

Next, at 712, the information entered at step 710 is compared to the information stored in Users table 622b (FIG. 6B). If there is a match (e.g., if the talent's email address matches the email address of talent that already exists in Users table 622b), this indicates that the talent already has an account, and process 700 proceeds to 714 at which the user is notified that the talent has already been “discovered” (i.e., the talent already has an account in Users table 622b).

In the depicted embodiment, such notification includes the automatic generation and transmission (e.g., by server 620) of a predefined email that is sent to the e-mail address associated with the user as stored, for example, in Users table 622b. An email may be sent, for example, via network 610 via a standard Simple Mail Transfer Protocol (“SMTP”) server and third party SMTP services such as those provided by Yahoo, Google, or the like. However, various methods of communication and methods of interfacing with same may be substituted without departing from the scope hereof including, without limitation, Short Message Service (“SMS”), Facebook®, Twitter®, pushing the notification via a mobile application, etc. For example, if the message is sent via SMS, it may be transmitted utilizing a web-based SMS gateway interacting with an API executed by server 620 or the like. Process 700 then ends at 716. Such alternate methods may be utilized for any notification sent via system 600 including those discussed in greater detail below.

Alternatively, if at 712, the information entered at step 710 is not present in Users table 622b, process 700 proceeds to 718 at which an invitation code is generated. In the depicted embodiment, the invitation code is automatically generated by a server such as server 620, and it includes the user's ID (i.e., a numeric identifier associated with the user and stored in Users table 622b in conjunction with the user's other information) followed by a random code. In some embodiments, the random code is generated by built in PHP or MySQL functions such as md5 and sha1. However, alternate random codes may be substituted including a code that simply increments the prior issued code by a predetermined value. The resulting invitation code is then stored in Fan Invitation table 622d (FIG. 6B) in step 720. The profile type for the talent (i.e., developing or established) may also be stored in this table and linked to the invitation code.

Process 700 then proceeds to 721, at which the user selects or otherwise enters data to cause an invitation to be sent to the discovered talent via electronic mail (“e-mail”) or another method (e.g., a text message, a hyperlink, Facebook® message, Twitter® message, etc.). In the depicted process, one alternate method of delivering an invitation is the sending of a hyperlink to the discovered talent, but any one or more methods of sending an invitation may be substituted without departing from the scope of the present invention.

If the user decides to send the invitation via e-mail, process 700 proceeds to 722, as depicted in FIG. 7B, at which the invitation code is forwarded to the discovered talent. In the depicted embodiment, such notification includes the automatic generation and transmission (e.g., by server 620) of a predefined email that is sent to the e-mail address associated with the talent as entered at step 710. This e-mail may include an embedded hypertext link upon which the recipient may click in order to accept the invitation. An email may be sent, for example, as discussed above with respect to step 714.

It should be noted that there is no limit to the quantity of users who can generate and send one or multiple invitations to a particular talent who is not registered with the systems and methods of the present invention. That is, system 600 will generate an unlimited quantity of invitation codes until the particular recipient talent accepts one of the invitations. Once an invitation is accepted, no more invitation codes may be generated for this talent, and all previous invitations are deleted from Fan Invitation table 622d (FIG. 6B). However, alternate methods are envisioned in which the quantity of invitations is limited in some manner and/or the previously sent invitations are retained in database 622.

Referring back to step 721 as discussed above with reference to FIG. 7A, if a user does not wish to send the invitation via email, process 700 proceeds to step 730. At step 730, the new invitation code is displayed to the user. In the depicted embodiment, the code is displayed via one or more predefined Web pages provided by server 620 to the user via, for example, the user's Web browser. Or, as an alternative to, or in addition to a Web browser, the code may be provided via display on a mobile device such as a smartphone, tablet, Web-enabled appliance or the like. Or the code may be sent via SMS. Any compatible method of providing or displaying the code to the user may be substituted without departing from the scope hereof. Then, at 732, the user may memorize or otherwise record the code for use in step 734. For example, the user may copy and paste the code from a Web browser to a document for storage. Any method of recording or memorizing the code may be utilized without departing from the scope hereof including, without limitation, memorization of the code by the user.

At 734, the user forwards the invitation code to the talent. The methods of forwarding the code are numerous and include, without limitation, sending via Facebook® message, Twitter® message, Talent Contact Forums, regular mail, electronic mail, telephone, SMS, blogs, and the like. Thereafter, process 700 proceeds to 724 as depicted in FIG. 7B.

At 724, the talent has received an invitation code via one of multiple methods and decides whether or not to accept the invitation. If the talent does not wish to accept the invitation, process 700 proceeds to 716, at which it ends.

Alternatively, if at 724, the talent wishes to accept the invitation to join the community created by the systems and methods of the present invention, process 700 proceeds to 726, at which acceptance of the invitation is initiated. In the depicted embodiment, if the discovered talent received the invitation via e-mail via step 722, initiating acceptance includes clicking a hypertext link embedded in the email. This clicking directs the user to an invitation acceptance Web page. Or, alternatively, if the invitation code was sent to the recipient via alternate methods such as those described in step 734, acceptance of the invitation may require the user to access a Web page via a predefined URL via the user's Web browser. This Web page will then prompt the user to enter his or her invitation code. However, alternate methods of accepting the invitation may be substituted without departing from the scope hereof including, without limitation, calling a customer service representative, emailing or texting the intent to accept, and the like.

Next, at 728, the discovered talent is prompted to register with the systems and methods of the present invention via display of one or more registration Web pages that include various methods of entering information (e.g., text entry boxes, pull down menus, etc.). The registration Web page(s) vary based upon whether the talent is a developing or established talent, and this information may be determined by the invitation code. That is, when server 620 receives the invitation code entered by the talent, it reads the profile type (e.g., developing, established talent, etc.) associated with the invitation code as stored in Fan Invitation table 622d (FIG. 6B) and presents the talent with the proper registration page. However, as discussed above, alternate forms of talent registration may be substituted including, without limitation, mail in forms, telephonic registration, and the like.

Once all of the talent's information has been entered via the registration Web page(s), a record is created for the talent that includes such information. In the depicted embodiment, the information is stored as a new database record in Users table 622b at step 730. In the depicted embodiment, the database record includes, inter alia, the following fields: Discovered User (i.e., this field is populated with the User ID for the discovered talent) and Discovering User (i.e., this field is populated with the User ID(s) for the fan or fans who discovered the talent). The User ID of the discovering user may be derived from the invitation code. However, alternate table fields may be substituted without departing from the scope hereof.

Next, at 732, the user(s) who discovered the new talent is notified of a successful discovery. In the depicted embodiment, such notification includes the automatic generation and transmission (e.g., by server 620) of a predefined email that is sent to the e-mail address associated with the discovering user as entered and stored in, for example, Users table 622b (at the time the user initially registered with the systems and methods of the present invention). This e-mail may include the user ID associated with the discovered talent to allow the user to, for example, promote and track the success of the discovered talents' music or other media and associated products/promotional items. An email may be sent, for example, as discussed above with respect to step 714. However, alternate methods of notifying the user(s) of the successful discovery of talent may be substituted including, without limitation, SMS text, telephonic, etc. Process 700 then proceeds to 734, at which any prior invitations sent to the talent are deleted from Fan Invitation table 622d. Thereafter, process 700 proceeds to 716, at which it ends.

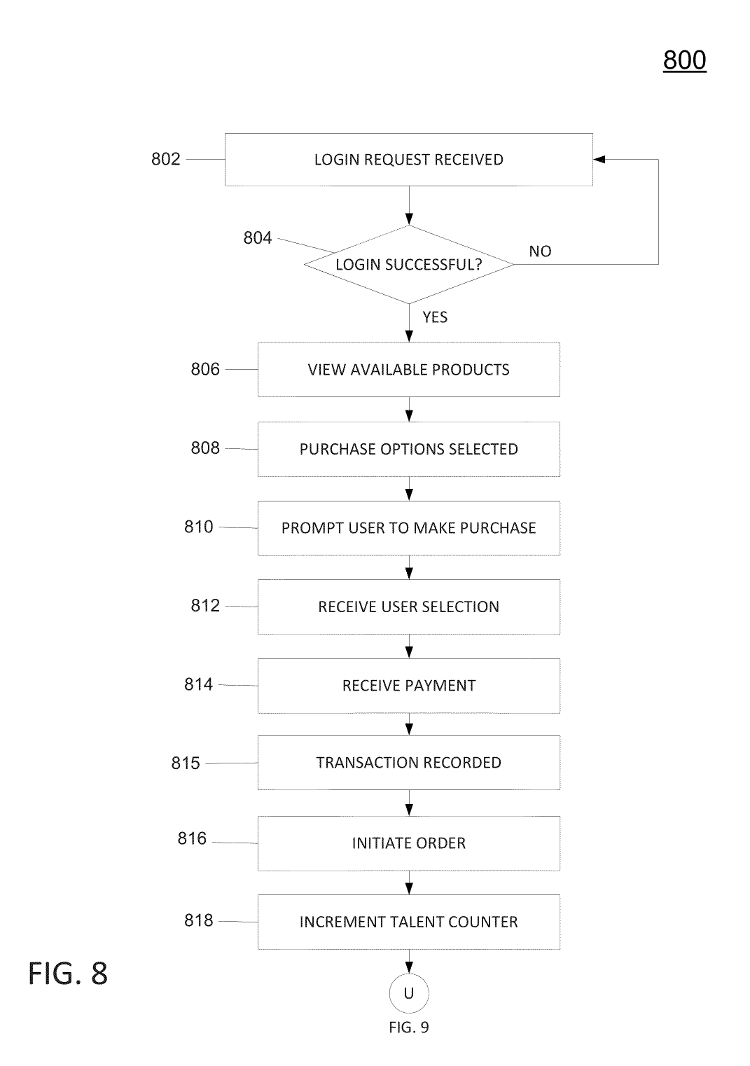

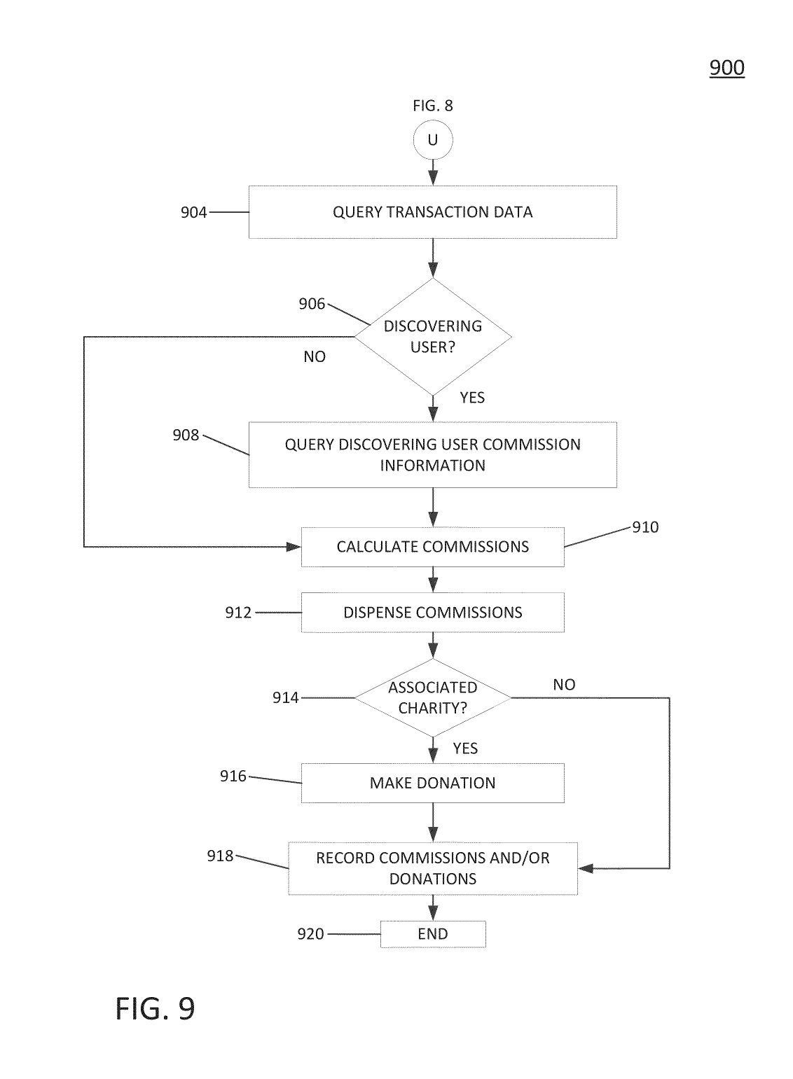

Turning now to FIG. 8, depicted is a process for allowing a user to purchase talent products in accordance with the alternate embodiment of the present invention depicted in FIGS. 6A through 19. Process 800 starts at 802, at which system 600 receives a login request from a user as described in greater detail above with respect to 702. Next, at step 804, if the user ID and password matches the information included in, for example, Users table 622b, the user is logged into system 600, and process 800 proceeds to 806. If a match does not occur, process 800 returns to 802, at which the user is prompted to re-enter the correct user ID and password.

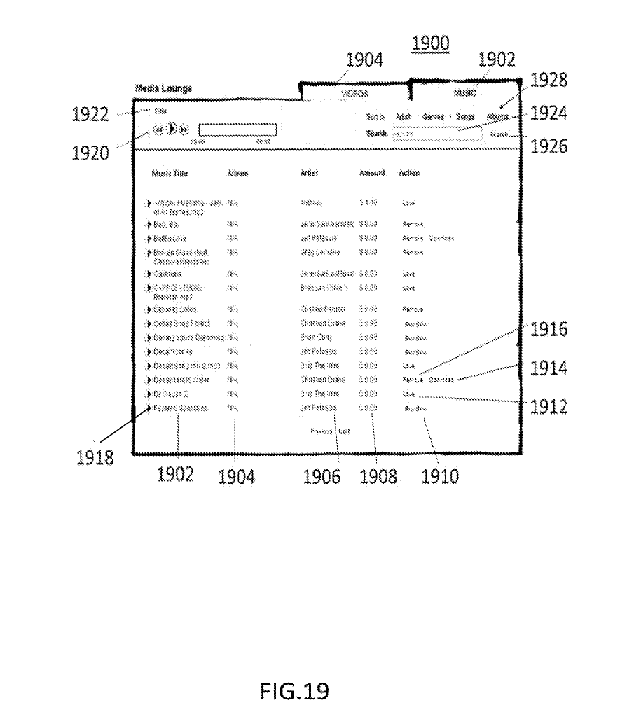

At 806, process 800 allows the user to view the talent's products available for purchase. The user may find such material by searching, for example, all products uploaded for sale by a particular talent. Such products may be listed, for example, on one or more Web pages associated with the talent. Once the user finds the product(s) that he or she wishes to purchase, the user selects the product(s) to be downloaded by clicking, for example, a purchase button or the like (e.g., similar to Buy Now button 1910 as shown in FIG. 19), and process 800 proceeds to 808.

At 808, the user selects purchase options. For example, in the depicted embodiment, these options include delivery method (e.g., download, standard delivery, 2 day delivery, etc.), destination name, destination address, and the like. Next, process 800 proceeds to 810, at which the user is prompted to make a purchase.

Next, at 812, process 800 receives the user's selection (i.e., product to be purchased). Then, at 814, process 800 provides the user with a means for making payment, for example, a Web site or the like. In the depicted embodiment, the user is directed to a www.paypal.com Web site via a PayPal® API or the like, however, alternate methods of receiving payment may be substituted including, without limitation, Paymentech™ methods as offered by Chase Bank. Once payment has been received, process 800 proceeds to 815.

At 815, the information related to the processed transaction is recorded in a table such as Purchase table 622h (FIG. 6B). The database record may include information such as, but not limited to, talent user ID, total sale price, total revenue derived from sale, purchaser user ID, date of sale, and the like. The processed transaction data may also be linked to the database record of the talent whose goods or services are being purchased.

Then, at 816, the shipment of the order is initiated. This step includes sending the information received at step 808 to a third party that warehouses, packages, and/or ships the purchased products to the address entered by the user. Process 800 then proceeds to 818, at which the Products Sold field of the talent who sold the product(s) is incremented by the number of products purchased. This field maintains a running tally of all of the products sold by the talent via the systems and methods of the present invention during the talent's career. Such a field may be stored, for example, in Purchase Talent table 622h or the like without departing from the scope hereof. Although the depicted embodiment includes the ability to track every product purchased, alternate embodiments are envisioned in which different types of products are tallied in different fields. For example, a field may be created for each type of product sold (e.g., T-shirts Sold field, Mugs Sold field, Posters Sold field, etc.). Or, the sales amount (e.g., total dollar sales) may be tallied in addition to, or in lieu of, the quantity of products sold. Process 800 then initiates process 900 as depicted in FIG. 9 and as described in greater detail below.

Turning now to FIG. 9, depicted is a flowchart of one method 900 of rewarding a user for discovering talent in accordance with the alternate embodiment of the present invention set forth in FIGS. 6A through 19 as discussed herein. In one aspect of the invention, users are rewarded via the payment of a commission on (or percentage of) all future sales associated with the discovered talent. In other words, once the discovered talent is registered with system 600, the talent may utilize the systems and methods of the present invention to sell talent products including, without limitation, music downloads, video downloads, and talent promotional items (e.g., t-shirts, mugs, backpacks, hats, and the like) via system 600 as described above with regards to process 800. However, alternate methods of offering talent products may be substituted without departing from the scope hereof including, without limitation, third party e-commerce solutions.

In the depicted embodiment, the commission is paid as soon as the transaction is processed. That is, upon the purchase of a talent's music or goods, the discovering user(s) (e.g., fans, interns, and/or school discoverers) are immediately rewarded via, for example, deposit of the commission into a PayPal® account or the like. However, alternate embodiments are envisioned in which rewards are awarded on a predetermined time schedule (e.g., monthly, quarterly, semi-annually, annually), and process 900 is executed for every discovered talent on that predetermined time schedule. Or, process 900 may be executed for a particular talent whenever the discovering user prompts the system to do so.

In the depicted embodiment, the user discovering the talent is rewarded based upon the talent's Internet and mobile (e.g., cellular phone, electronic tablet, etc.) sales only, regardless of where those transactions are made (e.g., at a show, at home, etc.). However, alternate embodiments are envisioned in which rewards for varying sales are substituted or added without departing from the scope hereof.

First, at step 904, the e-commerce transaction data recorded in step 815 (See FIG. 8) is queried to determine the talent ID associated with the processed transaction, the total dollar amount of the sale, and the e-mail address of the talent. Then, at 906, the talent's user record (as stored, for example, in Users table 622b) is queried to determine whether one or more discovering users are associated with the talent whose goods or services were purchased, and the associated e-mail addresses. That is, in the depicted embodiment, if the talent whose goods or services are being purchased was discovered by a user of system 600 via a process such as process 700, as discussed above, the discovering user's or users' identity(ies) are associated with the talent's database record as stored in a database table such as Users table 622b. For example, the user ID(s) of the discovering user(s) may be stored in discoverer field(s) associated with the talent's database record.

If, at 906, a discovering user is not found, process 900 proceeds to 910 and operates as discussed below. This may occur, for example, if talent independently decides to register with the systems and methods of the present invention without being referred or invited by another user. In the depicted embodiment, a user must be invited by another user; however, alternate embodiments are envisioned in which an invitation is not required.

Alternatively, if, at 906, a discovering user is found, process 900 proceeds to 908, at which it analyzes the data associated with the discover field(s) as read in step 906. In the depicted embodiment, if one discovering user ID is found, the commission information is set to equal a predetermined discoverer commission percentage, for example, five percent (5%). As discussed below, the discoverer's commission is a percentage of total sales, therefore, this commission information allows the commission to be calculated. Or, if more than one discovering user IDs are found, in the depicted embodiment, each discovering user shares equally in the predetermined discoverer commission percentage (again, in this example, five percent (5%)). That is, if there are two discovering users, each such user shall be entitled to two and one half percent (2½%) of total sales. This may happen, for example, when the first discoverer is an intern and the second discoverer is a school discoverer associated with that intern. If discovering user ID(s) are found, the e-mail address(es) associated with those user IDs are also obtained for use in step 908.

However, alternate embodiments of the present invention are envisioned in which varying commission percentages are utilized for different discoverers. In such a scenario, a particular discoverer's unique commission percentage may be stored along with the discoverer's database record and it may be read as part of step 908. This information may be stored, for example, in Users table 622b in association with the discovering user's user ID. Also, although the depicted embodiment calculates the commission based upon a percentage of total sales, virtually any other form of commission may be substituted including, without limitation, a percentage of gross revenue or some other amount, a flat fee, a fixed dollar amount, reward points per dollar of total sales, etc.

Next, at 910, all commissions for a particular transaction are calculated. In the depicted embodiment, commissions are paid to the discovering user(s), and the talent associated with the purchased goods or services. The commission(s) for the discovering user(s) are calculated based upon the data retrieved in steps 904 and 908. For example, in the depicted embodiment, the commission(s) are calculated by multiplying the commission percentage(s) retrieved or determined in step 908 by the total sales amount of the transaction as retrieved in step 904. In this scenario, the commission is a monetary amount, however, non-monetary commissions may also be issued (e.g., credits towards the purchase of talent products, points, etc.).

In the depicted embodiment, the talent commission is calculated based upon the sales data retrieved in step 904 and a predetermined talent commission percentage (e.g., 80%). That is, in the depicted embodiment, the talent commission is calculated by multiplying the talent commission percentage by the total sales amount of the transaction as retrieved in step 904. Again, in this scenario, the talent commission is a monetary amount, however, non-monetary commissions may also be issued (e.g., credits towards the purchase of products, points, etc.).

After all commissions have been calculated, process 900 proceeds to 912. At 912, the commissions are dispensed to the discovering user(s), if any, and the talent. In the depicted embodiment, the monetary values calculated at step 910 are dispensed to PayPal® accounts associated with same. This dispensation is done automatically utilizing an API sub-routine developed by PayPal®. This sub-routine receives the dollar amount to be dispensed, as calculated in step 910, as well as the talent and discovering user's payout email addresses as retrieved during steps 904 and 908. This information allows the API sub-routine to automatically deposit the commissions into the PayPal® accounts of the talent and discovering users. However, alternate methods of dispensing commissions may be substituted including, without limitation, mailing of a check, direct deposit to a bank account, issuance of a monetary credit or points to be utilized for products, and the like. Thereafter, process 900 proceeds to 914.

It should be noted that any portion of the total sale that has not been dispensed as a commission to the talent and/or discovering user(s) is retained by the provider of the systems and methods of the present invention. In the depicted embodiment, such provider retains fifteen percent (15%) of the total sales amount when there are one or more discovering users, and twenty percent (20%) of the total sales amount when there are no discovering users. However, varying amounts and/or percentages may be substituted without departing from the scope hereof.

Next, at step 914, the database record associated with the talent is queried to determine whether or not that talent has selected one or more charities. If no, process 900 proceeds to step 918, as discussed in greater detail below. If yes, process 900 proceeds to step 916. At 916, a portion of the total transaction sales is donated to the selected charity (ies). The information for payment to the charities may be read from Charity table 622i and may be deposited, for example, via a PayPal® account associated with the charity. However, other methods of dispensing charitable contributions may be substituted including, without limitation, mailing of a check, direct deposit to a bank account, issuance of a monetary credit or points to be utilized for products, and the like.

Next, process 900 proceeds to 918, at which all paid commissions and/or donations are recorded in database 622. For example, information such as dollar value, date, time, and talent responsible for each charitable donation may be recorded in database 622 in a table such as Charity table 622i. Similarly, the dollar value, date, and time of commission payments paid to users may be recorded in database 622 in a table such as Users table 622b. However, varying types of information may be recorded in database 622 or elsewhere without departing from the scope of the present invention. Thereafter, process 900 proceeds to 920, at which it ends.

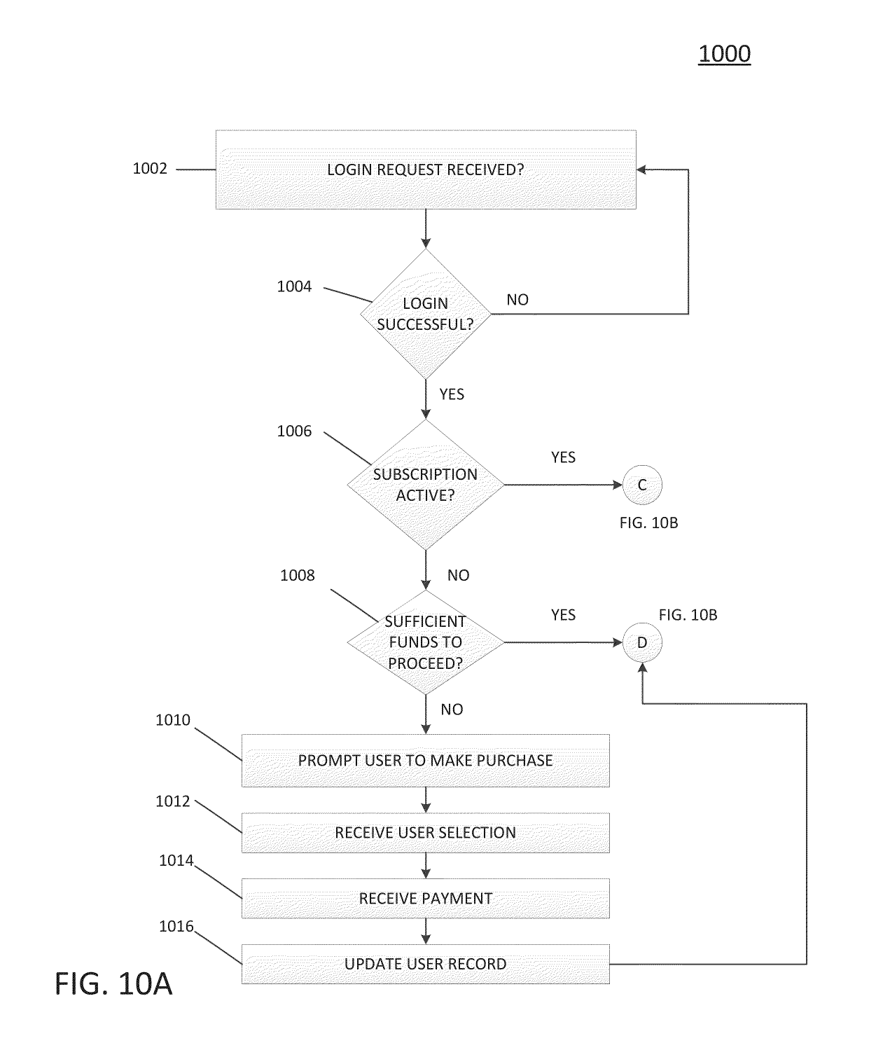

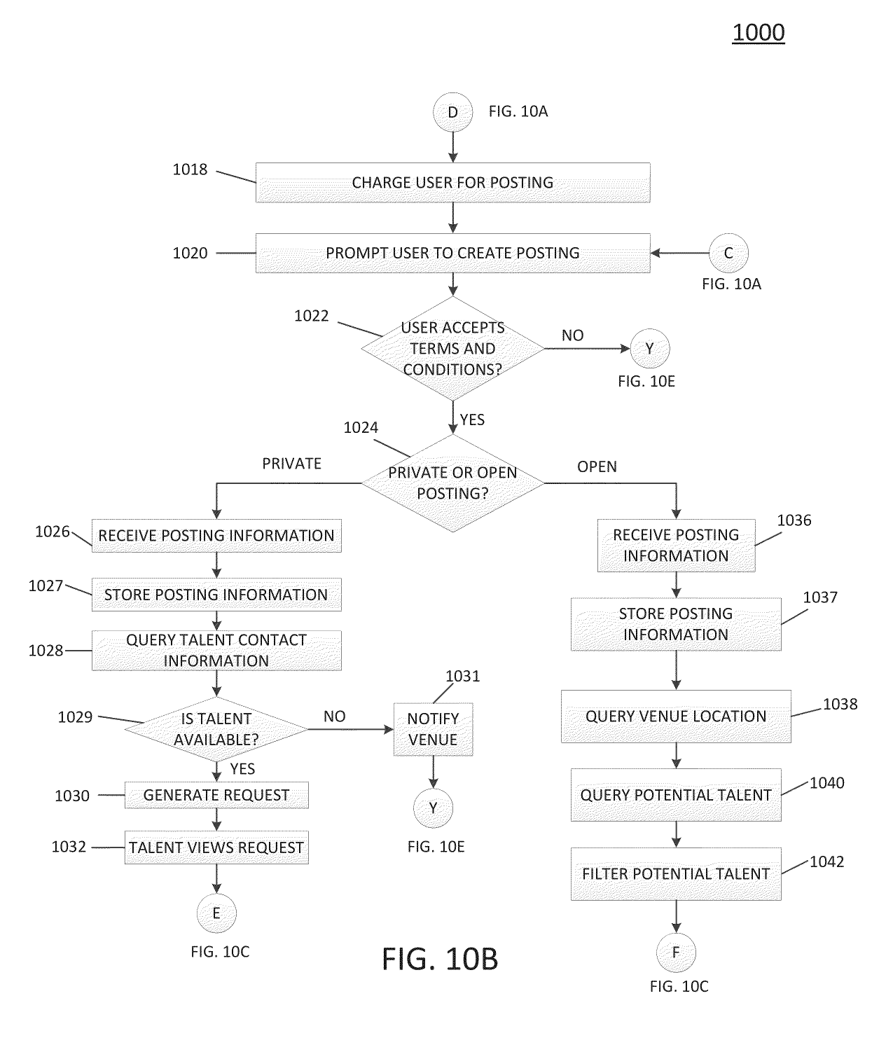

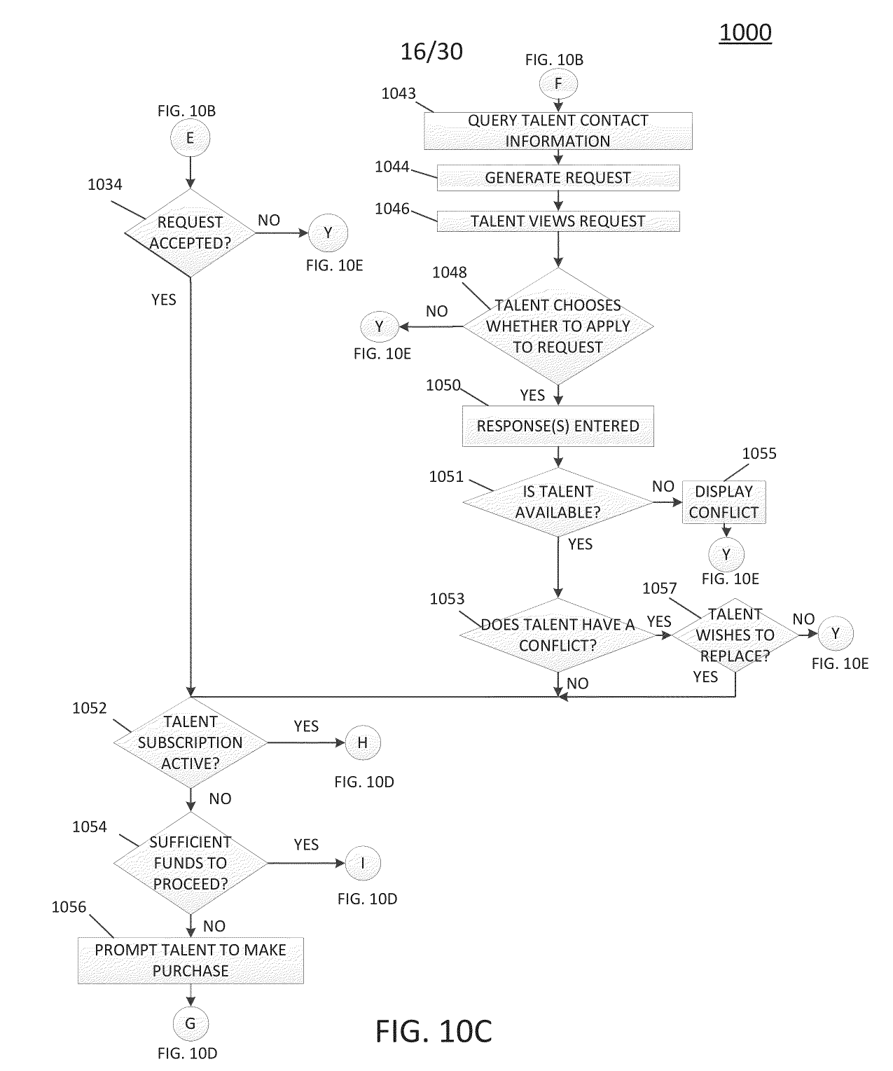

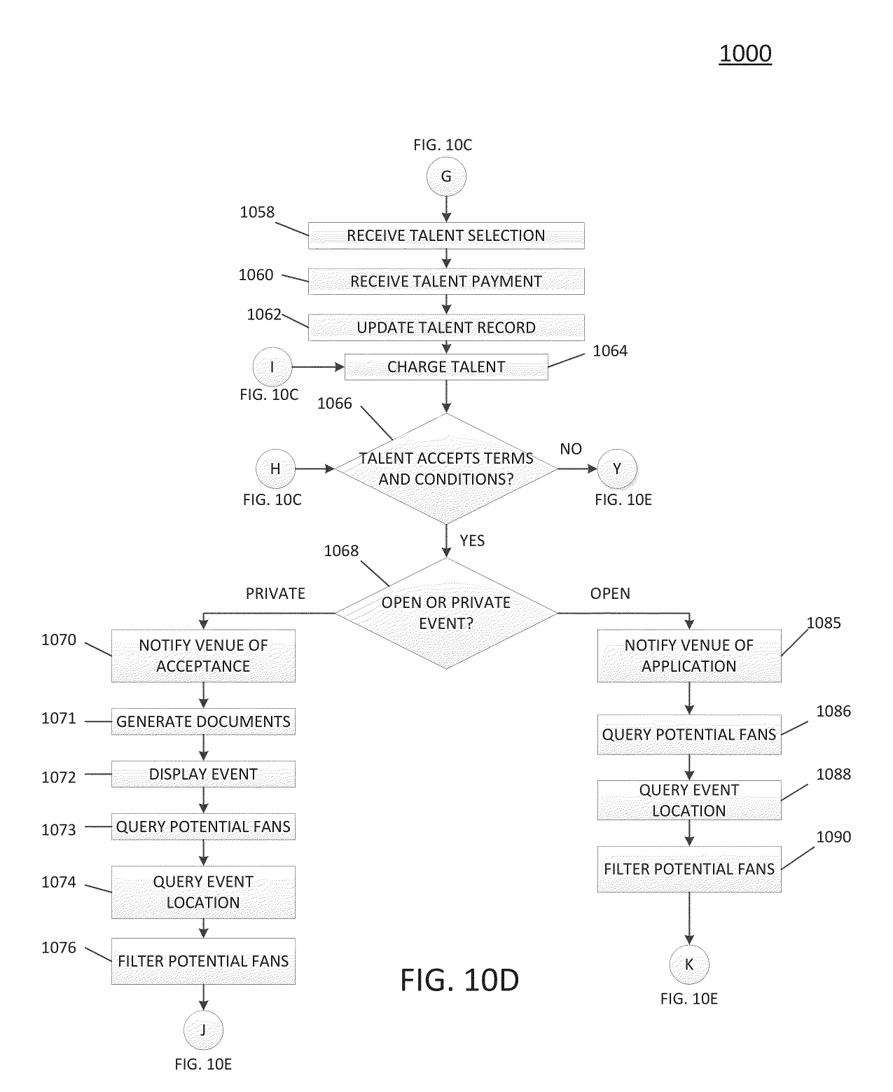

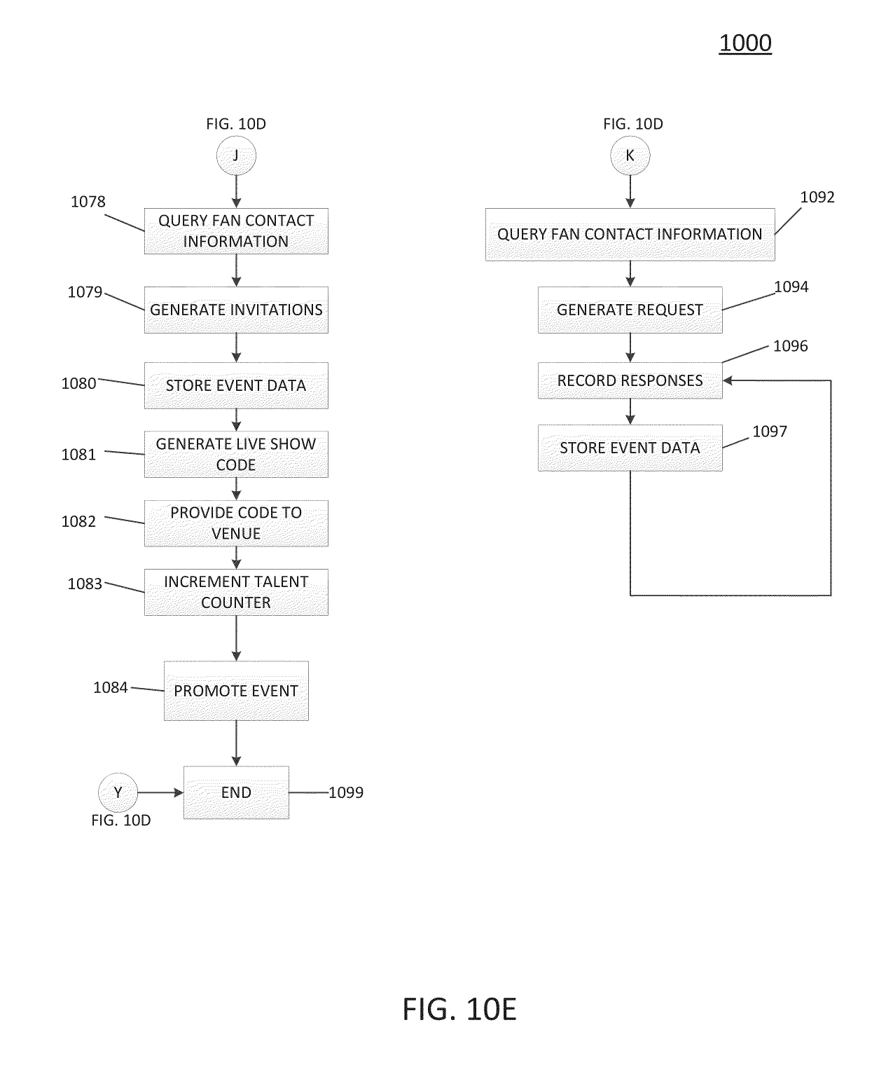

Turning next to FIGS. 10A through 10E, depicted is a flowchart of one method for connecting talent, fans, and venues in the community created by the systems and methods of the present invention (the “Community”) in accordance with an alternate embodiment of the present invention such as that depicted in FIGS. 6A through 19.

Process 1000 starts at 1002, at which system 600 receives a login request from a user. In this process, the user will typically be associated with a venue at which one or more of the talent within the Community might perform or otherwise display their talents/art. The venue type users referenced herein may be any venue that hosts and/or promotes events. Each venue type user becomes a member of the community created by the systems and methods of the present invention by accessing a Web page or the like associated with system 600 and selecting a registration option.

Such access is similar to that discussed above for logging in to system 600. Thereafter, the user enters various information and selects login data (e.g., a user name and password) that will be used to access the user's account at a future date as is known in the art.

Such a request typically involves entry of a user identification (“ID”) and password via the user's computing device 602 as is known in the art. For example, a user may open an Internet browser such as Internet Explorer, Google Chrome, Firefox, Safari or the like, and may enter the desired Uniform Resource Locator (“URL”) to access one or more predefined Web pages provided by server 620. The Web page displayed to the user includes one or more hyperlinks, text entry boxes, and/or the like to facilitate entry of a user ID and password as is known in the art. Alternate methods of accessing the systems and methods of the present invention may also be added or substituted without departing from the scope hereof including mobile applications that provide access to same via any one or more mobile devices such as smartphones, tablets, Web-enabled appliances, and the like.

At step 1004, if the user ID and password matches the information included in Users table 622b, the user is logged into system 600, and process 1000 proceeds to 1006. If a match does not occur, process 1000 returns to 1002, at which the user is prompted to re-enter the correct user ID and password.

Next, at step 1006, process 1000 determines whether the user's subscription is active. For example, process 1000 may query the active subscription field associated with the user's record as stored in Users table 622b. If, at 1006, it is determined that the user does not have an active subscription, process 1000 proceeds to 1008.

At 1008, in the depicted embodiment, the account balance for the venue user is queried to determine if there are sufficient funds to proceed. For example, in the depicted embodiment, a token system is utilized, and, at 1008, the account is queried to determine whether there is more than one token in the account. If the account balance does not have sufficient funds to proceed (i.e., there is less than one token in the account), process 1000 proceeds to 1010, at which the venue user is prompted to purchase one or more tokens or to purchase an active subscription.

Next, at 1012, process 1000 receives the user's selection (i.e., purchase of an active subscription or one or more tokens). Then, at 1014, process 1000 provides the user with a means for making payment, for example, a Web site or the like. In the depicted embodiment, the user is directed to a www.paypal.com Web site via a PayPal® API or the like, however, alternate methods of receiving payment may be substituted. Once payment has been received, the details of the transaction are stored in Purchase table 622h or the like, and control is returned to process 1000.

Next, process 1000 updates the user record to reflect the purchase at 1016. For example, if the user chose to purchase an active subscription at step 1012, the active subscription field of the user's database record is marked “A” and is stored in a database table such as Users table 622b. Or, alternatively, if the user chose to purchase tokens at 1012, the token field of the user's database record is updated to reflect the quantity of tokens purchased. A user may choose to purchase tokens if he/she/they wish to “pay as they go” rather than purchasing an active subscription.

Next, process 1000 proceeds to 1018 as shown in FIG. 10B. Step 1018 may also be reached directly from step 1008 (FIG. 10A) if the user has sufficient funds in his or her account, thereby negating the need for the user to purchase tokens or the like via steps of 1010 through 1016. At step 1018, process 1000 charges the user for the posting. In the depicted embodiment, one token is charged. That is, process 1000 decreases the number of tokens available in the token field of the user's database record by one. Process 1000 then proceeds to 1020.

At 1020, the user is prompted to create his or her advertisement/posting. It should be noted that step 1020 may also be reached directly from step 1006 if the user has an active subscription. That is, when a venue user purchases an active subscription, the user is allowed to post an unlimited quantity of event bookings as described below and is allowed to advertise an unlimited quantity of events (whether talent for such events was found through system 600 or elsewhere). However, alternate types of active subscriptions may be substituted without departing from the scope hereof.

Process 1000 then proceeds to 1022. At 1022, the legal terms and conditions of the posting are presented to the user. If the user does not wish to accept the terms and conditions, process 1000 proceeds to 1099 (FIG. 10E), at which it ends. In the depicted embodiment, accepting the terms and conditions presented to the venue user at step 1022 requires the venue to automatically agree to the terms and conditions of the legal document generated at steps 1071 or 1106 and/or to electronically sign such documents, as discussed in greater detail below. However, alternate embodiments are envisioned in which the legal documents are reviewed and signed separate from the terms and conditions presented at step 1022.

If the user accepts the legal terms and conditions presented at step 1022, process 1000 proceeds to 1024, at which the user selects a private or open event (i.e., the engagement of talent to perform or otherwise display his or her art) posting. If the user selects a “Private” posting, process 1000 proceeds to 1026. At 1026, information related to the posting is received from the user. For example, this step may present a template via a Web page or the like to the user with predefined data fields to allow and guide the user to enter the necessary information. This information may include, without limitation, one or more of the following: name of talent desired to perform at the event, event name, event date and time, event duration, music genre, age limits for attendees, capacity of the venue, price to be paid by the venue to the talent, terms of payment, venue site conditions, talent and/or venue cancellation policy, responsibilities of the talent, equipment to be supplied by the venue and/or by the talent, and a deadline for response (to accept or decline the event).

Next, at 1027, the information entered by the user is received and recorded in a database table such as Events table 622c. Process then proceeds to 1028, at which the contact information for the talent submitted by the user in step 1024 is queried from a database table such as Events Talent table 622e. For example, such contact information may be the talent's email address, phone number, or the like.

Process 1000 then proceeds to 1029, at which database 622 is queried to determine whether the desired talent is available. That is, database 622 is queried to determine if a booked event already exists in the database for that particular talent that overlaps with the requested date and time. If an overlapping booked event exists, the talent is not available to perform, and process 1000 proceeds to 1031, at which the venue is notified that the talent is not available. Thereafter, process 1000 ends at 1099 (FIG. 10E). Such a process reduces or eliminates the ability for talent to doublebook using system 600, thereby decreasing any frustration related thereto on the part of the venue and/or the talent. However, alternate embodiments are envisioned in which the talent is allowed to doublebook and/or accept a new request in lieu of a pre-arranged booking.

Alternatively, if no overlapping booked event exists for the requested date and time, the talent is available, and process 1000 proceeds to 1030, at which a request is made to the talent in relation to the private event posting. In the depicted embodiment, such request includes the automatic generation and transmission (e.g., by server 620) of a predefined email that is sent to the e-mail address associated with the talent as retrieved from Events Talent table 622e at step 1028. This e-mail may include an embedded hypertext link upon which the recipient may click in order to view the event request. An email may be sent, for example, as discussed above with respect to step 714.

Process 1000 then proceeds to 1032, at which the details of the request are displayed to the user. In the depicted embodiment, the details are displayed via one or more predefined Web pages provided by server 620 to the user via, for example, the user's Web browser. Or, as an alternative to, or in addition to a Web browser, the details may be provided via display on a mobile device such as a smartphone, tablet, Web-enabled appliance of the like. Or the details may be sent via SMS. Any compatible method of providing or displaying the details of the request to the talent may be substituted without departing from the scope hereof.

Then, at 1034 as depicted in FIG. 10C, the talent decides whether or not to accept the event request. If the event is not accepted, process 1000 proceeds to 1099 (FIG. 10E), at which it ends. If the request is accepted, process 1000 proceeds to 1052 as discussed in greater detail below. The request may be accepted, for example, by clicking an “Accept Private Event Request” hyperlink, graphical button, or the like that is displayed along with the private event information.

Referring back to step 1024, if the user decides to post an open event request, process 1000 proceeds to 1036. At 1036, information related to the posting is received from the user. For example, this step may present a template via a Web page to the user with predefined data fields to allow and guide the user to enter the necessary information. This information may include, without limitation, one or more of the following: event name, event date and time, event duration, music genre, age limits for attendees, capacity of the venue, price to be paid by the venue to the talent, the quantity of talent desired, terms of payment, venue site conditions, venue and/or talent cancellation policy, responsibilities of the talent, equipment to be supplied by the venue and/or by the talent, and a deadline for response (to accept or decline the event). In the depicted embodiment of the present invention, a venue user may submit a range of suggested prices to be paid to the talent or a fixed price. Such suggestions may be submitted in a comments field or the like. Or, alternate embodiments are envisioned in which the venue determines the price as part of the posting information.

Next, at 1037, the information entered by the user is received and recorded in a database table such as Events table 622c. Process then proceeds to 1038, at which the location of the venue user is queried from a database table such as Users table 622b. For example, such location information may include the venue's zip code, town, state, street address, or other geographical information. In the depicted embodiment, this location information is utilized to retrieve the longitudinal and latitudinal coordinates of the venue via incorporation of an API such as the Google® Maps API, which are saved in association with the venue user's profile in a database table such as Users table 622b. Alternate APIs may also be substituted including, without limitation, MapQuest® and Bing®. However, retrieval of such longitudinal and latitudinal coordinates is not required to implement the present invention.

Process 1000 then proceeds to 1040, at which a query is performed to find all talent who have not chosen to opt out of notifications (e.g., event notifications). For example, in the depicted embodiment, Events Talent table 622e and/or the like is queried to retrieve all talent whose records do not include a “Y” in the “Notification Opt Out” field. This field is populated, for example, when the talent initially registers with the systems and methods of the present invention as discussed above with respect to steps 728 and 730 (FIG. 7B).

Next, at 1042, the records retrieved at step 1040 are filtered to determine a potential talent pool. In the depicted embodiment, process 1000 reads the zip code or other geographical information associated with each of the records and utilizes an API such as the Google® Maps API to determine the longitudinal and latitudinal coordinates associated with each of the records. These coordinates are then compared to the coordinates associated with the venue requesting the event to determine the aerial distance between the venue and the talent. This calculated aerial distance is then compared to the maximum aerial distance associated with each talent record. Talent records for which the calculated aerial distance exceeds the maximum aerial distance associated with the record are removed from the pool of potential talent.

Maximum aerial distances may be set by the talent user during the registration process (or at some time thereafter) and may indicate the aerial or other distance that the talent is willing to travel to perform at an event. Each of the parameters utilized to determine whether talent will be notified of a posted event is considered notification criteria including, without limitation, maximum aerial distance, genre type, consenting to receive notifications, and the like.

In the depicted embodiment, the venue posting the event also sets a maximum distance in which the talent must be located in order to perform at the event (or apply to perform at the event). If the talent is located farther than the maximum distance set by the venue, the talent is removed from the pool of potential talent. In other words, in the depicted embodiment, a maximum aerial distance set by the venue will override the maximum aerial distance set by the talent. Therefore, if talent is located farther than the maximum aerial distance set by the venue, but within the maximum aerial distance set by the talent, such talent will not be notified of the event. However, this feature is not required to implement the present invention.

The depicted embodiment of the present invention also filters records to eliminate any talent that has a “live event” genre that differs from the genre desired for the event as indicated by the venue in the open event request. The “live event” genre associated with the talent may be set or modified by the talent user at registration or at some time thereafter. The event genre is submitted by the venue user when submitting an event request as discussed above with respect to step 1036. However, other methods of filtering the talent pool may be substituted or added without departing from the scope hereof. Embodiments are also envisioned in which the talent is not filtered prior to posting the open event request (i.e., all talent has the opportunity to respond to the request).

Once the talent pool has been determined, process 1000 proceeds to 1043 as depicted in FIG. 10C, at which the contact information for the talent filtered in step 1042 is queried from a database table such as Events Talent table 622e. For example, such contact information may include the talent's email address, phone number, or the like.

Next, at 1044, a request is made to the talent filtered in step 1042 in relation to the open event posting. In the depicted embodiment, such request includes the automatic generation and transmission (e.g., by server 620) of a predefined email that is sent to the e-mail addresses associated with the filtered talent as retrieved from, for example, Events Talent table 622e at step 1043. This e-mail may include an embedded hypertext link upon which the recipient(s) may click in order to view the event request. An email may be sent, for example, as discussed above with respect to step 714.

Process 1000 then proceeds to 1046, at which the details of the request are displayed to the user. In the depicted embodiment, the details are displayed via one or more predefined Web pages provided by server 620 to the user via, for example, the user's Web browser. Or, as an alternative to, or in addition to a Web browser, the details may be provided via display on a mobile device such as a smartphone, tablet, Web-enabled appliance or the like. Or the details may be sent via SMS. Any compatible method of providing or displaying the details of the request to the talent may be substituted without departing from the scope hereof.

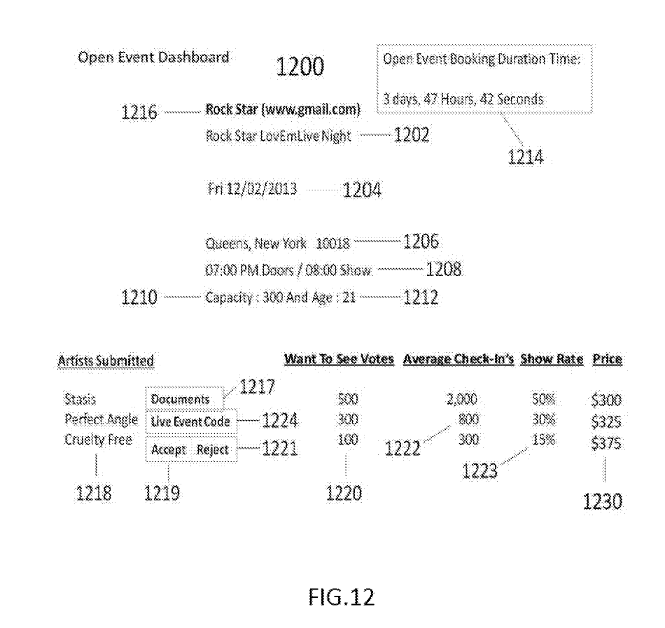

Then, at 1048, the talent decides whether or not to apply to the open event request. If the talent does not wish to apply, process 1000 proceeds to 1099 (FIG. 10E), at which it ends. If the talent wishes to apply to the open event request, process 1000 proceeds to 1050, at which a response is entered. In the depicted embodiment of the present invention, such a response must include, for example, the talent's price for performing the open event or the request will not be accepted. This allows the venue user to evaluate all talent interested in performing at the event based upon price and other criteria related to the user as discussed in greater detail below with regards to FIG. 12. However, alternate embodiments are envisioned in which the talent is not required to submit the talent's price for performing the open event. After any required information is entered, the talent clicks an “Accept Open Event Request” graphical button or the like to proceed.

Next, at 1051, database 622 is queried to determine whether the talent wishing to apply to the posting is available to perform. That is, database 622 is queried to determine if a booked event already exists in the database for that particular talent that overlaps with the requested date and time. If an overlapping booked event exists, the talent is not available to perform, and process 1000 proceeds to 1055. At 1055, the talent is notified that he or she is already booked to perform at an event that overlaps with the requested date and time and that a new application will not be accepted by system 600. Thereafter, process 1000 ends at 1099 (FIG. 10E). Such a process reduces or eliminates the ability for talent to doublebook using system 600, thereby decreasing any frustration related thereto on the part of the venue and/or the talent. However, alternate embodiments are envisioned in which the talent is allowed to doublebook and/or accept a new request in lieu of a pre-arranged booking.

Alternatively, if, at 1051, no overlapping booked event exists for the requested date and time, the talent is available, and process 1000 proceeds to 1053. At 1053, database 622 is queried to determine whether the desired talent has a conflict. More specifically, database 622 is queried to determine whether the talent already submitted an application to perform at another event that overlaps with the date and time of the event to which the applicant wishes to apply. If an application for an overlapping event exists, process 1000 proceeds to 1057, at which the conflict is displayed to the talent, and the talent is provided with an option to replace the prior application for the overlapping event with the new application to be submitted or abandon the application in the process of being submitted.

If, at 1057, the talent does not wish to replace the prior application for the overlapping event, process 1000 proceeds to 1099 (FIG. 10E), at which it ends. If the talent wishes to replace the prior application, the prior application is removed from the respective venue's Open Event Dashboard, and process 1000 proceeds to 1052. Step 1052 may also be reached directly from step 1053 if there are no prior applications for an event that overlap with the event to which the talent wishes to apply. Step 1052 may also be reached from 1034 as discussed above.

At 1052, process 1000 determines whether the talent's subscription is active. In the depicted embodiment, process 1000 may query the active subscription field associated with the talent's record as stored in Users table 622b. If, at 1052, it is determined that the talent does not have an active subscription, process 1000 proceeds to 1054.

At 1054, in the depicted embodiment, the account balance for the talent is queried to determine if there are sufficient funds to proceed. For example, in the depicted embodiment, a token system is utilized, and, at 1054, the account is queried to determine whether there is more than one token in the account. If the account balance does not have sufficient funds to proceed (i.e., there is less than one token in the account), process 1000 proceeds to 1056, at which the talent is prompted to purchase one or more tokens or an active subscription.

Next, at 1058 as shown in FIG. 10D, process 1000 receives the talent's selection (i.e., purchase of an active subscription or one or more tokens). Then, at 1060, process 1000 provides the user with a means for making payment, for example, a Web site or the like. In the depicted embodiment, the user is directed to a www.paypal.com Web site via a PayPal® API or the like, however, alternate methods of receiving payment may be substituted. Once payment has been received, control is returned to process 1000, which then updates the talent record to reflect the purchase at step 1062. For example, if the user chose to purchase an active subscription at step 1058, the active subscription field of the talent's database record is marked “A” and is stored in a database table such as Users table 622b. Or, alternatively, if the user chose to purchase tokens at 1058, the token field of the talent's database record is updated to reflect the quantity of tokens purchased.

Next, process 1000 proceeds to 1064. Step 1064 may also be reached directly from step 1054 (FIG. 10C) if the talent has sufficient funds in his or her account, thereby negating the need for the talent to purchase tokens or the like via steps of 1056 through 1062. At step 1064, process 1000 charges the talent for applying to the Private or Open event posting. In the depicted embodiment, one token is charged. That is, process 1000 decreases the number of tokens available in the token field of the talent's database record by one. Process 1000 then proceeds to 1066. It should be noted that although the depicted methods charge talent for applying, alternate embodiments of the present invention are envisioned in which the talent is only charged if his/her/their application is accepted by the venue and an event is booked.

At 1066, the legal terms and conditions of applying to the “Open Event” posting are presented to the talent. It should be noted that process 1000 may reach step 1066 from either of steps 1052 or 1064. If the talent does not wish to accept the terms and conditions, process 1000 proceeds to 1099 (FIG. 10E), at which it ends. Alternatively, if the talent accesses and agrees to the legal terms and conditions, process 1000 proceeds to 1068. In the depicted embodiment, accepting the terms and conditions presented to the talent at step 1066 requires the talent to automatically agree to the terms and conditions of the legal document generated at step 1071 or 1106 and/or to electronically sign such documents, as discussed in greater detail below. However, alternate embodiments are envisioned in which the legal documents are reviewed and signed separate from the terms and conditions presented at step 1066.

Next, at 1068, process 1000 determines whether the event accepted or applied to by the talent as described in FIGS. 10A through 10C is open or private. If the event is a private event accepted by the talent, process 1000 proceeds to 1070. In the depicted embodiment, acceptance by the talent of a private event binds the venue to the terms and conditions of the deal offered by the venue, however, alternate embodiments are envisioned in which the talent's acceptance of the posting does not bind the venue.

At 1070, the venue that posted the event is notified that the desired talent has agreed to perform the event. In the depicted embodiment of the present invention, this notification involves displaying an acceptance message on the venue's “dashboard” or other informational screen. Such a dashboard may include information such as that depicted on the Open Event Dashboard shown in FIG. 12 as discussed below with the exception of the talent application acceptance graphical buttons 1219 and talent application rejection graphical buttons 1221. That is, in a private event, talent application acceptance graphical buttons 1219 and/or talent application rejection graphical buttons 1221 are not required since the venue has selected the talent prior to sending an invitation to the talent, and the event is booked upon acceptance by the talent. However alternate methods of providing such notification to the venue may be added or substituted without departing from the scope hereof including, without limitation, e-mail notification, text notification, and the like.

In the depicted embodiment of the present invention, talent can only accept a private event at the price offered by the venue when the event was posted (e.g., at step 1026). If the talent wishes to perform the event for a different price, the venue must resubmit a new posting with the agreed upon price. However, alternate embodiments are envisioned in which system 600 allows the venue and the talent to negotiate a price without re-posting the event.

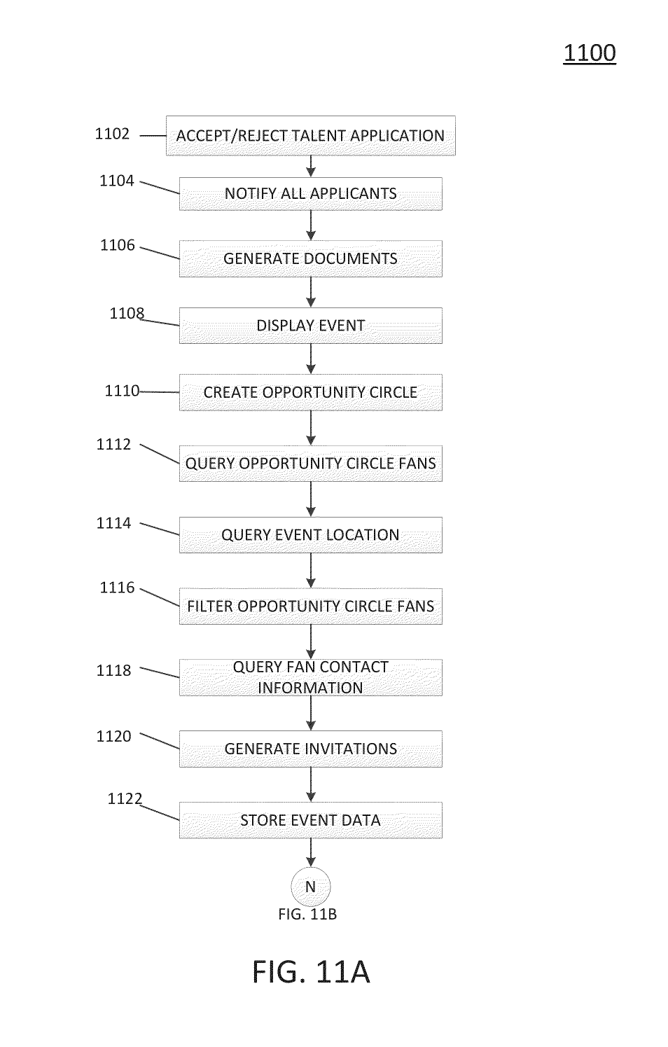

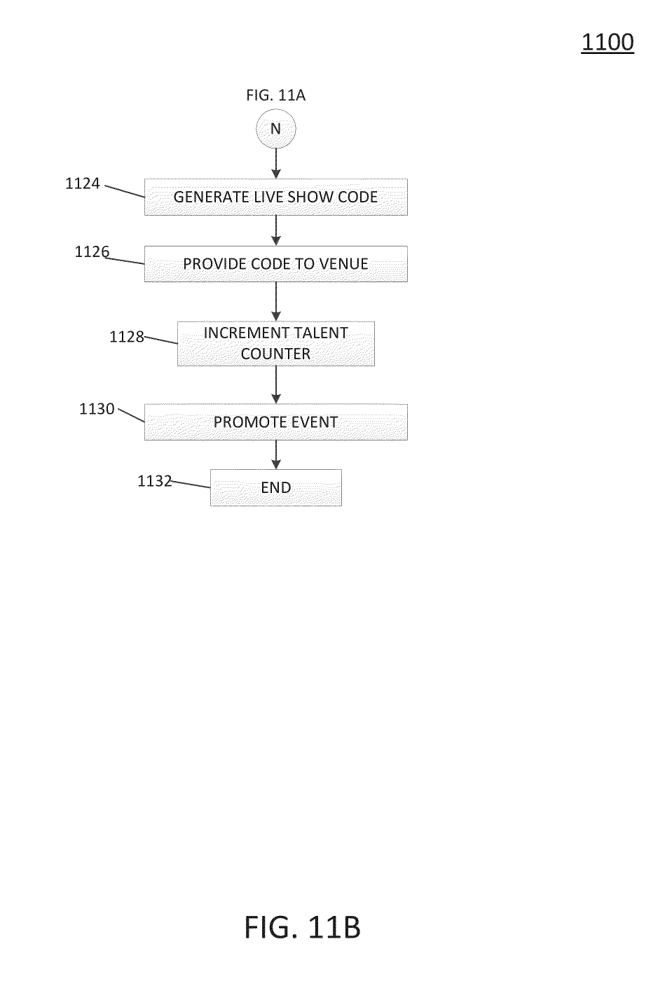

Process 1000 then proceeds to 1071, at which documents are automatically generated and automatically electronically signed as per the talent's acceptance of the terms and conditions presented at step 1066 and the venue's acceptance of the terms and conditions at step 1022. Thereafter, at 1072, the event is displayed. These steps are nearly identical, or may be nearly identical to steps 1106 and 1108, respectively, as discussed in greater detail below with respect to FIGS. 11A and 11B. Thereafter, process 1000 proceeds to 1073.

At 1073, potential fans are queried. In the depicted embodiment of the present invention, a query is performed to find all fans whom have not chosen to opt out of notifications (e.g., event notifications). For example, in the depicted embodiment, Users table 622b and/or the like is queried to retrieve all fans whose records do not include a “Y” in the “Notification Opt Out” field. This field is populated, for example, when the fan initially registers with the systems and methods of the present invention.

Next, at 1074, the location of the venue for the event accepted by the talent is queried from a database table such as Users table 622b. For example, such location information may include the venue's zip code, town, state, street address, or other geographical information. In the depicted embodiment, this location information is utilized to retrieve the longitudinal and latitudinal coordinates of the venue via incorporation of an API such as the Google® Maps API, which are saved in association with the event's record in a database table such as Events table 622c. However, retrieval of such longitudinal and latitudinal coordinates is not required to implement the present invention.

Next, at 1076, the records retrieved at step 1072 are filtered to determine a potential fan pool for the event. In the depicted embodiment, process 1000 reads the zip code or other geographical information associated with each of the fan records and utilizes an API such as the Google® Maps API to determine the longitudinal and latitudinal coordinates associated with each of the records. These coordinates are then compared to the coordinates associated with the venue at which the event will be held to determine the aerial distance between the event venue and the fan. This calculated aerial distance is then compared to the maximum aerial distance associated with each fan record. Fan records for which the calculated aerial distance exceeds the maximum aerial distance associated with the fan record are removed from the pool of potential fans. Such maximum aerial distances may be set by the fan user during the registration process (or at some time thereafter) and indicate the distance a fan is willing to travel to an event.

The depicted embodiment of the present invention also filters records to eliminate any fans that have a “live event” genre that differs from the genre of the event. The “live event” genre associated with the fan may be set or modified by the fan user at registration or at some time thereafter. The event genre is submitted by the venue user when submitting an event request as discussed above with respect to step 1026. However, other methods of filtering the fan pool may be substituted or added without departing from the scope hereof. Embodiments are also envisioned in which the fan pool is not filtered prior to sending invitations to the event (i.e., all fans have the opportunity to receive an invitation).

Once the fan pool has been determined, process 1000 proceeds to 1078 of FIG. 10E, at which the contact information for the fans filtered in step 1076 is queried from a database table such as Users table 622b. For example, such contact information may be the fan's email address, phone number, or the like.

Next, at 1079, an invitation is generated and sent to each of the fans filtered in step 1076 to invite each of the fans to the event. In the depicted embodiment, such invitation includes the automatic generation and transmission (e.g., by server 620) of a predefined email that is sent to the e-mail addresses associated with the filtered fans as retrieved from, for example, Users table 622b at step 1078. This e-mail may include an embedded hypertext link upon which the recipient(s) may click in order to view the details of the event. An email may be sent, for example, as discussed above with respect to step 714. These details may include, but are not limited to, talent name, date, time, venue, and the like for the specific event.

Upon receipt, the recipient may open the email and clicks the embedded hypertext link to view the invitation (including the details of the event). In the depicted embodiment, the details are displayed via one or more predefined Web pages provided by server 620 to the user via, for example, the user's Web browser. Or, as an alternative to, or in addition to a Web browser, the details may be provided via display on a mobile device such as a smartphone, tablet, Web-enabled appliance or the like. Or the details may be sent via SMS. Any compatible method of providing or displaying the details of the event to the fan may be substituted without departing from the scope hereof.

Process 1000 then proceeds to 1080, at which the details of the event are stored in database 622 via a table such as Events table 622c. Such details may include, but are not limited to, event ID, venue, talent name, contract date (i.e., the date of the contract executed between the venue and the talent), contract time (i.e., the time of the contract executed between the venue and the talent), event date, event time, price paid to talent for the event, duration of the event, special arrangements required, and the like.

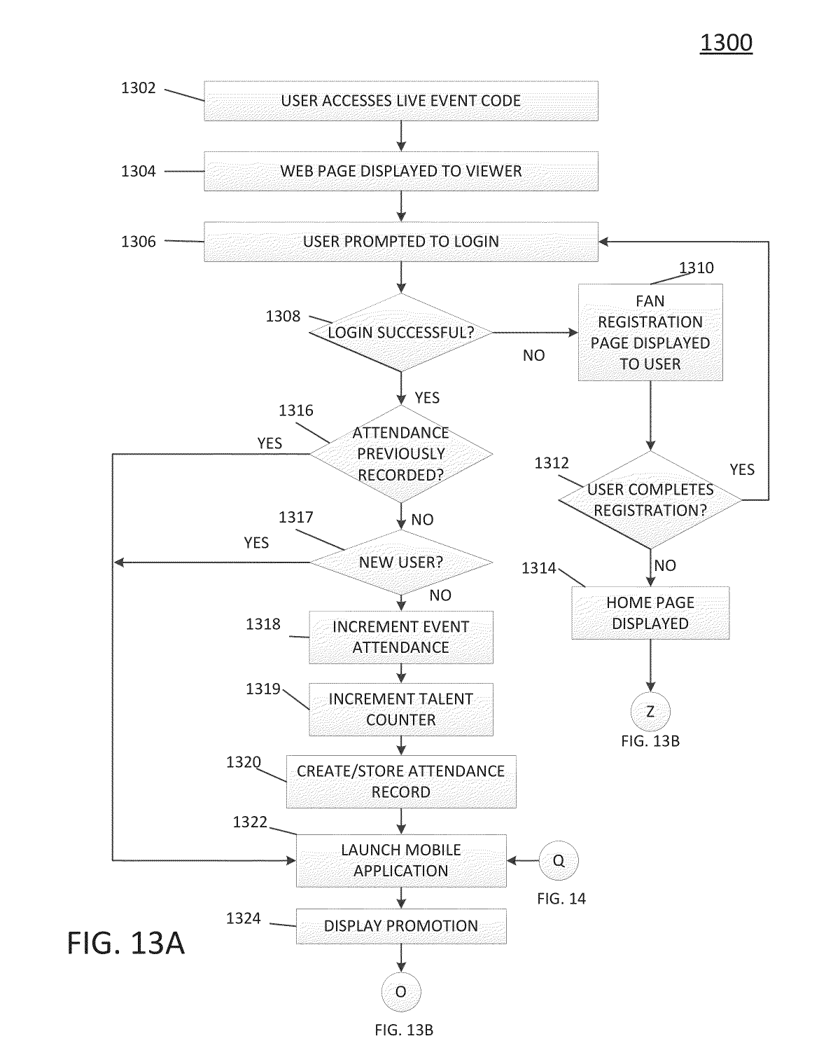

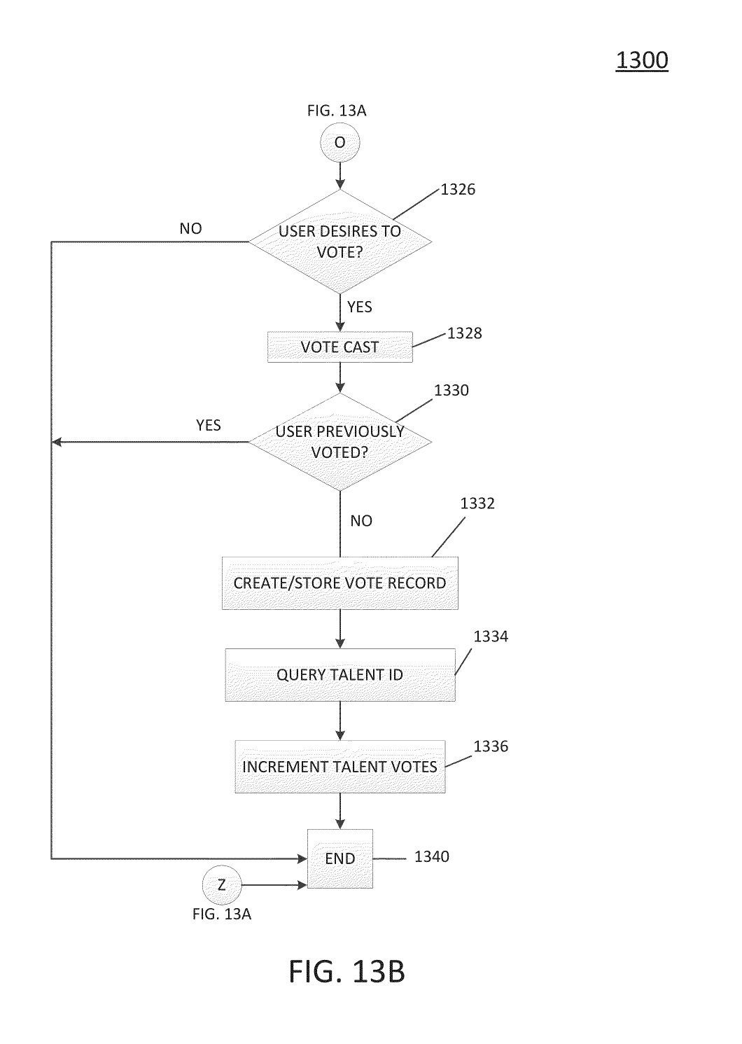

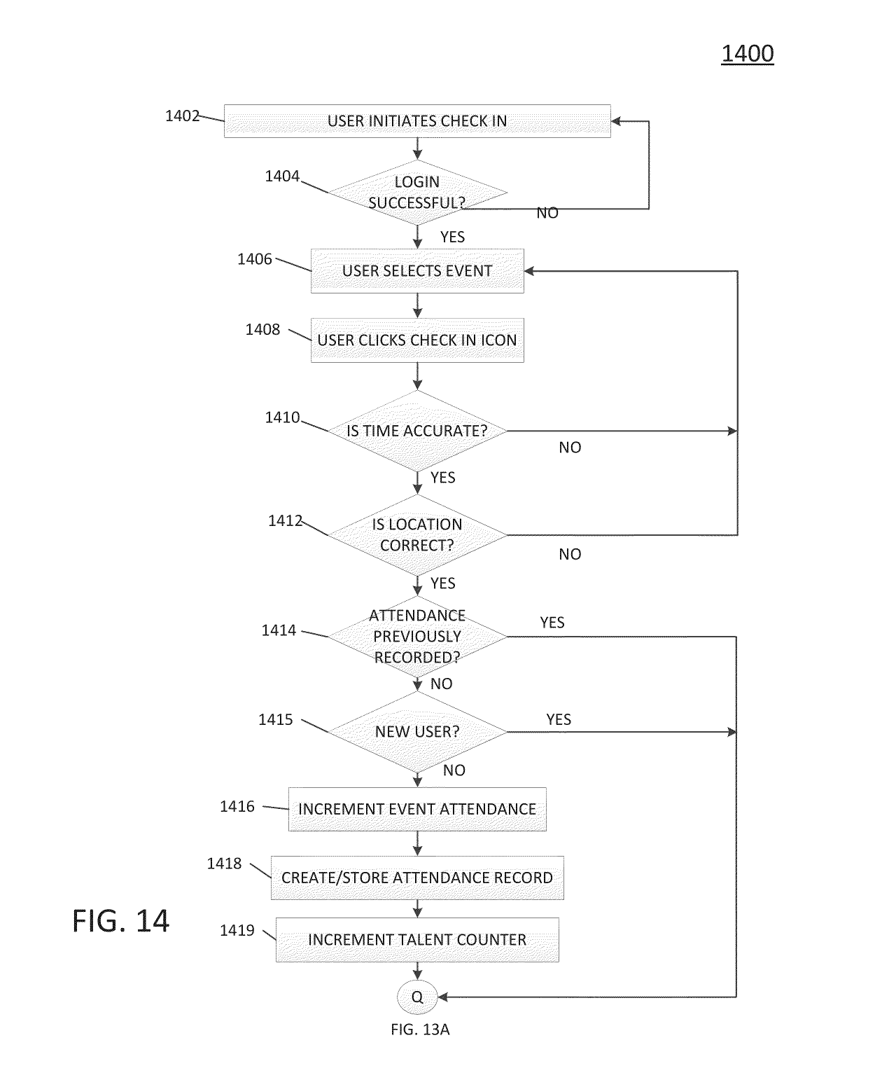

Next, at 1081, a live show code is generated. This code allows a fan or other viewer of the live event to enter feedback for the event as discussed in greater detail below with regards to FIGS. 13A and 13B. In the depicted embodiment, the live show code is a QR (“Quick Response”) code, however, other codes may be substituted without departing from the scope hereof including, without limitation, a unique event identification number. Or, alternate methods of linking the systems and methods of the present invention to the live event (other than codes) may be substituted. In the depicted embodiment of the present invention, the live show code is generated by a third party QR generator API; however, alternate methods may be substituted.

Process 1000 then proceeds to 1082, at which the code generated at 1081 is provided to the venue. In the depicted embodiment, such provision includes displaying the live event code to the venue. More specifically, a live event code graphical button is displayed on the venue's Open Event Dashboard such as that depicted in FIG. 12. Clicking on the live event code graphical button displays the code to the venue user and/or allows the venue user to download the code for recordation, reproduction, etc. This allows the venue to display the code at the live event, which allows viewers at the event to utilize the code to provide feedback via the systems and methods of the present invention.

Process 1000 then proceeds to 1083, at which the Event Booking field of the talent booking the event is incremented by one. This maintains a running tally of all of the events booked by the talent via the systems and methods of the present invention during the talent's career. Such a field may be stored, for example, in Events Talent table 622e or the like without departing from the scope hereof.

Next, at 1084, the event is promoted. In the depicted embodiment of the present invention, such promotion includes displaying the details of the event (e.g., talent name, venue name, live show code or link to download live show code, etc.) on one or more Web pages associated with the systems and methods of the present invention. However, other methods of promoting the event may be added or substituted without departing from the scope hereof. Process 1000 then proceeds to 1099, at which it ends.

Alternatively, if, at step 1068, it is determined that the event is an open event, process 1000 proceeds to 1085. At 1085, the venue that posted the event is notified that talent has applied to perform at the event. In the depicted embodiment, such notification includes the automatic generation and transmission (e.g., by server 620) of a predefined email that is sent to the e-mail addresses associated with the venue hosting the event. This e-mail may include an embedded hypertext link upon which the recipient(s) may click in order to view the talent name, talent profile, and price requested by the talent for the requested event. In the depicted embodiment of the present invention, clicking this link directs the venue user to the venue's dashboard as discussed herein, and the dashboard displays the necessary information regarding the talent's application to perform at the event. However, alternate methods of providing such notification to the venue may be substituted without departing from the scope hereof including, without limitation, e-mail notification, text notification, and the like.

After the notification is sent, process 1000 performs steps 1086 through 1094, which are nearly identical to steps 1073 through 1079 as discussed above with one exception. At step 1094, process 1000 sends a polling question to the fans in the fan pool (in lieu of an invitation to the event). In the depicted embodiment, the polling question is “Would you like to see this talent?” in reference to the talent that applied for the event in the preceding steps.

Next, at 1096, the responses to the polling question are recorded, for example, in Events Talent table 622e. In the depicted embodiment, the responses indicate whether or not the user wishes to see the talent perform. These “want to see” votes are tallied and displayed to the venue hosting the event via, for example, the venue's Open Event Dashboard. However, other polling questions/responses may be posed/recorded and/or such responses may be utilized differently without departing from the scope hereof including, without limitation, “do not want to see” votes.

Process 1000 then proceeds to 1097, at which the details of the event are stored in database 622 via a table such as Events table 622c. Such details may include, but are not limited to, event ID, venue, talent name, contract date (i.e., the date of the contract executed between the venue and the talent), contract time (i.e., the time of the contract executed between the venue and the talent), event date, event time, price paid to talent for the event, duration of the event, special arrangements required, and the like. Thereafter, process 1000 returns to 1096, at which it continues to record “want to see” or other types of responses (e.g., votes).

Turning now to FIGS. 11A and 11B, depicted is a process for allowing a venue to accept a talent's application to perform for a specific event. Such an acceptance may be initiated via, for example, the venue's Open Event Dashboard. One such exemplary dashboard is depicted in FIG. 12.

As seen in FIG. 12, Open Event Dashboard 1200 is available to the respective venue via the systems and methods of the present invention. That is, the venue may access a Web page or the like that displays the Open Event Dashboard when logged into system 600. The Open Event Dashboard 1200 may include information such as, but not limited to, event title 1202, event date 1204, event location 1206, event times 1208 (e.g., doors open time and show time), venue capacity 1210, minimum age requirement 1212, open event booking duration time 1214 (i.e., the duration of time remaining to book talent for the event), event Web site 1216, documents 1217 (clicking this button automatically generates copies of the legal documents that are automatically generated and electronically signed when talent agrees to perform a private event or when a venue selects talent to perform at an open event), list of talent who applied to perform 1218, talent application acceptance graphical buttons 1219, talent application rejection graphical buttons 1221, quantity of fans wishing to see specific talent perform at the event 1220 (i.e., those fans who cast “want to see” votes as discussed in greater detail above with respect to FIG. 10E, career average check-ins per show 1222 (e.g., the quantity of unique check-ins associated with the listed talent divided by the total number of events performed by the listed talent), Show rate 1223 (e.g., the quantity of pre-registered fans who check in at an event divided by the quantity of fans who submitted a “want to see” vote, for example, at step 1096 of FIG. 10E), live event code 1224, and price 1230 (the price the talent is requesting to be paid to perform at the event). However, alternate embodiments of the present invention are envisioned in which the Open Event Dashboard includes varying information without departing from the scope hereof. Or, data displayed on the Open Event Dashboard may be calculated differently without departing from the scope hereof. For example, although attendance by fans who register at an event is excluded from the Show Rate calculation, alternate embodiments are envisioned in which such attendance is included.

Referring back to FIG. 11, the exemplary process for allowing a venue to accept a talent application begins at 1102. At 1102, the talent applications are accepted or rejected. In the depicted embodiment, this occurs when someone associated with the venue clicks accept graphical button 1219 or reject graphical button 1221 in the venue's Open Event Dashboard. Rejected talent information (e.g., name as listed in 1218, quantity of fans wishing to see specific talent perform at the event 1220, average check-in data 1222, show rate data 1223, price data 1230, talent accept and reject graphical buttons 1219 and 1221, respectively, etc.) is then removed from the respective venue's Open Event Dashboard.

Next, process 1100 proceeds to 1104, at which all accepted and rejected talent are notified. In the depicted embodiment, such notification includes the automatic generation and transmission (e.g., by server 620) of a predefined email that is sent to the e-mail address associated with the talent as stored in Users table 622b as discussed in greater detail above with regards to step 714. However, various methods of communication and methods of interfacing with same may be substituted without departing from the scope hereof including, without limitation, SMS, regular mail, and telephone. Process 1100 then proceeds to 1106.

At 1106, documents are generated. In the depicted embodiment, such documents include a legal contract that includes the terms and conditions of the booking. The contract may be prepared using a pre-written contract applicable to the type of event to be performed, and a collection of such pre-written contracts may be saved in database 622, for example, in Admin Info table 622g, which stores this and other types of administrative data. Variable data may be imported from other tables in database 622 and automatically inserted in the applicable contract. Such data may include, without limitation, event time, event date, contract time, contract date, the fee to be paid to the talent for performing the event, event duration, and the like. However, alternate types of documents may be added or substituted and alternate methods of creating same may be substituted without departing from the scope hereof. In the depicted embodiment, the legal documents are automatically generated and electronically signed and are considered to be executed and legally binding on the venue and the talent upon creation of the documents as per the talent's acceptance of the terms and conditions presented at step 1066 and the venue's acceptance of the terms and conditions at step 1022. However, alternate embodiments are envisioned in which the legal documents are reviewed and signed separate from the terms and conditions presented at step 1066. Alternatively, this step may be omitted without departing from the scope hereof.

Once the documents are created and electronically signed, documents graphical button 1217 is displayed via Open Event Dashboard 1200. This graphical button allows the venue to click thereupon in order to view, print, save, etc. a Portable Document Format (“PDF”) copy of one or more documents. However, alternate methods of accessing copies of the executed documents and/or alternate forms for displaying the documents may be substituted or added without departing from the scope hereof. Alternatively, one or more of these items may be omitted without departing from the scope hereof.

Next, at 1108, the information pertaining to the booked event is displayed via the systems and methods of the present invention. Optionally, the systems and methods of the present invention may also display information pertaining to the booked event to the public and/or all registered users via a Web page (e.g., displayed via a personal computer or mobile device) or the like. In the depicted embodiment, such Web page is associated with the same domain name(s) as the user login and other Web pages described herein with reference to FIGS. 6A through 19. However, alternate methods of publishing or advertising the booked event may be added or substituted without departing from the scope hereof. Some information may be omitted including, without limitation, the price paid to the talent to perform the booked event.

Process 1100 then proceeds to 1110, at which an opportunity circle is created for the booked event. The opportunity circle connects all user IDs within the circle and allows them to easily connect and/or communicate with each other. In the depicted embodiment, an internal chat mechanism allows the users in the opportunity circle to instant message or chat with one another. These functions may be employed utilizing third party APIs or custom written code as is known in the art. However, alternate methods of connecting and/or communicating may be added or substituted without departing from the scope hereof including, without limitation, text messaging, emailing, video chat, etc. Or, the opportunity circle may be omitted without departing from the scope hereof.

In the depicted embodiment, the opportunity circle includes all user IDs saved in database 622 in association with the booked event. Each user ID corresponds to one of the users who responded affirmatively to the request generated at step 1094 as discussed above with respect to FIG. 10E. That is, the opportunity circle includes all user IDs for all fans who voted for the talent to perform at the booked event. However, other methods of adding user IDs to the opportunity circle may be substituted or added without departing from the scope hereof. For example, such user IDs may include the ID associated with each fan in the filtered fan pool created after step 1090 as discussed above with respect to FIG. 10D.

In the depicted embodiment of the present invention, users within the opportunity circle can connect with other users therein based upon similar attributes (other than voting for the same talent) including, without limitation, age, horoscope, interests, favorite things, relationship status, intention (e.g., looking to meet new friends, looking to network for business opportunities, looking for a relationship, etc.), education level, ethnicity, employment status, religious beliefs, and social traits (e.g., drinker, smoker, heterosexual, homosexual, and bisexual). Each user may set these attributes when the user registers with the systems and methods of the present invention. Or, if the user does not wish to participate in the opportunity circle, he or she can elect to opt out of same. After the attributes are entered and saved, they are utilized by system 600 to match users to other users in the opportunity circle who have similar attributes. A list is provided to the user who is then able to contact one or more other users via, for example, SMS, email or the like.

Once a digital connection is made via the opportunity circle, the users who have made that connection may elect to meet in person at the booked event to further the connection. The venue hosting the booked event benefits as there is an increased likelihood that the user will attend the show, which is likely to increase the overall attendance at the booked event.

After the opportunity circle has been created, process 1000 proceeds to 1112, at which the opportunity circle fans are queried. In the depicted embodiment of the present invention, a query is performed to find all fans who have not chosen to opt out of notifications (e.g., event notifications). For example, in the depicted embodiment, Users table 622b and/or the like is queried to retrieve all opportunity circle fans whose records do not include a “Y” in the “Notification Opt Out” field. This field is populated, for example, when the fan initially registers with the systems and methods of the present invention.

Next, at 1114, the location of the venue for the booked event is queried from a database table such as Events table 622c. For example, such location information may include the venue's zip code, town and state, street address, or other geographical information. In the depicted embodiment, this location information is utilized to retrieve the longitudinal and latitudinal coordinates of the venue via incorporation of an API such as the Google® Maps API. The coordinates are then saved in association with the event's record in a database table such as Events table 622c. However, retrieval of such longitudinal and latitudinal coordinates is not required to implement the present invention.

Next, process 1100 performs steps 1116 through 1132, which are identical to, or substantially identical to, steps 1076 through 1099, as discussed above with respect to FIGS. 10D and 10E. In these steps, a potential fan pool is created/filtered, event invitations are sent to the fan pool, event data is stored, a live show code is generated and provided to the venue hosting the event, and the event is promoted, all as discussed in greater detail above.

Referring now to FIGS. 13A and 13B, depicted is a method 1300 for checking in and voting for talent via accessing a live event code in accordance with one embodiment of the present invention. Process 1300 begins at 1302, at which a user accesses a live event code. In the depicted embodiment, the live event code is a QR code, however, alternate codes or methods of initiating a Web page or the like may be substituted without departing from the scope hereof. For example, a user present at a live event may scan the code with a smartphone or other mobile device. In such an example, the venue posts or otherwise displays the QR code at the live event. In the depicted embodiment, this scanning of the QR code generates a hyperlink that directs the user to a live event Web page utilizing TCP/IP or the like, and the Web page is displayed on the mobile device at 1304.

At 1306, the user is prompted to log in to the live event Web page. Such a request typically involves entry of a user ID and password via the user's computing device 602 as discussed above with respective to step 702. At step 1308, if the user ID and password matches the information included in, for example, Users table 622b, the user is logged into system 600, and process 1300 proceeds to 1316. If a match does not occur, process 1300 proceeds to 1310, at which a fan registration Web page is displayed to the user. Such registration page allows the fan, for example, to enter personal information and preferences. If, at 1312, the user completes the registration process by entering and submitting the necessary data as is known in the art, process 1300 returns to 1306, at which the user is again prompted to login as discussed above.

If, at 1312, the user does not wish to register, process 1300 proceeds to 1314, at which the home page for the systems and methods of the present invention is displayed to the user. Such home page may include, but is not limited to, advertisements for talent and live events associated with the systems and methods of the present invention. Thereafter, process 1300 ends at 1340 (FIG. 13B).

Alternatively, if, at 1308, the login is successful, process 1300 proceeds to 1316, at which it is determined whether the user's attendance was previously recorded. At 1316, process 1300 queries database 622 to determine whether an attendance record exists that includes both the ID of the live event being attended and the ID of the logged in user. Such records may be stored, for example, in Events table 622c. If the user's attendance has already been recorded, process 1300 proceeds to 1322 as discussed in greater detail below. If the user's attendance has not been previously recorded, process 1300 proceeds to 1317.

Next, at 1317, it is determined whether the user is a new user. At 1317, process 1300 queries database 622 to determine the date and time the user registered with system 600. This date and time is compared to the date and time of the live event being attended. Such records may be stored, for example, in Users table 622b and/or Events table 622c. If the user registered after the live event started (i.e., the user registered at the event), process 1300 proceeds to 1322 as discussed in greater detail below. If the user registered with system 600 prior to the event, process 1300 proceeds to 1318.

At 1318, the attendance field of the live event record is incremented by one. Process 1300 then proceeds to 1319, at which the Check In field of the talent performing at the event is incremented by one. This field maintains a running tally of all check-ins for all events performed by the talent via the systems and methods of the present invention during the talent's career. Further, in the depicted embodiment, process 1300 also recalculates the Average Check-In and Show Rates based upon the increased attendance as discussed in greater detail above with regards to FIG. 12. Such data may be stored, for example, in Events Talent table 622e or the like without departing from the scope hereof.

Next, at 1320, an attendance record including the event ID and user ID is created and stored in database 622 to track attendance by the particular user and to avoid double counting of same. Then, process 1300 proceeds to 1322, at which a mobile application is launched. In the depicted embodiment, process 1300 sends a push notification via a wireless network to the mobile device to command the desired mobile application to be launched. This application allows local deals or promotions created by the venue to be displayed to the user via the user's mobile device at 1324. In some embodiments of the present invention, the local deal may be displayed directly to the user via the mobile device.

Next, at 1326, the user decides whether to cast a vote for the talent performing at the live event. If the user does not wish to cast a vote, process 1300 ends at 1340. Alternatively, if the user wishes to cast a vote, the user clicks or otherwise selects a vote graphical button, and process 1300 proceeds to 1328, at which the vote is cast. In the depicted embodiment, a vote is placed via sending an SMS message or the like. The user is charged a fee for each vote, and the payment of such fee is stored in database 622, for example, in Purchase table 622h. Embodiments of the present invention are envisioned in which a user is rewarded for placing a vote (e.g., the user receives one free download per vote from the talent for which the vote was submitted). Also, embodiments are envisioned in which a portion of the price charged per vote is contributed to one or more charities associated with the event at which the talent is performing. However, alternate methods of casting a vote may be substituted without departing from the scope hereof including, without limitation, via sending a wireless URL call to database 622. Process 1300 then proceeds to 1330.

At 1330, process 1300 determines whether the user has already cast a vote for the same talent at the same event. Process 1300 queries database 622 to determine whether a vote record exists that includes both the ID of the live event being attended and the ID of the logged in user. Such records may be stored, for example, in Events table 622c. If the user's vote has already been recorded, process 1300 proceeds to 1340, at which it ends. If the user's vote has not been previously recorded, process 1300 proceeds to 1332.

At 1332, a vote record including the event ID and user ID is created and stored in database 622 to track the particular user's vote and to avoid double counting of same. Next, process 1300 proceeds to 1334, at which the ID of the talent performing at the current event is queried. In the depicted embodiment, the talent ID associated with the open live event record is queried. Process 1300 then proceeds to 1336, at which the Performance Vote record field associated with the talent's database record is incremented by one. In the depicted embodiment, the Performance Vote record field associated with a talent's database record tallies all votes cast for the talent since the talent registered with system 600. Such a field may be stored, for example, in Events Talent table 622e or the like without departing from the scope hereof. Process 1300 then ends at 1340.

Turning now to FIG. 14, depicted is a method 1400 for allowing a user to check in and vote for talent via logging in to the systems and methods of the present invention in accordance with one embodiment of the present invention. Process 1400 begins at 1402, at which a user initiates a live event check in. In the depicted embodiment, initiating a check in involves accessing an application that has been downloaded to the user's mobile device. This application allows the systems and methods to be utilized on a mobile device, and also allows the mobile device to communicate with system 600. The application connects the mobile device to system 600 via, for example, a wireless URL call, and the user is presented with a Web page at which he or she is prompted to login. However, alternate methods of initiating communication with system 600 may be substituted without departing from the scope hereof including, without limitation, a Web site.

Login typically involves entry of a user ID and password via the user's computing device 602 as discussed above with respect to step 702 and as is known in the art. Next, at step 1404, if the user ID and password matches the information included in, for example, Users table 622b, the user is logged into system 600, and process 1400 proceeds to 1406. If a match does not occur, process 1400 returns to 1402, at which the user is given another chance to enter login information.

At 1406, the user selects the event being attended by the user. For example, the user may click a hyperlink, graphical button, etc. associated with the event. Next, at 1408, the user selects the check in option. This option may also be presented, for example, as a hyperlink, graphical button, icon, or the like that is able to be clicked by the user.

Next, at 1410, process 1400 reads the date, start time, and check in end time of the event selected by the user as stored, for example, in Events table 622c. The check in end time is a time chosen by the providers of the systems and methods of the present invention, and it occurs at a time that is equal to the end time of the event plus an added time period (e.g., a half hour). The extra time may be appended to the end time of the event to allow a user sufficient time to check in and/or vote if the user is unable to vote during the event due to, for example, lack of cell service or the like. These times are compared to the date and time at which check in is initiated in step 1408. If check in was not initiated on the date of the event, after the start time of the event, and before the check in end time associated with the event, process 1400 returns to 1406, at which the user is prompted to select a different event. If check in is initiated on the same date and after the start time but before the check in end time of the event, process 1400 proceeds to 1412.

Similarly, at 1412, process 1400 reads the location associated with the event as may also be stored, for example, in Events table 622c. In the depicted embodiment, process 1400 utilizes an API such as the Google® Maps API to determine the longitudinal and latitudinal coordinates associated with the event. These coordinates are then compared to the longitudinal and latitudinal coordinates associated with the mobile device requesting check in to determine the aerial distance between the live event venue and the mobile device. This calculated aerial distance is then compared to a predetermined maximum distance, for example, five miles. If check in is not initiated from a mobile device located at a distance less than the predetermined maximum distance from the live event venue, process 1400 returns to 1406, at which the user is prompted to select a different event. If check in is initiated from a mobile device located less than the predetermined maximum distance from the live event venue, process 1400 proceeds to 1414.

At 1414, process 1400 queries database 622 to determine whether an attendance record exists that includes both the ID of the live event being attended and the ID of the logged in user attempting to check in. Such records may be stored, for example, in Events table 622c. If the user's attendance has already been recorded, process 1400 proceeds to 1322 as discussed in greater detail above with respect to FIGS. 13A and 13B. If the user's attendance has not been previously recorded, process 1400 proceeds to 1415.

Next, at 1415, it is determined whether the user is a new user. At 1415, process 1400 queries database 622 to determine the date and time the user registered with system 600. This date and time is compared to the date and time of the live event being attended. Such records may be stored, for example, in Users table 622b and/or Events table 622c. If the user registered after the live event started (i.e., the user registered at the event), process 1400 proceeds to 1322 as discussed in greater detail above. If the user registered with system 600 prior to the event, process 1400 proceeds to 1416.

At 1416, the attendance field of the live event record is incremented by one. Next, at 1418, an attendance record including the event ID and user ID is created and stored in database 622 to track attendance by the particular user and to avoid double counting of same. Process 1400 then proceeds to 1419, at which the Check In field of the talent performing at the event is incremented by one. This field maintains a running tally of all check-ins for all events performed by the talent via the systems and methods of the present invention during the talent's career. Further, in the depicted embodiment, process 1400 also recalculates the Average Check-In and Show Rates based upon the increased attendance as discussed in greater detail above with regards to FIG. 12. Such data may be stored, for example, in Events Talent table 622e or the like without departing from the scope hereof. Process 1400 then proceeds to 1322 as discussed in greater detail above with respect to FIGS. 13A and 13B.

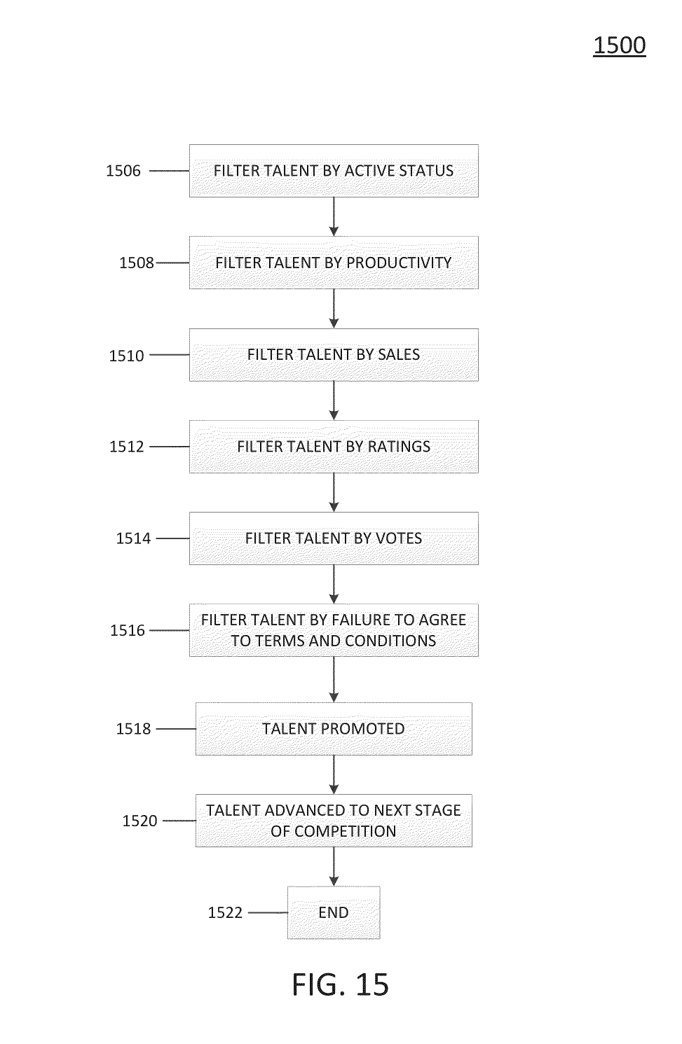

Referring next to FIG. 15, depicted is method 1500 for identifying talent in accordance with one embodiment of the present invention. In the depicted embodiment, the talent to be identified is a subset of all talent in the Community, and this subset may be determined based upon predetermined selection criteria as discussed below. In some scenarios, a method such as method 1500 may be utilized to identify talent for participation in a talent competition in accordance with an alternate embodiment of the present invention. In another scenario, talent achievements and/or other identifying selection criteria is quantified and displayed for use by talent scouts, record label representatives, or the like to allow the talent to be recruited and/or identified for other endeavors. This selection criteria may include feedback received from community fans or other participants. The feedback may include, but is not limited to, votes, check ins, purchased talent media, purchased talent promotional products, ratings, and placement of talent media in a one or more favorite lists.

Process 1500 begins at 1506, typically after the systems and methods of the present invention have been in place for sufficient time to allow the talent utilizing the systems and methods of the present invention depicted in FIGS. 6A through 19 to accrue a favorable status that makes the talent more likely to be selected at the end of process 1500 for advancement in one or more manners as discussed in greater detail below. For example, during the time period prior to initiation of process 1500, talent may accrue selection criteria or statistics such as, but not limited to: quantity of uploaded songs and/or albums for fans to download and/or critique; quantity of songs and/or albums sold to fans through the systems and methods of the present invention; quantity of votes and/or other ratings received from fans; and quantity of performances and/or fan check-ins at venues that hire the talent through the systems and methods of the present invention.

At 1506, the talent is filtered by active status. That is, process 1500 determines whether the talent's registration is active. It should be noted that talent may have an active registration with system 600 without having an active subscription. In such a scenario, talent may be on a pay as you go system for each item initiated through system 600 including, but not limited to, applying for event bookings. In the depicted embodiment, process 1500 queries the active registration field associated with the talent's record as stored in Events Talent table 622e. If, at 1506, it is determined that the talent does not have an active registration, the talent is eliminated from the pool of talent to be considered for advancement, and process 1500 proceeds to 1508. However, alternate methods of eliminating inactive talent from consideration for advancement may be substituted. For example, talent may be required to have an active subscription.

At 1508, talent is filtered by productivity and/or a talent's productivity is quantified for additional consideration. In the depicted embodiment, process 1500 queries, for example, the Event Booking and Check In fields associated with the talent's record as stored in Events Talent table 622e. Any talent that has not booked at least five thousand (5,000) events and has not received at least twenty thousand (20,000) unique check-ins (i.e., each check-in considered in this number must come from a different fan) is eliminated from the list of talent to be considered for advancement. If the talent is not eliminated, the talent's name is added to a list of talent being considered for advancement, and his or her productivity statistics (e.g., quantity of career bookings, quantity of unique check-ins, etc.) is provided along with the talent's name. This information, as well as the other information listed below, may be utilized at any time by those seeking new talent. This information will also be utilized at step 1518 to determine the final talent pool to be advanced, for example, to the first stages of a music competition. However, other purposes may be substituted or added without departing from the scope hereof.

In 1510, talent is filtered by sales. In the depicted embodiment, for all talent that has not been previously eliminated, process 1500 queries the album sales and song sales fields associated with the talents' records as stored in Events Talent table 622e and/or Purchase table 622h. Any talent that has not sold five thousand (5,000) albums and ten thousand (10,000) singles is eliminated from the list of talent to be considered for advancement. If the talent is not eliminated, the talent's name is added to a list of talent being considered for advancement, and his or her sales statistics (e.g., quantity of songs and albums sold) is provided along with the talent's name. This information, as well as the other information listed below, may be utilized at any time by those seeking new talent. This information will also be utilized at step 1518 to determine the final talent pool to be advanced, for example, to the first stages of a music competition. Although the depicted embodiment considers album and song sales only, other forms of sales may also be considered including, without limitation, product sales, video download sales, etc.

Next, process 1500 proceeds to 1512, at which the talent is filtered by ratings. In the depicted embodiment, for all talent that has not been previously eliminated, process 1500 queries the Cumulative Song Rating field associated with the talents' records as stored in Ratings table 622e. Any talent that has a cumulative song rating of less than four (4) stars is eliminated from the list of talent to be considered for advancement. If the talent is not eliminated, the talent's name is added to a list of talent being considered for advancement, and his or her rating statistics is provided along with the talent's name. This information, as well as the other information listed below, may be utilized at any time by those seeking new talent. This information will also be utilized at step 1518 to determine the final talent pool to be advanced, for example, to the first stages of a music competition. Although the depicted embodiment considers cumulative song ratings, other ratings may also be considered including, without limitation, album ratings, video ratings, live performance ratings, talent ratings, and the like. Process 1500 then proceeds to 1514.

At 1514, talent is filtered by votes. In the depicted embodiment, for all talent that has not been previously eliminated, process 1500 queries the performance vote quantity field associated with the talents' records as stored in, for example, Events Talent table 622e. Any talent that has less than ten thousand (10,000) unique performance votes (i.e., each vote considered in this number must come from a different fan) is eliminated from the list of talent to be considered for advancement. If the talent is not eliminated, the talent's name is added to a list of talent being considered for advancement, and his or her vote statistics are provided along with the talent's name. This information, as well as the other information listed below, may be utilized at any time by those seeking new talent. This information will also be utilized at step 1518 to determine the final talent pool to be advanced, for example, to the first stages of a music competition. Although the depicted embodiment considers performance vote quantity, other quantities may also be considered. Process 1500 then proceeds to 1516.

Next, at 1516, talent is filtered by failure to agree to the terms and conditions for advancement. Such terms and conditions may include, for example, an agreement that the talent will pay a percentage of all future earnings (e.g., 20%) to the providers of the systems and methods of the present invention if the talent signs a music deal with a third party (e.g., talent agency, music label, etc.). However, other terms and conditions may be added or substituted without departing from the scope hereof. Such agreement may include signing of a written legal agreement by the talent or the like, but this is not required to implement the present invention. Any talent that does not agree to the terms and conditions presented at 1516, is eliminated from the list of talent being considered for advancement. Process 1500 then proceeds to 1518.

At 1518, talent that has not been previously eliminated is promoted. Such promotion may include, for example, posting information on the Web pages of the system and methods of the present invention stating that the advanced talent has achieved minimum criteria. Or, such promotion may include access to expertise, education, counseling, and the like related to the advancement of the talent's career.

Next, at 1520, talent that has not been previously eliminated is advanced to a next stage of competition or such talent is entered into a competition such as that described above with respect to FIGS. 1 through 5. For example, process 1500 may be substituted for the initial phase described above with respect to FIGS. 1 through 5, and the talent selected for advancement via process 1500 may be automatically entered into the next phase of the FIG. 1 through 5 competition (e.g., the Internet Phase). Or process 1500 may be substituted for the initial and Internet phases described above with respect to FIGS. 1 through 5, and the talent selected for advancement via process 1500 may be automatically entered into the next phase of the FIG. 1 through 5 competition (e.g., the Radio Phase). However, varying configurations of utilizing the talent selected by process 1500 may be substituted without departing from the scope hereof. Thereafter, process 1500 ends at 1522.

Although the above embodiment includes automatic advancement of talent without the participation by the providers of the systems and methods of the present invention in the selection of the talent to be advanced, alternate embodiments of the present invention are envisioned in which the providers of the systems and methods of the present invention intervene in determining which talent is automatically advanced. However, in the depicted embodiment, selection of the talent to be advanced is driven 100% by public fan participation in the systems and methods of the present invention without the intervention of any third party judges or the like.

Although FIG. 15 utilizes talent active status, talent productivity, talent sales, talent rating, and talent votes to automatically advance talent, any of these criteria may be omitted and/or other criteria may be added without departing from the scope of the present invention.

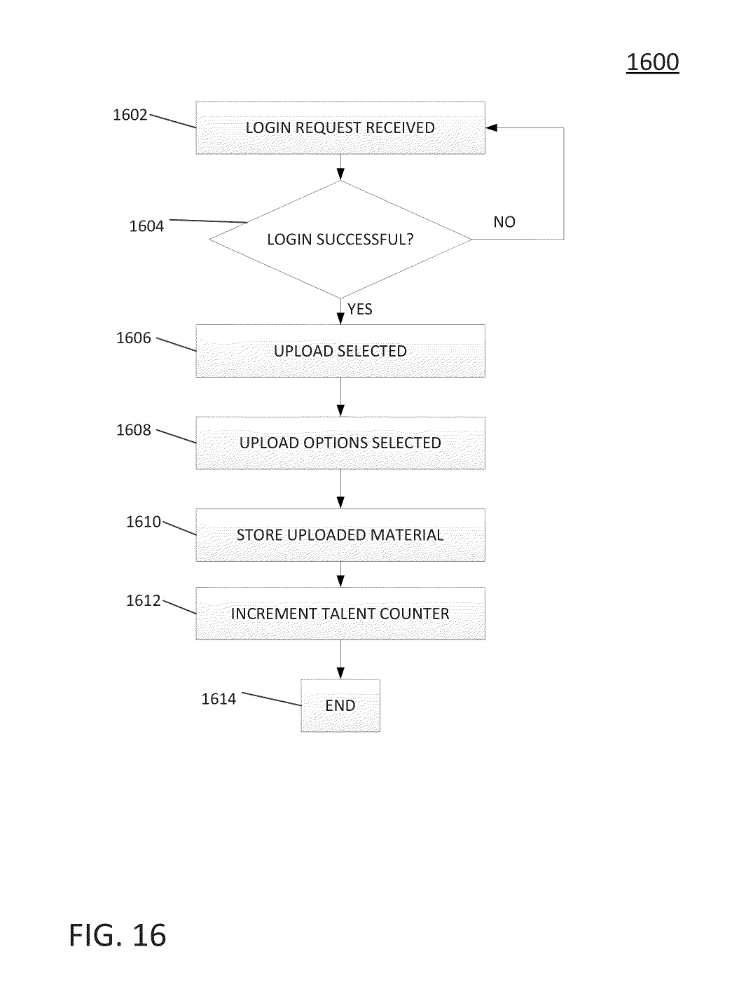

Referring now to FIG. 16, depicted is a process for uploading media in accordance with the alternate embodiment of the present invention depicted in FIGS. 6A through 19. Process 1600 starts at 1602, at which system 600 receives a login request from a user as described in greater detail above with respect to 702. Next, at step 1604, if the user ID and password matches the information included in, for example, Users table 622b, the user is logged into system 600 and process 1600 proceeds to 1606. If a match does not occur, process 1600 returns to 1602, at which the user is prompted to re-enter the correct user ID and password.

At 1606, process 1600 prompts the user to upload material. In the depicted embodiment, the user may choose one of three icons to upload talent media such as a video, a song, or an album, however, material may be omitted or added without departing from the scope hereof. That is, the user simply double clicks the desired icon to initiate the upload. Process 1600 then proceeds to 1608.

At 1608, the user selects upload options. For example, in the depicted embodiment these options include musical genre of the material being uploaded, price (e.g., free or the fee paid by a user to download as discussed below), delivery method (e.g., streaming, download a file, etc.), and file type (e.g., .mp3, .mp4, .wav, etc.). During step 1608, the user also has the ability to enter information about the material being uploaded including, but not limited to, title, thumbnail image, and the like. Also, the user selects the file containing the material to be uploaded, and the material is uploaded using built in PHP methods such as move_uploaded_file, a built in Simple Mail Transfer Protocol (“SMTP”) provided by the hosting provider, and third party APIs such as EZtexting.

Next, at 1610, the uploaded material is stored in database 622. For example, such material may be stored in User Uploads table 622f or the like without departing from the scope hereof. Process 1600 then proceeds to 1612, at which the Uploaded Albums, Uploaded Songs, or Uploaded Videos field of the talent uploading the material is incremented by one (depending on the type of material uploaded). This maintains a running tally of all of the material uploaded by the talent via the systems and methods of the present invention during the talent's career. Such a field may be stored, for example, in Users Talent table 622b or the like without departing from the scope hereof. Process 1600 then ends at 1614. Although the depicted embodiment includes the ability to upload albums, songs, and videos, media may be eliminated, added, or substituted without departing from the scope hereof.

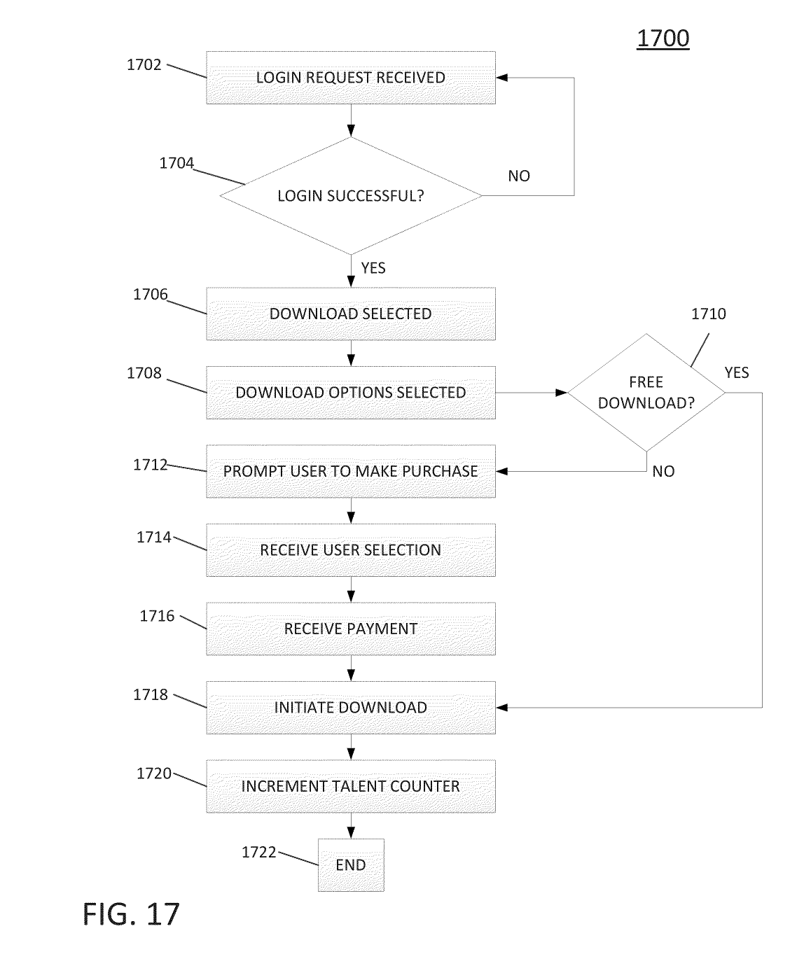

Turning now to FIG. 17, depicted is a process for downloading media in accordance with the alternate embodiment of the present invention depicted in FIGS. 6A through 19. Process 1700 starts at 1702, at which system 600 receives a login request from a user as described in greater detail above with respect to 702. Next, at step 1704, if the user ID and password matches the information included in, for example, Users table 622b, the user is logged into system 600, and process 1700 proceeds to 1706. If a match does not occur, process 1700 returns to 1702, at which the user is prompted to re-enter the correct user ID and password.

At 1706, process 1700 allows the user to download material. The user may find such material by accessing, for example, all material uploaded for a particular talent. Such material may be listed, for example, on one or more Web pages associated with the talent and/or a fan dashboard. One such exemplary Fan Dashboard is depicted in FIG. 19. In the depicted embodiment, every fan has a dedicated Fan Dashboard that is accessible to the fan after the fan logs in to the systems and methods of the present invention. That is, each fan may access a Web page or the like that displays his or her Fan Dashboard when logged into system 600.

In the depicted embodiment of the present invention, Fan Dashboard 1900 includes two tabs, namely, a music tab 1902 and a video tab 1904. FIG. 19 depicts a view of the Fan Dashboard 1900 when the music tab 1902 has been selected. Music tab 1902 includes a list of music and associated information such as, but not limited to: music title 1902, associated album title 1904 (if any), talent name 1906, price 1908 (e.g., the price paid to download the music), Buy Now button 1910 (i.e., clicking this button allows the user to download music as described in greater detail herein with regards to FIG. 17), Love button 1912 (i.e., clicking this button allows the user to “love” the music which adds the music to the user's favorite music or “love” list); Download button 1914 (i.e., clicking this button allows the user to download music previously purchased without repurchasing the music as described in greater detail herein with regards to FIG. 17); Remove button 1916 (i.e., clicking this button allows the user to remove music from the list displayed in the Fan Dashboard); and Play buttons 1918 (i.e., clicking one of these buttons plays the music on the same line as the selected button and displays the selected music in the music control box 1920 along with the selected music title 1922).

In the depicted embodiment, music tab 1902 also includes a search box 1924 that allows the user to search for one or more of search options 1928 by clicking the search button 1926. Search options may include, but are not limited to, talent, genre, song, and/or album. Also, video tab 1904 is substantially identical to music tab 1902 with the exception that the video tab 1904 displays a list of videos rather than songs or albums, and it similarly allows such videos to be played, searched, bought, loved, removed, and downloaded.

Alternate embodiments of the present invention are envisioned in which the Fan Dashboard includes varying information without departing from the scope hereof. Also, varying tabs may be added and/or deleted without departing from the scope hereof.

Referring back to FIG. 17, once the user finds the material that he or she wishes to download, the user begins the download process by clicking, for example, download button 1914 (FIG. 19), and process 1700 proceeds to 1708.

At 1708, the user selects download options. For example, in the depicted embodiment these options include delivery method (e.g., streaming, download a file, etc.) and desired file type (e.g., .mp3, .mp4, .wav, etc.). Downloads are performed using built in PHP methods such as move_uploaded_file, a built in Simple Mail Transfer Protocol (“SMTP”) provided by the hosting provider, and third party APIs such as EZtexting.

Next, at 1710, if the material to be downloaded is free, process 1700 proceeds to 1718 as discussed in greater detail below. If the material to be downloaded is not free, process 1700 proceeds to 1712, at which the user is prompted to make a purchase.

Next, at 1714, process 1700 receives the user's selection (i.e., purchase of the material to be downloaded). Then, at 1716, process 1700 provides the user with a means for making payment, for example, a Web site or the like. In the depicted embodiment, the user is directed to a www.paypal.com Web site via a PayPal® API or the like, however, alternate methods of receiving payment may be substituted. Once payment has been received, process 1700 to 1718.

At 1718, the download of the material is initiated. The user selects a location on his or her electronic device such as computing device 602 (FIG. 6A) to save the downloaded material. The downloaded material is also associated with the user's account via system 600 such that the user may view one or more lists of all downloaded material at any time via system 600. Such information may be presented in any form including, without limitation, one or more Web pages or the like. In the depicted embodiment, such Web pages allow the user to control the lists of downloaded material and/or the downloaded material itself. For example, users may choose to play material on the list, to remove material from the list, etc.

Process 1700 then proceeds to 1720, at which the Albums Sold, Songs Sold, or Videos Sold field of the talent who uploaded the material is incremented by one (depending on the type of material downloaded). This maintains a running tally of all of the material sold by the talent via the systems and methods of the present invention during the talent's career. Such a field may be stored, for example, in Events Talent table 622e or the like without departing from the scope hereof. Process 1700 then ends at 1722. Although the depicted embodiment includes the ability to purchase albums, songs, and videos, media may be eliminated, added, or substituted without departing from the scope hereof.

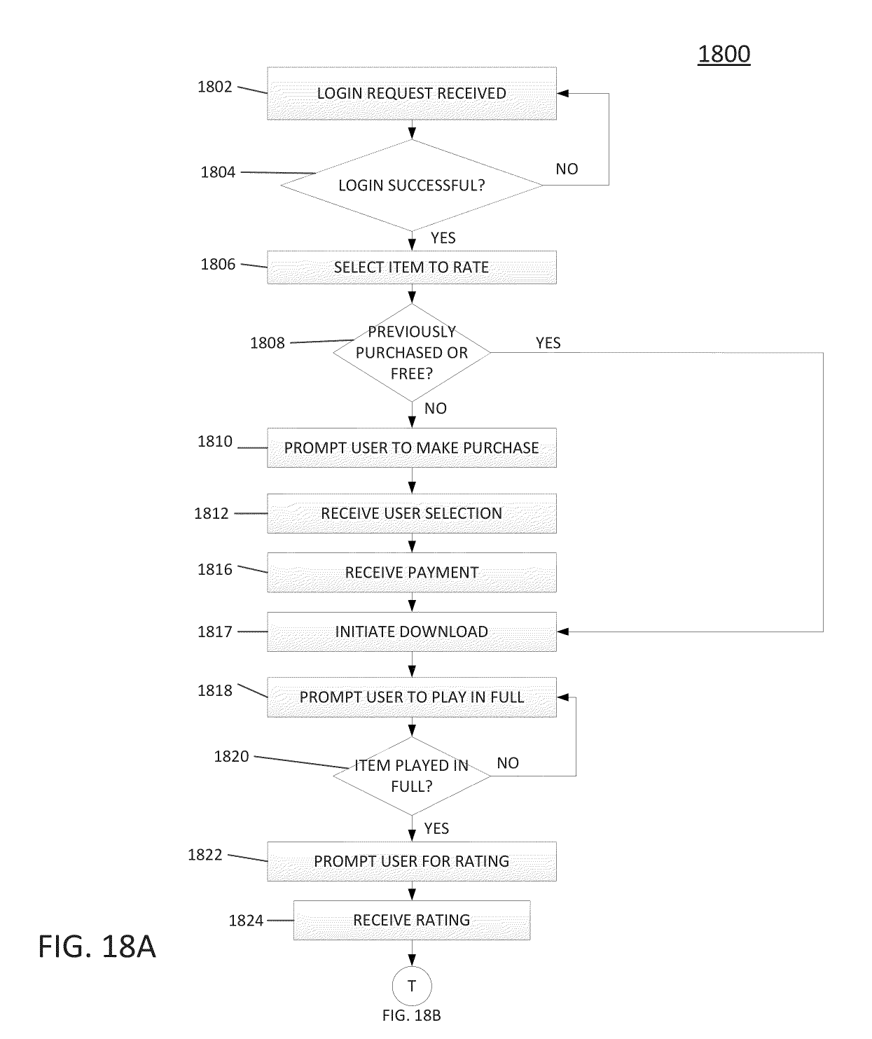

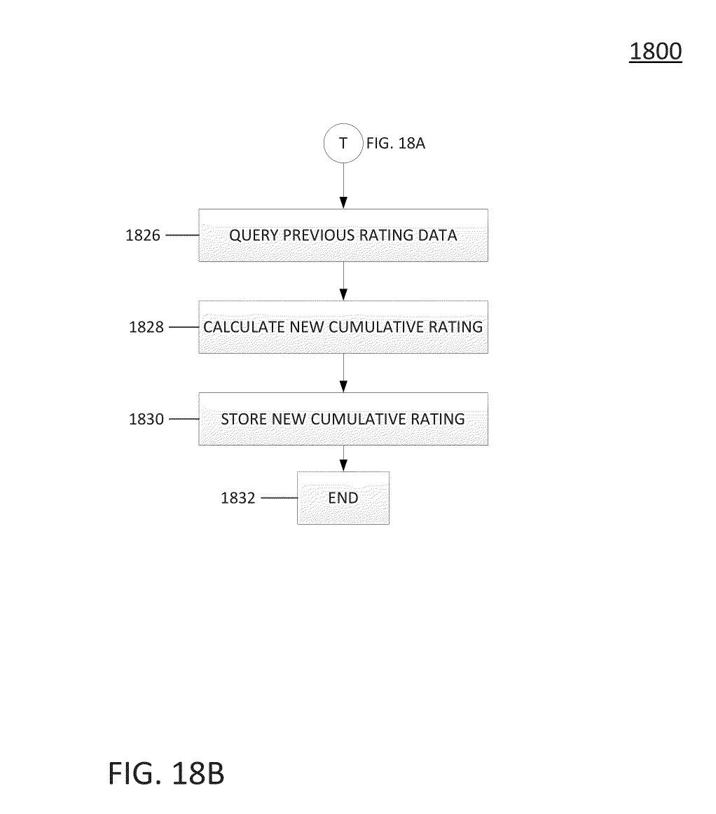

Referring now to FIGS. 18A and 18B, depicted is a process for rating talent, venues, and/or media in accordance with the alternate embodiment of the present invention depicted in FIGS. 6A through 19. Process 1800 starts at 1802, at which system 600 receives a login request from a user as described in greater detail above with respect to 702. Next, at step 1804, if the user ID and password matches the information included in, for example, Users table 622b, the user is logged into system 600, and process 1800 proceeds to 1806. If a match does not occur, process 1800 returns to 1802, at which the user is prompted to re-enter the correct user ID and password.

At 1806, process 1800 allows the user to select talent, venue, or media to be rated. The user may find such material by, for example, searching for talent, searching for a venue, and/or searching all material or media uploaded for a particular talent. Such material may be listed, for example, on one or more Web pages. Each listing may include for example, information including, but not limited to, talent/venue/media name or title. For media, such information may also include the associated talent, price, etc. However alternate methods of finding material to rate may be substituted without departing from the scope hereof. The user then selects the material to be rated by clicking or the like, and process 1800 proceeds to 1808.

At 1808, process 1800 determines whether or not a fee must be paid to rate the talent/venue/media. In the depicted embodiment, there is no fee to rate talent or venues, but the user is unable to rate media unless the user has purchased the media and played it in full. Therefore, at 1808, process 1800 determines whether the media has been previously purchased by the user. If yes, process 1800 proceeds to 1817 as discussed in greater detail below. Or, if a user has not previously purchased the media but the media is free, process 1800 also proceeds to 1817 as discussed in greater detail below. If the user has not purchased the media and the media is not free, process 1800 proceeds to 1810, at which the user is prompted to make a purchase. Although the depicted systems and methods of the present invention do not require a fee to rate talent/venues/media, alternate embodiments are envisioned in which the ability to submit one or more ratings requires payment of a fee.

Next, at 1816, process 1800 receives the user's selection (i.e., purchase of the material to be downloaded/rated). Then, at 1816, process 1800 provides the user with a means for making payment, for example, a Web site or the like. In the depicted embodiment, the user is directed to a www.paypal.com Web site via a PayPal® API or the like, however, alternate methods of receiving payment may be substituted. Once payment has been received, process 1800 proceeds to 1817.

At 1817, the download of the material is initiated. The user selects a location on his or her electronic device such as computing device 602 (FIG. 6A) to save the downloaded material. The downloaded material is also associated with the user's account via system 600 such that the user may view one or more lists of all downloaded material at any time via system 600. Such information may be presented in any form including, without limitation, one or more Web pages or the like. In the depicted embodiment, such Web pages allow the user to control the lists of downloaded material and/or the downloaded material itself. For example, users may choose to play material on the list, to remove material from the list, etc.

Next, at 1818, the user is prompted to play the material to be rated in full. That is, in the depicted systems and methods of the present invention, the user must play the material to be rated from start to finish before the user is able to submit a rating. However, alternate embodiments are envisioned in which such a requirement is not utilized.

Next, at 1820, process 1800 determines whether or not the material to be rated has been played in full. In the depicted embodiment, process 1800 compares the run-time counter (i.e., a counter that indicates how long the material has been playing) to the total length of the material. If they are equal, the material is designated to have been played in full. If the user has not played the material in full, process 1800 returns to 1818. Alternatively, if the material has been played in full, process 1800 proceeds to 1822, at which the user is prompted to enter a rating. In the depicted embodiment, a five star rating system is utilized, wherein five is the highest rating and one is the lowest rating. However, alternate rating systems may be substituted without departing from the scope herein. Ratings may be entered by the user by simply clicking the desired quantity of stars on a Web page or the like provided by system 600.

Next, at 1824, system 600 receives the user's rating and stores same in Ratings table 622a. Then, at 1826, process 1800 queries the previous rating data for the talent/venue/media. Such rating data may include quantity of ratings and average cumulative rating (i.e., the sum of all ratings received divided by the quantity of ratings received). Such data may be read from, for example, the Cumulative Song Rating, Cumulative Album Rating, Cumulative Video Rating, Cumulative Talent Rating, Album Rating, Song Rating, Video Rating, or Talent Rating fields of the talent who is being rated. Such fields may be found, for example, in Ratings table 622a. This table maintains rating information for all talent and all of the material sold by the talent via the systems and methods of the present invention. Alternatively, if a venue is being rated, such data may be read from, for example, the Venue Rating or Venue Cumulative Rating field of a table such as Venue table 622j. Venue table 622j stores all venue information including name and address as well as venue type (e.g., bar, restaurant, club, community, school, etc.).

After the previous rating data has been queried, new rating data is calculated at 1828. In the depicted embodiment, a new cumulative rating is calculated by adding the new rating received to the sum of all prior ratings. This value is then divided by the total number of ratings to calculate a new cumulative rating. However, alternate methods of calculating a rating may be substituted without departing from the scope hereof including, but not limited to, weighted ratings and the like.

At 1830, the new cumulative rating is stored in database 622 in the same field and/or table from which the prior cumulative rating data was retrieved at steps 1826 as discussed above. Process 1800 then proceeds to 1832, at which it ends.

Although several processes have been disclosed as software, it may be appreciated by one of skill in the art that the same processes, functions, etc. may be performed via hardware or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of identifying talent comprising:
creating a community;
allowing, using a microprocessor, any member of a public to join said community via a network connection capable of accessing a server associated with said community;
receiving, using a microprocessor, talent into said community;
receiving, using a microprocessor, at least one of the group consisting of talent media and talent promotional items from said talent;
making at least one of the group consisting of said talent, said talent media, said talent promotional items, and combinations thereof available to said community via said network;
receiving, using a microprocessor, feedback from said fans via a plurality of electronic devices in communication with said server;
automatically selecting, using a microprocessor, a subset of said talent based upon predetermined selection criteria; and
promoting said subset.

2. A method according to claim 1 further comprising:
allowing said fans to send invitations, using a microprocessor, to invite potential talent to join said community.

3. A method according to claim 2 further comprising:
receiving, using a microprocessor, said potential talent into said community upon acceptance of one of said invitations by said potential talent.

4. A method according to claim 1, wherein said predetermined selection criteria is selected from the group consisting of talent vote quantity, quantity of downloaded songs, quantity of downloaded videos, quantity of favorite songs, quantity of favorite videos, quantity of booked events, quantity of check ins, talent ratings, promotional item sales, media sales, and combinations thereof.

5. A method according to claim 1, wherein said plurality of electronic devices includes at least one of the group consisting of a personal computer, a telephone, a cell phone, a digital media player, a personal data assistant, and combinations thereof.

6. A method according to claim 1,
wherein said predetermined selection criteria includes feedback provided by the community; and
wherein said feedback is received via at least one of the group consisting of an electronic mail message, an SMS message, a vote, a social media interface, and combinations thereof.

7. A method according to claim 1 further comprising:
generating revenue from at least one of the group consisting of fees for providing feedback, downloading fees, access fees, advertising fees, sponsor fees, sales of talent promotional items, sales of said talent media, and combinations thereof.

8. A method according to claim 6, wherein at least a portion of said revenue is allocated to at least one of the group consisting of talent associated with said revenue, said fan who discovered said talent associated with said revenue, a charity, and combinations thereof.

9. A method according to claim 1, wherein said talent is at least one of the group consisting of individual artists, bands, and combinations thereof.

10. A method according to claim 1, wherein said talent media is at least one of the group consisting of songs, videos, and combinations thereof.

11. A method according to claim 1 further comprising:
receiving, using a microprocessor, at least one venue into said community.

12. A method according to claim 11 further comprising:
allowing, using a microprocessor, said at least one venue to post at least one advertisement requesting said talent in said community to perform at one or more events hosted by said at least one venue.

13. A method according to claim 12, wherein said at least one advertisement may be private or public.

14. A method according to claim 12 further comprising:
automatically notifying, using a microprocessor, said talent of said at least one advertisement based upon predetermined notification criteria set by said talent.

15. A method according to claim 12 further comprising:
generating revenue, using a microprocessor, from at least one of the group consisting of allowing said talent to respond to said at least one advertisement, allowing said venue to post said at least one advertisement, and combinations thereof.

16. A method according to claim 12 further comprising:
automatically generating, using a microprocessor, documents upon the occurrence of at least one of the group consisting of acceptance of a talent application by said at least one venue or acceptance of said at least one advertisement by said talent.

17. A method according to claim 12 further comprising:
automatically promoting, using a microprocessor, said one or more events upon the occurrence of at least one of the group consisting of acceptance of a talent application by said at least one venue or acceptance of said at least one advertisement by said talent.

18. A method according to claim 17,
wherein said promoting is performed using a microprocessor; and
wherein said promoting includes at least one of the group consisting of automatic generation and sending of event invitations, automatic creation of an opportunity circle, and combinations thereof.

19. A method according to claim 12 further comprising:
receiving, using a microprocessor, at least one of the group consisting of an event check in, an event vote, and combinations thereof; and
storing, using a microprocessor, said at least one of the group consisting of said event check in, said event vote, and combinations thereof in a record associated with said talent performing at said event associated with said at least one of the group consisting of said event check in, said event vote, and combinations thereof.
